(19) United States
(12) Patent Application Publication
(10) Pub. No.: US 2026/0172378 A1
(43) Pub. Date: Jun. 18, 2026

(54) CONTEXT-AWARE MESSAGING WITH ACTIONABLE OBJECT-BASED COMMAND INTEGRATION

(71) Applicant: Adeia Guides Inc., San Jose, CA (US)

(72) Inventors: Charles Dasher, Lawrenceville, GA (US); Jean-Yves Couleaud, Mission Viejo, CA (US)

(21) Appl. No.: 18/979,341

(22) Filed: Dec. 12, 2024

(51) Int. Cl. H04L 51/18; H04L 51/02

(52) U.S. Cl. CPC H04L 51/18; H04L 51/02

(57) ABSTRACT

Systems and methods for including an actionable object that includes an instruction for a recipient device in a messaging context to perform an action, which includes handling of the message, are described. A message is composed and an actionable object for the message is selected and associated with the message. The actionable object includes instructions for the recipient device to perform an action when a current state of the recipient device meets described contextual awareness condition(s). The instructions are included in a data packet, separate from the message, and transmitted to the recipient device. The recipient device, upon receiving the message with the instructions, determines a current contextual awareness state. If the current state meets the described contextual awareness condition, the recipient device performs the action as instructed. API calls to other applications can be made to perform the action.

### FIELD OF DISCLOSURE

Embodiments of the present disclosure relate to techniques for composing and transmitting a message and an associated actionable object that includes an instruction and a contextual awareness condition to a recipient device. Embodiments also relate to techniques for executing the message in accordance with the executing instruction upon occurrence of the contextual awareness condition.

### BACKGROUND

A decade or two ago, phone calls were the primary means of communication. People would pick up the phone and engage in direct conversations, often without prior notice to the recipient that is receiving the call. A few decades before that the culture was to show up at someone's house spontaneously without calling them before and getting their permission to visit them. A lot has changed since then and others'privacy and respect for their time has become more important. Accordingly, in recent years, texting has emerged as a dominant mode of communication and thought of as less intrusive compared to calling someone unannounced. This change allows recipients to respond at their own pace, without feeling pressured to answer immediately.

While texting offers more privacy by avoiding unexpected interruptions, there are still several drawbacks to the current state of texting or text messaging. One such drawback is that text messaging can still disrupt activities. For example, a text message might arrive at an inopportune time, such as during sleep or while the recipient is busy. Although some strides have been made in managing notifications with customizable settings and integrations, these improvements are still limited, require manual configuration, and are static in nature, unable to dynamically adapt to real-time context. Furthermore, such attempts use approaches that are limited in their ability to provide truly personalized and context-aware communication experiences.

Another drawback with the current state of texting or text messaging is that if the message is not read in time by the recipient, a message read later in time can lead to delays in communication between the sender and the recipient, especially for messaging requiring urgent attention. For example, when someone sends an important text message, they may be left in a state of uncertainty, wondering if the recipient has even seen or engaged with the message, let alone responded. Although read receipts are available on some messaging platforms, they do not provide details or confirm with any level of certainty whether the recipient has actually read or engaged with the message. For example, if the recipient clicks on the message but then scrolls away without reading it, current read receipts may still indicate that the message was read.

Another drawback with the current messaging systems is that they only provide static notifications. Such notifications do not adapt to the recipient's context, can be disruptive and lead to missed communications. For example, the notification may become buried in someone's inbox as other messages pile on top, increasing the probability that the recipient may not read the message or get to the message in time.

Yet another drawback is that current messaging systems lack personalization in that they do not offer personalized actions for each message. As such, they force recipients to manually manage notifications, which can be cumbersome. This lack of contextual awareness makes the message inefficient.

Yet another drawback with some of the current messaging systems is that they do not adequately address the growing demand for enhanced security and accountability. Features to protect sensitive information do exist, such as self-destructing messages that enhance privacy by automatically deleting messages after they are read. However, such deletion does not account for the recipient's context, such as their availability or whether they are in a situation where privacy is paramount.

As such, there is a need for dynamic systems and methods that enhance message notifications and functionality by considering the contextual circumstances and providing enhanced personalization, customizations, and security features.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a block diagram of a process for executing an action based on triggering of a contextual awareness condition specified by an instruction associated with a message, in accordance with some embodiments of the disclosure;

FIG. 2 is a block diagram of a system for executing an action based on triggering of a contextual awareness condition specified by an instruction associated with a message, in accordance with some embodiments of the disclosure;

FIG. 3 is a block diagram of a user device used for executing an action based on triggering of a contextual awareness condition specified by an instruction associated with a message, in accordance with some embodiments of the disclosure;

FIG. 4 is a flowchart of a process for executing an action based on triggering of a contextual awareness condition specified by an instruction associated with a message, in accordance with some embodiments of the disclosure;

FIG. 5 is communication process between systems and devices for executing an action based on triggering of a contextual awareness condition specified by an instruction associated with a message, in accordance with some embodiments of the disclosure;

FIG. 6A is an example of an SMS with an update command, in accordance with some embodiments of the disclosure;

FIG. 6B is an example of an SMS with a cancel command, in accordance with some embodiments of the disclosure;

FIG. 7 is an example of an iMessage payload for an updated command, in accordance with some embodiments of the disclosure;

FIG. 8 is an example of an iMessage payload for a command cancellation, in accordance with some embodiments of the disclosure;

FIG. 9 is communication process between systems and devices for executing an action based on triggering of a contextual awareness condition specified by an instruction associated with a message, in accordance with some embodiments of the disclosure;

FIG. 10 is communication process between systems and devices when utilizing user data header (UDH) to include a command or metadata within the SMS message, in accordance with some embodiments of the disclosure;

FIG. 11 is communication process between systems and devices when system defines a custom data coding scheme (DCS) value that indicates the presence of command data within the message, in accordance with some embodiments of the disclosure;

FIG. 12 is communication process between systems and devices when a system embeds a command directly within the user data (UD) of the SMS in a predefined format, in accordance with some embodiments of the disclosure;

FIG. 13 is an example of a messaging payload for a delayed notification, in accordance with some embodiments of the disclosure;

FIG. 14 is communication process between systems and devices for providing a delayed notification, in accordance with some embodiments of the disclosure;

FIG. 15 is communication process between systems and devices using an API for executing a specific action associated with the actionable object, in accordance with some embodiments of the disclosure;

FIG. 16 is an example of structuring metadata in the payload for delayed notification in an iMessage, in accordance with some embodiments of the disclosure;

FIG. 17 is communication process between systems and devices when a unique message identifier is embedded within the UDH, in accordance with some embodiments of the disclosure;

FIG. 18 is an example of structuring metadata for scheduled notification in an iMessage, in accordance with some embodiments of the disclosure;

FIG. 19 is communication process between systems and devices for executing a scheduled notification, in accordance with some embodiments of the disclosure;

FIG. 20 is communication process between systems and devices when biometric authentication is used, in accordance with some embodiments of the disclosure;

FIG. 21 is an example of structuring metadata for automatically deleting a message in iMessage, in accordance with some embodiments of the disclosure;

FIG. 22 is communication process between systems and devices when biometric authentication is used and a message is automatically deleted based on various deletion factors, in accordance with some embodiments of the disclosure;

FIG. 23 is communication process between systems and devices for tracking an engagement metric related to engagement with the message, in accordance with some embodiments of the disclosure;

FIG. 24 is communication process between systems and devices for using a calendaring and reminding function for the recipient of the message, in accordance with some embodiments of the disclosure;

FIG. 25 is a user interface for generating a message and associating an actionable object, such as an emoji, with the message, in accordance with some embodiments of the disclosure;

FIG. 26 is an example of using a same actionable object for all recipients in a group, in accordance with some embodiments of the disclosure;

FIG. 27 is an example of using a different instruction for each recipient in a group setting, in accordance with some embodiments of the disclosure;

FIG. 28 is an example of including an instruction that is interdependent on an action executed for other recipients in a group setting, in accordance with some embodiments of the disclosure;

FIG. 29 is an example of using an actionable object with an instruction that may be interpreted by each recipient device based on the recipient device's contextual data, in accordance with some embodiments of the disclosure;

FIG. 30 is an example of using distinct actionable objects, each with distinct instructions, for each recipient in the group that is to receive the same message, in accordance with some embodiments of the disclosure; and

FIG. 31 is a flowchart of a process for composing a message and an actionable object for plurality of recipients in a group setting.

### DETAILED DESCRIPTION

In accordance with some embodiments disclosed herein, some of the above-mentioned limitations are overcome by utilizing an actionable object to integrate a contextual command or instruction with a message and transmitting the message to a recipient device with the accompanying command or instruction associated with the actionable object. The recipient device decodes the command or instruction associated with the actionable object to execute a specific action, as provided by the contextual command, when contextual data associated with the recipient device satisfies a trigger condition, also referred to as condition, as specified by the contextual command.

In some embodiments, a message is composed by a user using a messaging application, such as WhatsApp, social media chat applications, email applications, text messaging applications, or chat applications, such as Google chat. The message may be an SMS, MMS, RCS, email message, or another type of message. The message may or may not have attachments.

An actionable object may be selected and inserted for the message into the message composing area. For example, a user may drag and drop into a body of the message an actionable object that is relevant to the context of the message from an actionable object library displayed on a user interface of the messaging application. In another example, the user may utter a voice command to insert the actionable object from a library, or to search for it and then have it inserted.

In some embodiments, the actionable object may contextually relate to the composed message. In other embodiments, the actionable object may be distinct from the message and may not relate to the content or context of the message. For example, the actionable object may relate to the timing of delivering the message and may not be related to the content of the message.

The actionable object may be associated with a command or instruction that includes a specific action for the recipient device to execute upon the recipient device determining that one or more contextual conditions are satisfied.

In some embodiments, the sending device that transmits the message, or the associated server, may format and transmit the message such that the command/instruction associated with the actionable object is separated or distinct from the message. For example, the command/instruction may be embedded in a header of the packet while the body of the message is embedded in the payload. Other formats may also be used to ensure that the command/instruction is formatted or otherwise packaged with, but distinct from, the message. Separating the command/instruction allows the receiving device to a) identify that the message includes a command/instruction that is to be processed, and b) process the command/instruction separately from processing and displaying the message, or a notification of the message. The instructions, although included separately from the message, may be sent in the same or different data packet as the message. The system may also assign a unique identifier to each message when it is transmitted to indicate that an actionable object that includes a command/instruction is associated with the message.

The recipient device may receive the message and the accompanied command/instruction. It may then parse and analyze the instruction to determine the triggering condition, which may be a contextual awareness condition, and the action to be taken upon occurrence of the triggering condition. The recipient device may then monitor the recipient device or user of the recipient device and obtain current contextual awareness data associated with the recipient to determine whether the contextual awareness data triggers the action to be taken. For example, the recipient device may access an application of the receiving device to perform the monitoring of contextual awareness data. In another example, the recipient device may monitor the usage of the application, such as use of a gaming application by the recipient, use of a phone application, use of a media player application, all of which may indicate the type of activity the recipient is engaged in. Such monitoring may be performed by the recipient device or other devices from which current contextual awareness data may be obtained. The messaging application associated with the recipient device may execute the action as indicated in the instructions when the obtained contextual awareness data satisfies the contextual awareness condition indicated in the instruction.

Once the message is delivered to the recipient and the action as indicated in the instruction associated with the actionable object is executed, then engagement metrics that include detailed engagement data, if authorized by the recipient, may be provided to the sender of the message. Such engagement metrics may include detailed engagement data of how the recipient engaged with the message and may go well beyond a read receipt.

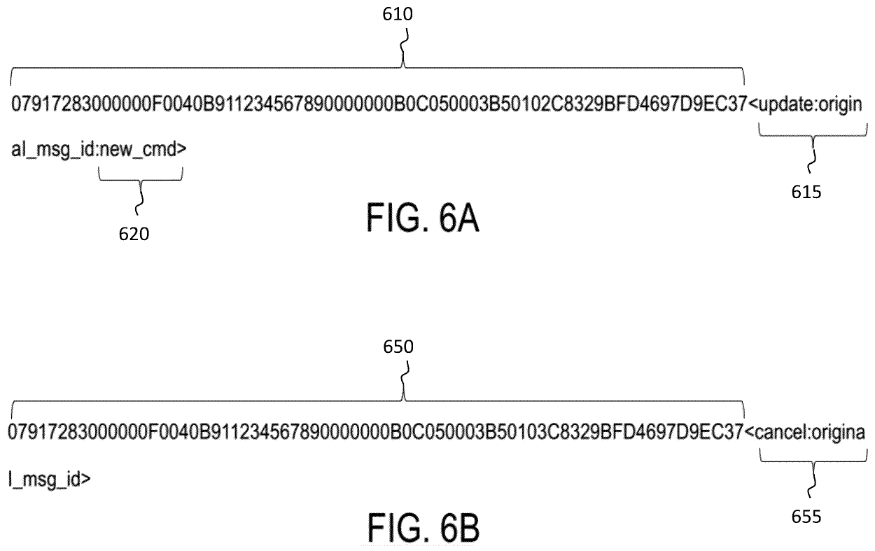

In some embodiments, as described in further detail at least in FIGS. 6A, 6B, 9, 11, and 17, once the message has been delivered, it may be updated or cancelled by the sender. Such update or cancellation may be performed by a subsequent follow-up message with metadata sent to update the previously sent instructions associated with the actionable object. Such update or cancellation may be performed once a determination is made that the recipient has not already read the message and the instruction from the previous message was not already executed.

In some embodiments, a message may be a group message that is sent to a group of recipients, each of whom may receive a unique actionable object with an associated command/instruction. When a group message is sent, in some embodiments, the sender may have a plurality of options to select one or more actionable objects for transmitting the message to the group.

In a first embodiment, the same actionable object may be selected by the sender to send to all the recipients in the group. In this embodiment, the actionable object may include instructions on how to handle the message for each recipient based on their contextual data. For example, if the message instructions are to deliver the message when the recipient wakes up, since each recipient may wake up from overnight sleep at different times, the action to deliver the message after waking up may vary by recipient.

In a second embodiment, conditional relationships between recipients may be established through a selection of actionable objects. Such conditional relationships may be used to determine the sequence or execution of actions as provided by the instructions in the actionable objects. For example, one recipient's action or condition may trigger a specific action for another recipient within a predetermined timeframe. For example, the instructions provided in the actionable object may be to deliver the message to a second recipient only after the message is read by the first recipient or only after the message is delivered to the first recipient after they wake up. As such, the execution of an action for the second recipient in the group may be dependent upon the execution of action for the first recipient. Accordingly, one or more conditions, included nested conditions and if this then that type of instructions may tie execution of actions between recipients of the group.

In a third embodiment, the sender may include separate actionable objects within the same message, specifying which actionable object applies to which recipient. These actionable objects could be distinct or related, with their implementation varying based on different commands and associated instructions associated with each actionable object for each recipient for whom it is directed. For example, actionable object A may be directed for recipient 1 and may have different instructions than actionable object B, which may be directed for recipient 2.

In yet another embodiment, although the actionable object may be the same for each recipient of the group, the instructions to each separate recipient device may be to interpret the instructions associated with the actionable object according to their contextual circumstances when the message is read or accessed. For example, while the actionable object selected for the message may include instructions to provide navigation instructions to a specific destination, which may be the same action for all recipients, the routing to that location could differ based on each recipient location and their starting points. As such, the separate recipient devices may interpret the instructions associated with the actionable object according to their location and generate appropriate directions when the message is read or accessed. In brief, in this embodiment, although the core instructions to all the recipients in the group may be identical, e.g., to provide navigational directions to the same destination, the specific implementation might vary across recipients due to their unique contextual data.

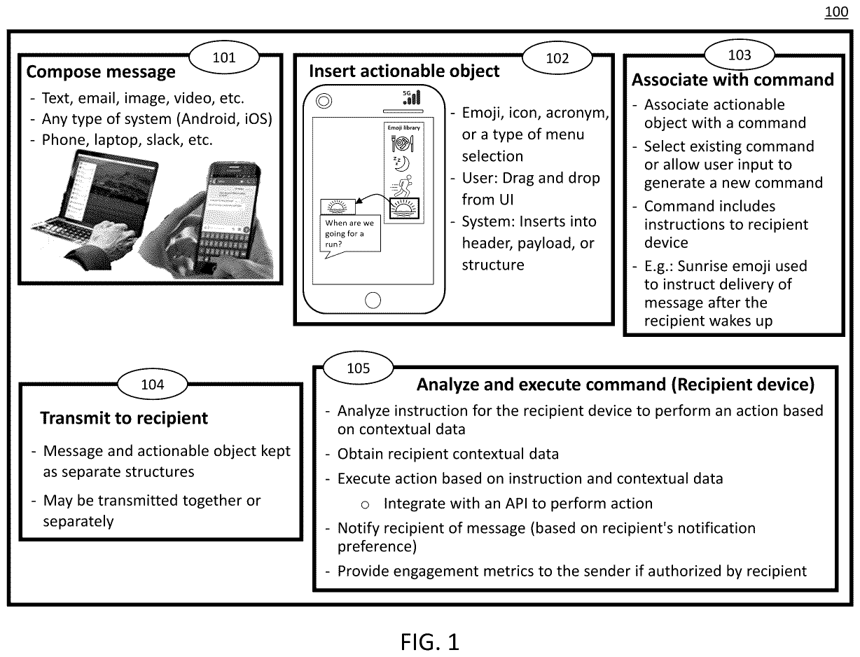

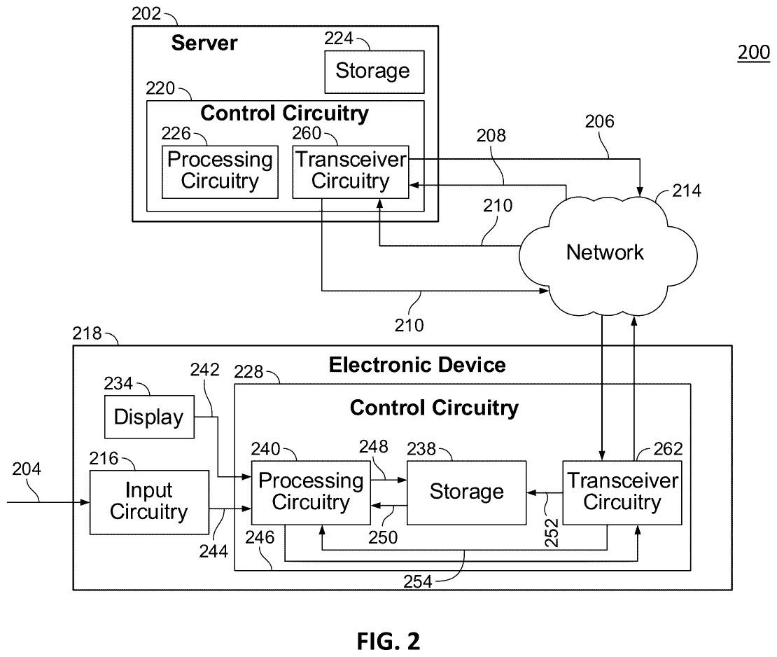

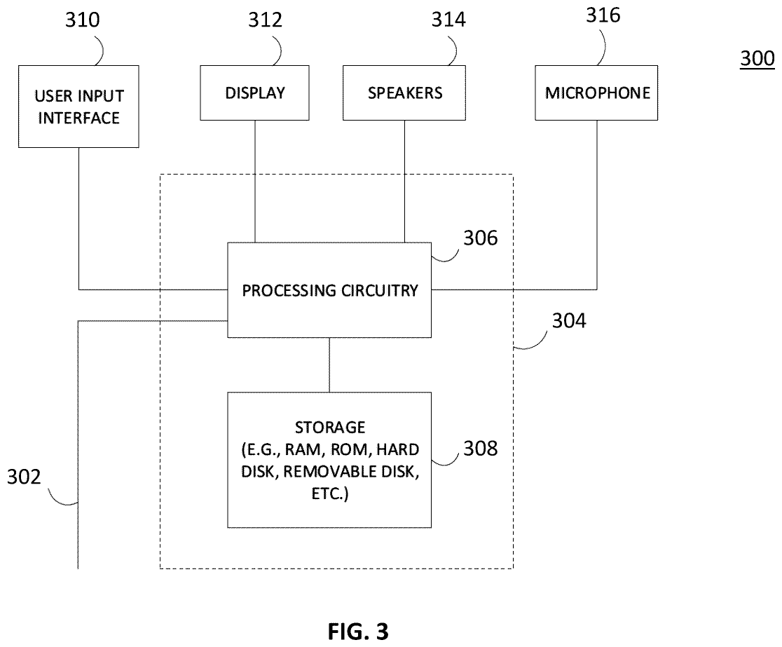

Turning now to figures, FIG. 1 is a block diagram of a process 100 for executing an action based on triggering of a contextual awareness condition specified by an instruction associated with a message, in accordance with some embodiments of the disclosure. The process 100 may be implemented, in whole or in part, by systems or devices such as those shown in FIGS. 2 and 3. One or more blocks or actions of the process 100 may be incorporated into or combined with one or more blocks or actions of any other process or embodiment described herein. The process 100 may be saved to a memory or storage (e.g., any one of those depicted in FIGS. 2 and 3) as one or more instructions or routines that may be executed by a corresponding device or system to implement the process 100.

In some embodiments, at block 101, a message is composed by a user. The message may be a SMS (Short message service), MMS (Multimedia messaging service), or an RCS (Rich communications service) message. The message may also be an iMessage, Slack message, Microsoft Teams message, Google chat message, Discord message, a message that uses OTT (over-the-top) messaging application (such as WhatsApp, Telegram, or Signal), or a social media chat message (such as Facebook messenger, Instagram Direct, and Snapchat). It may also be an email application, such as Gmail or Outlook. The message referred to herein may be on any type of messaging platform, such as WhatsApp, Telegram, Signal and others discussed herein, or on any operating system, such as Android or iOS operating system.

The message may be composed using a smartphone, laptop, desktop, smartwatch or other wearable device, virtual or augmented reality device, tablet computers, or any other device that is capable of receiving user input for constructing a message and transmitting the message. For example, automobile applications, gaming consoles, TVs, may also be used to perform the embodiments described herein.

The composed message may include text, images, videos, GIFs, documents, location pins, contacts, symbols, emojis, sound emojis, icons, audio files, or any combination thereof. The composed message may also be an email in which an actionable object may be included.

At block 102, an actionable object may be inserted. The actionable object may be an emoji, icon, acronym, or any type of menu option offered to a user for selection. The actionable object may also be an image, GIF, or text that is made actionable. The actionable object may be associated with a command/instruction that instructs a recipient device to execute an action when a contextual awareness condition is satisfied. For example, the actionable object may be an emoji of a sunrise which may be associated with a command that instructs the recipient device to perform an action, which may be to deliver the text message and notify the recipient, when a contextual awareness condition, such as the recipient waking up in the morning, may be satisfied. Other types of actionable objects may include a sunrise, sunset, that may be associated with delivering the message at a particular time or when the recipient is awake or prior to going to bed. Another example of an actionable object may be a school sign, a school bus, or something that can remind the recipient of a school and the command associated with the actionable object may be to send the message, such as the following message: “Don't forget to pick up the kids from school” a few minutes before school ends, which may be at different times on different days. Such a reminder message may also be sent if the recipient's current location is determined to be too far from the school for the recipient to arrive on time at the school for pickup, considering factors like distance and travel time.

The command or instruction associated with the actionable object may be placed into a data packet separately from the message. For example, it may be embedded as metadata in a data packet header of the message or attached to a payload. The data packet, which may contain the message content, along with information like the sender and recipient's phone numbers, may also include metadata, e.g., command/instruction, associated with the actionable object. In some embodiments, the sending device that transmits the message, or the associated server, may format and transmit the message such that the command/instruction associated with the actionable object is separated from the message. For example, the command/instruction may be embedded in a header of the packet while the message is embedded in the payload. Other formats may also be used to ensure that the command/instruction is formatted or otherwise packaged with, but distinct from, the message. Separating the command/instruction allows the receiving device to a) identify that the message includes a command/instruction that is to be processed and b) process the command/instruction separately from processing the message. The instructions, although included separately from the message, may be sent in the same or different data packet than the message.

In some embodiments, a user can insert an actionable object using the user interface displayed on the user device, such as a smartphone, smartwatch, laptop, or computer tablet. The insertion may be performed, for example, by the user dragging and dropping an actionable object from a menu into the message composition area or double-click on an object to automatically insert it. The system may suggest related actionable objects based on the message content and context. The user may also select multiple objects to insert.

In some embodiments, when composing a message, such as an SMS text message using a smartphone, the sender may be able to select an actionable object from a menu or type in a keyword for related actionable objects to be displayed in a section of the user interface. This actionable object upon user section, or system selection, may be displayed in line with other emojis, such as non-actionable happy face emoji, or in a separate section of the user interface. The actionable object may also be hidden initially and revealed when certain options are selected, or it could have a limited display time.

In some embodiments, the system may display the actionable object anywhere within the message. It may display the actionable object at the top, bottom, or sides of the message. The user may be able to preview the actionable object before sending, allowing for confirmation, such as by selecting the message, hovering over the message, or sliding the message when the actionable object is hidden on the sender's user interface. In other embodiments, the actionable object may be visible, and the user may select it or perform gestures like sliding or long-touching the message or use voice commands to get more information related to the actionable object that will be accompanying the message. In yet other embodiments, the actionable object may be inserted based on voice commands. When the actionable object is inserted, the sender device may format and transmit the message such that the command or instruction associated with the actionable object is separated from the message such that the recipient device may process the actionable object separate from the message.

The system may also recommend multiple actionable object options based on the content and context of the message, which the user may select by dragging, double-clicking, hovering, or simply selecting. The system may also recommend actionable object options based on the identity of the recipient and the relationship of the recipient to the sender. The system may also recommend actionable object options based on other factors such as frequency of communications between sender and recipient and their comfort level with each other. The recommendations may be adopted by the user by inserting the actionable object into the message composition area, which may result in the command/instruction associated with the actionable object being separately formatted in a data packet, such as in a header, that the message.

The system may also recommend one or more actionable object options based on user history, user pattern or use, which may be obtained based on using machine learning (ML) algorithms. For example, the system may invoke an ML engine to execute an ML algorithm to analyze user patterns and suggest relevant actionable objects.

In some embodiments, instead of the user selecting actionable objects, the system may automatically suggest them and automatically include them with the message without user intervention. In other embodiments, the system may insert the recommended actionable objects once the user approves it.

The user may also modify the system's suggestions and query the system to provide more choices of actionable objects under the same recommended genre. For instance, if the system suggests a calendaring-related actionable object, the user may enter a query seeking more choices of actionable objects, which may then lead the system to provide a variety of actionable object choices relating to the calendaring category. In some embodiments, the system may recommend actionable objects based on the user's history or suggestions from ML and/or AI algorithms.

At block 103, in some embodiments, regardless of whether the user selects the actionable object, the system automatically selects the actionable object and associates it with the message without user intervention, or the system associates a recommended actionable object after the user approves of the recommendation, once the actionable object is selected, the actionable object may be associated or linked with a command that provides specific instructions for the recipient device to execute an action when a contextual awareness condition is satisfied.

In some embodiments, the command might already be associated with the selected actionable object. In other embodiments, the command may be generated after the actionable object is selected. In yet another embodiment, the user may be able to customize both the actionable object and its associated command by providing input. In yet other embodiments, the user may be provided options to modify the specific commands/instructions and/or actions associated with a recommended actionable object.

By associating a command/instruction with the message, the system utilizes contextual awareness data to enhance the message's execution, such as, for example, by delivering the message to the recipient when it matters the most, when the timing of the delivery is appropriate, or when the recipient is not busy or distracted. These commands/instructions may be translated into metadata that may be placed into packet headers, separate from the message, ensuring that specific actions are executed by the recipient device. A command/instruction may also be embedded within the payload of the data packet if the message is located in another section of the data packet that is separate from where the command/instruction is located. This system addresses the need for contextually appropriate message delivery and management, providing users with control over timing, visibility, and security.

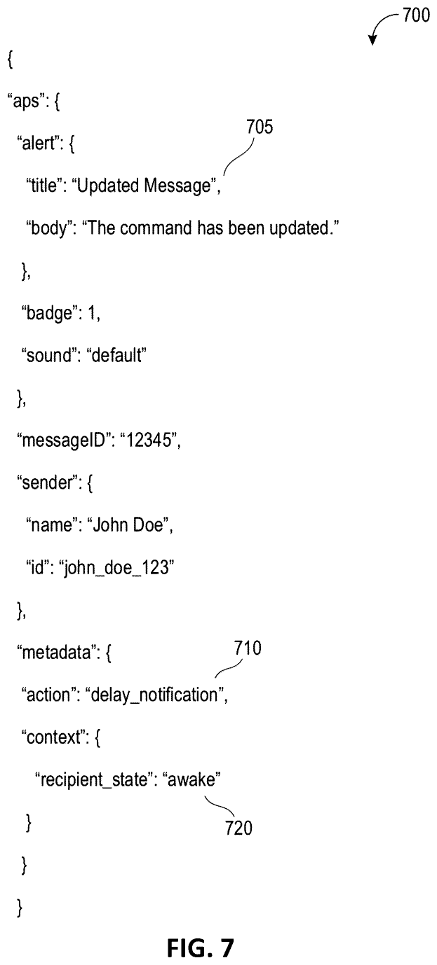

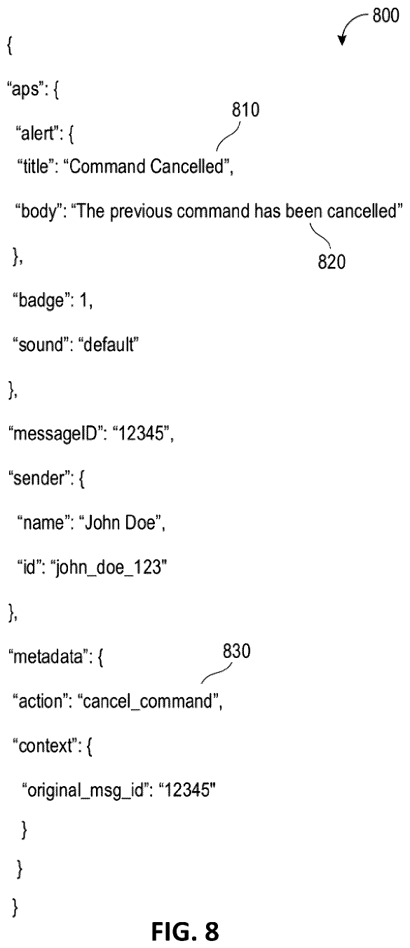

Upon selecting an actionable object, in some embodiments, the system may translate it into a corresponding command. For example, in modern messaging platforms like iMessage or RCS, this command may be attached as metadata and transmitted to the recipient device. If the sender decides to update or remove the command after the message has been sent, they may access the sent message, modify the command, and resend the updated metadata. For SMS messages, the command may be included in the User Data Header (UDH) or encoded in the User Data (UD) field and transmitted to the recipient device. Doing as such may ensure that the command data is part of the SMS payload but separate from the visible message content. If the user wishes to delete or modify the command in an SMS message, the system simulates updating a previously sent message by sending a follow-up SMS with special metadata indicating the update. An example of an update or cancelation command is depicted in FIGS. 6A and 6B. Another example of an update or cancelation command when using iMessage is depicted in FIGS. 7 and 8.

At block 104, the message and the actionable object with its associated command/instruction may be transmitted to the recipient device. In one embodiment, the message and the command/instruction associated with the actionable object may be separate data structures that are transmitted together to the recipient device. In another embodiment, the message and the command/instruction associated with the actionable object may be transmitted separately to the recipient device.

In one embodiment, the actionable object may be translated into a command by the system, embedded in a header as metadata or payload of a data packet, and transmitted to the recipient device.

In some embodiments, for an SMS, the command/instruction may be embedded in the UDH or UD field using a predefined format to ensure it is transmitted with the message body. For example, in an SMS transmission, when the command/instruction is embedded and it relates to, for example, scheduling or deletion of the command once sent, the scheduling command may be directly embedded within the UDH or UD with the scheduling or deletion information.

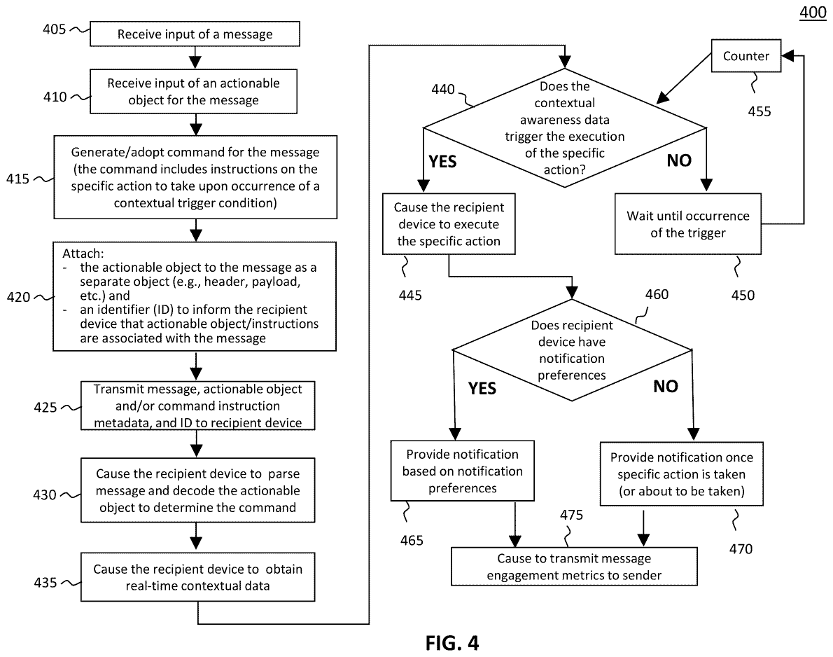

In some embodiments, the system may assign a unique identifier to each message when it is transmitted. This unique identifier may be included in the header or payload metadata and stored in both the sender's and recipient's messaging applications. In yet other embodiments, when using modern messaging platforms like iMessage, Gmail, Outlook, or RCS, the unique identifier may be a part of the message payload and can be a UUID (Universally Unique Identifier) that may be used to ensure that each message can be distinctly referenced. Additional details relating to various transmission processes for various platforms and types of actions to be implemented by the recipient device are described in further detail in the discussion of FIGS. 4-25.

At block 105, the recipient device may receive the message and the accompanied actionable object (or the command or instructions) and analyze and execute the command/instruction associated with the actionable object. In some embodiments, the recipient device may receive the message and the command/instruction, instead of the actionable object, or just the instructions from the command in the metadata. Upon receipt, the system may analyze the command and/or instructions, whichever is received, to execute the actions to be performed, as indicated in the instructions, when a contextual awareness condition relating to the recipient device is satisfied.

This process may include the recipient device analyzing the incoming message and the command/instruction received. The recipient device may obtain recipient's real-time contextual data and execute one or more specific actions as instructed by the command/instruction based on the obtained contextual data. In other words, if the recipient associated with the recipient device's current state, which is obtained via analysis of contextual data, meets the contextual conditions stated in the command, then the actions stated in the command may be executed. For example, the contextual conditions may be to deliver the message, such as an SMS, to the recipient when the recipient wakes up, is not busy, is not in a meeting, is not watching their favorite show on TV, is not in a movie theatre, etc. In another example, an instruction associated with the contextual conditions may be to analyze scheduling data by accessing a calendar and then scheduling an action, such as calendaring an upcoming event. In yet another example, an instruction associated with the contextual conditions may be to determine the recipient's location data, and if the location triggers an action indicated in the actionable object, then executing that action. Such contextual data of the recipient's current status may be obtained by the recipient device by monitoring the recipient using the recipient device's camera, microphone, or other devices, such as home assistants. In yet other embodiments, contextual data may be obtained from a motion sensor, pedometer, smart watch, or by making an API call to another monitoring device, which are not intrusive and protect the recipient's privacy. In yet other embodiments, contextual data may be obtained from other applications that are installed on the recipient device. For example, such contextual data may be obtained by accessing a gaming application installed on the receiving device that when accessed indicates that a user is playing a video game on the gaming application. In another example, such contextual data may be obtained by accessing a phone application installed on the receiving device that when accessed indicates that a user is busy since the user is engaged on a phone call using the phone application. In yet other examples, such contextual data may be obtained from applications, such as a media player application, a running application, and/or a do-not-disturb application installed on the receiving device.

To perform certain actions indicated in the command, once the contextual awareness conditions are met, the recipient device may integrate various applications via an API. For example, an API call may be made to an application, also referred to as a second application or external application that is distinct from the messaging application, associated with a calendar, navigation, gaming, home IoT device, or OTT service. In such embodiments, where an API call is made, there may be two commands or two sets of instructions, the first command/set of instructions may be to the recipient device, such as to delay the message, and the second command/set of instructions may be to make the API call and how to use the external application. In yet other embodiments, a third command/set of instructions may include how to make the API call, what data to obtain from the external application, or instructions for the external application to perform a second action. Once an action has been executed, such as a message delivered to the recipient device, the recipient device may also notify the recipient of message (based on recipient's notification preferences).

In some embodiments, the recipient device may read the UDH or UD to execute the command/instruction, which may be hidden from the recipient, to and execute the actions as directed by the command/instruction based on the real-time contextual awareness data.

In some embodiments, when a UUID is used and embedded in the UDH or UD field, upon receiving the message with the unique identifier, which may be associated with a command such as to delay notification, the recipient device may display a notification banner or alert. When the recipient selects this notification, the messaging application may intercept the selection event and retrieve the unique identifier from the notification metadata. The messaging application may then search its message database using this identifier to locate the specific message associated with the delayed notification. This process may involve querying the message store, which could be a local database or cloud-based storage, to find the message that matches the unique identifier. In this embodiment, the unique message identifier may be embedded within the UDH, allowing the recipient device to extract it and perform a lookup. In some embodiments, the message may be augmented with contextual text to inform the recipient associated with the recipient device of the reason for the delay.

In some embodiments, the command associated with the actionable object, or its corresponding instructions, may be transmitted to the recipient device as metadata, separate from the message. Upon receiving the message, the recipient device may be able to process this metadata using AI and NLP techniques to understand the intended actions and the contextual awareness conditions required to trigger them. By leveraging AI, the system may be able to identify key elements like the action to be performed, such as delaying the notification of a message, the relevant contextual awareness conditions, and the trigger for performing the action. For example, the system may determine the recipient device's location, and initiate an action if the location meets a contextual awareness condition, such as to remind the recipient of directions to a restaurant.

In one embodiment, the command may relate to delaying the delivery of the message to the recipient device until a certain contextual awareness condition is met. In other words, the delivery is to be delayed until the recipient's current status, which is determined by the contextual data associated with the recipient device, meets the conditions for delivering the messages. For example, the contextual status may need to be that the message is to be delayed until the recipient has completed a meeting. In the embodiment, upon receiving the message, the recipient device may retrieve the metadata or the UDH/UD field to extract the delayed notification delivery command. In some embodiments, the messaging application associated with the recipient device, or the recipient device, may process the command, and take the recommended action, such as analyzing calendar data to schedule an event or determining the recipient's location to trigger a specific action, such as providing directions to a place or reminding the recipient they should be driving towards school to pick up their kids in time when school gets out. In yet other embodiments, the messaging application associated with the recipient device, or the recipient device, may process the command and take the recommended action such as delaying the notification sound or delivering the message only after the recipient has completed their meeting, which may be determined by a microphone of the recipient device listening in, when authorized by the recipient, to the meeting and an AI engine analyzing the microphone input indicating to the recipient device that the meeting has ended. The data obtained through the recipient device, or from other devices, that relate to the recipient's status may be protected and not shared to protect their privacy and may be automatically deleted after the analysis is completed. In other embodiments, permission may be sought with the recipient prior to obtaining such data. In yet other embodiments, data may be gathered such that it is not intrusive and protects the privacy of the recipient, such as pedometer data without disclosing the recipient's location.

FIGS. 4-25 describe various communication processes between systems and devices within the context of messaging platforms, embedding, and analyzing of commands, determining contextual data, and executing actions prescribed in the commands when certain contextual conditions are met. These processes include using iMessage to execute actions based on contextual triggers, utilizing UDH for commands or metadata in SMS, defining custom data coding schemes, embedding commands directly within SMS user data, providing delayed notifications, using APIs for actions, structuring metadata for scheduled notifications, executing scheduled notifications, using biometric authentication, and tracking engagement metrics. These processes described in the FIGS. 4, 5, 9-12, 14-15, 17, 19-20, and 22-24 collectively enhance message notifications by incorporating contextual commands into messages through actionable objects, such as emojis or other selection mechanisms, which are translated into metadata or headers accompanying the message body. They also allow for dynamic adaptation to the recipient's context, such as location, activity, or time zone, ensuring messages are delivered appropriately and reducing disruptions.

The embodiments of FIGS. 4-25 described below, in some embodiments, may allow use of actionable objects, such as emojis, as a shortcut for inserting complex commands or actions into metadata, which are then accompanied with the message, separately or distinctly, and transmitted to the recipient device, such as from the main SMS text if the message is an SMS message. Such use of actionable objects may allow users/sender of a message an ease of use by allowing them to select and import an actionable object into a message composing area rather than having to manually type out instructions or generate code on how the message is to be handled by the recipient device. Such use also eliminates the need for users to learn and remember specific command syntax, making the process more user friendly and efficient. For example, a “goodnight” emoji may be used to automatically generate a command to set an alarm or schedule a routine.

In some embodiments, once the message is delivered to the recipient and the action as indicated in the metadata is performed, then the control circuitry may provide engagement metrics to the sender of the message. These engagement metrics may be detailed engagement data of how the recipient engaged with the message.

FIG. 2 is a block diagram of a system for executing an action based on triggering of a contextual awareness condition specified by an instruction associated with a message, in accordance with some embodiments of the disclosure. FIG. 3 is a block diagram of a user device used for executing an action based on triggering of a contextual awareness condition specified by an instruction associated with a message, in accordance with some embodiments of the disclosure.

FIGS. 2 and 3 also describe example devices, systems, servers, and related hardware that may be used to implement processes, execute user interface operations, and all other steps, functions and functionalities described at least in relation to FIG. 1, and 4-31.

Further, FIGS. 2 and 3 may also be used for receiving a composed message, receiving a selection of an actionable object associated with the message that is to be transmitted to a recipient device, deriving metadata associated with the actionable object, where the metadata includes a command that includes a trigger for the recipient device to execute the command, causing transmission of the message and the derived metadata to the recipient device, causing the recipient device to obtain contextual awareness data relevant to the trigger, and in response to determining, based on the obtained contextual awareness data, that the trigger has been satisfied, causing the second computing device to execute the command. FIGS. 2 and 3 may also be used for composing the message and associating it with an actionable object using a messaging application, where the actionable object is selected from a library of actionable objects presented on the messaging application user interface, the selection of the actionable object being made either by the recipient device or being suggested by the system based on the content and context of the message to the recipient for selection. FIGS. 2 and 3 may also be used for instructing the recipient device to make API calls to other applications, such as calendaring, OTT service, navigation, gaming applications, for executing the command using the other applications or the other applications providing data to the messaging application for executing the command. FIGS. 2 and 3 may also be used for transmitting the message in a group setting to a plurality of recipient devices, where a single actionable object with the same command/instruction may be transmitted to all recipient devices, a single actionable object with different command/instruction for each recipient device in the group may be transmitted, a single actionable object with the command/instruction that are dependent on execution of command/instruction of other recipient devices in the group may be transmitted, different actionable object with the different command/instruction for the same message may be transmitted to different recipient devices in the group. FIGS. 2 and 3 may also be used for updating or cancelling a command after the message has been transmitted. FIGS. 2 and 3 may also be used for monitoring the recipient device and the recipient associated with the recipient device to obtain their contextual awareness data and compare the obtained data with a trigger for executing the command, and performing all functions related to all other processes and features described herein.

In some embodiments, one or more parts of, or the entirety of system 200, may be configured as a system implementing various features, processes, functionalities and components of FIG. 1, and 4-31. Although FIG. 2 shows a certain number of components, in various examples, system 200 may include fewer than the illustrated number of components and/or multiples of one or more of the illustrated number of components.

System 200 is shown to include a computing device 218, a server 202 and a communication network 214. It is understood that while a single instance of a component may be shown and described relative to FIG. 2, additional instances of the component may be employed. For example, server 202 may include, or may be incorporated in, more than one server. Similarly, communication network 214 may include, or may be incorporated in, more than one communication network. Server 202 is shown communicatively coupled to computing device 218 through communication network 214. While not shown in FIG. 2, server 202 may be directly communicatively coupled to computing device 218, for example, in a system absent or bypassing communication network 214.

Communication network 214 may comprise one or more network systems, such as, without limitation, an internet, LAN, WIFI or other network systems suitable for audio processing applications. In some embodiments, system 200 excludes server 202, and functionality that would otherwise be implemented by server 202 is instead implemented by other components of system 200, such as one or more components of communication network 214. In still other embodiments, server 202 works in conjunction with one or more components of communication network 214 to implement certain functionality described herein in a distributed or cooperative manner. Similarly, in some embodiments, system 200 excludes computing device 218, and functionality that would otherwise be implemented by computing device 218 is instead implemented by other components of system 200, such as one or more components of communication network 214 or server 202 or a combination. In still other embodiments, computing device 218 works in conjunction with one or more components of communication network 214 or server 202 to implement certain functionality described herein in a distributed or cooperative manner.

Computing device 218 includes control circuitry 228, display 234 and input circuitry 216. Control circuitry 228 in turn includes transceiver circuitry 262, storage 238 and processing circuitry 240. In some embodiments, computing device 218 or control circuitry 228 may be configured as electronic device 300 of FIG. 3.

Server 202 includes control circuitry 220 and storage 224. Each of storages 224 and 238 may be an electronic storage device. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 4D disc recorders, digital video recorders (DVRs, sometimes called personal video recorders, or PVRs), solid state devices, quantum storage devices, gaming consoles, gaming media, or any other suitable fixed or removable storage devices, and/or any combination of the same. Each storage 224, 238 may be used to store various types of content (e.g., actionable objects, command/instructions associated with the actionable object, messages composed using the message application, contact list of all the recipients, notification preferences of each recipient device, calendar data, delay data, modified or cancellation of a command, information relating to device types and operating systems used by the sender and recipient device, and authorization information, and, AI and ML algorithms). Non-volatile memory may also be used (e.g., to launch a boot-up routine, launch an app, render an app, and other instructions). Cloud-based storage may be used to supplement storages 224, 238 or instead of storages 224, 238. In some embodiments, data relating actionable objects, command/instructions associated with the actionable object, messages composed using the message application, contact list of all the recipients, notification preferences of each recipient device, calendar data, delay data, modified or cancellation commands, information relating to device types and operating systems used by the sender and recipient device, and authorization information, and, AI and ML algorithms, and data relating to all other processes and features described herein, may be recorded and stored in one or more of storages 212, 238.

In some embodiments, control circuitry 220 and/or 228 executes instructions for an application stored in memory (e.g., storage 224 and/or storage 238). Specifically, control circuitry 220 and/or 228 may be instructed by the application to perform the functions discussed herein. In some implementations, any action performed by control circuitry 220 and/or 228 may be based on instructions received from the application. For example, the application may be implemented as software or a set of executable instructions that may be stored in storage 224 and/or 238 and executed by control circuitry 220 and/or 228. In some embodiments, the application may be a client/server application where only a client application resides on computing device 218, and a server application resides on server 202.

The application may be implemented using any suitable architecture. For example, it may be a stand-alone application wholly implemented on computing device 218. In such an approach, instructions for the application are stored locally (e.g., in storage 238), and data for use by the application is downloaded on a periodic basis (e.g., from an out-of-band feed, from an internet resource, or using another suitable approach). Control circuitry 228 may retrieve instructions for the application from storage 238 and process the instructions to perform the functionality described herein. Based on the processed instructions, control circuitry 228 may determine a type of action to perform in response to input received from input circuitry 216 or from communication network 214. For example, in response to detecting a trigger condition that the recipient is sleeping or busy, the system may delay notification of the message to the recipient device until, for example, the recipient is awake or no longer busy, as indicated in the instructions related to the trigger condition. The control circuitry 228 may also perform steps of processes described in the figures.

In client/server-based embodiments, control circuitry 228 may include communication circuitry suitable for communicating with an application server (e.g., server 202) or other networks or servers. The instructions for carrying out the functionality described herein may be stored on the application server. Communication circuitry may include a cable modem, an Ethernet card, or a wireless modem for communication with other equipment, or any other suitable communication circuitry. Such communication may involve the internet or any other suitable communication networks or paths (e.g., communication network 214). In another example of a client/server-based application, control circuitry 228 runs a web browser that interprets web pages provided by a remote server (e.g., server 202). For example, the remote server may store the instructions for the application in a storage device. The remote server may process the stored instructions using circuitry (e.g., control circuitry 228) and/or generate displays. Computing device 218 may receive the displays generated by the remote server and may display the content of the displays locally via display 234. This way, the processing of the instructions is performed remotely (e.g., by server 202) while the resulting displays, such as the display windows described elsewhere herein, are provided locally on computing device 218. Computing device 218 may receive inputs from the user via input circuitry 216 and transmit those inputs to the remote server for processing and generating the corresponding displays. Alternatively, computing device 218 may receive inputs from the user via input circuitry 216 and process and display the received inputs locally, by control circuitry 228 and display 234, respectively.

Server 202 and computing device 218 may transmit and receive content and data such as data relating to actionable objects, command/instructions associated with the actionable object, messages composed using the message application, contact list of all the recipients, notification preferences of each recipient device, calendar data, delay data, modified or cancellation commands, information relating to device types and operating systems used by the sender and recipient device, and authorization information, and, AI and ML algorithms and input from primary devices and secondary devices, such as messages and actionable objects associated with the messages. Control circuitry 220, 228 may send and receive commands, requests, and other suitable data through communication network 214 using transceiver circuitry 260, 262, respectively. Control circuitry 220, 228 may communicate directly with each other using transceiver circuits 260, 262, respectively, avoiding communication network 214.

It is understood that computing device 218 is not limited to the embodiments and methods shown and described herein. In nonlimiting examples, computing device 218 may be an electronic device, a personal computer (PC), a laptop computer, a tablet computer, a WebTV box, a personal computer television (PC/TV), a PC media server, a PC media center, a handheld computer, a mobile telephone, a smartphone, or any other device, computing equipment, or wireless device, and/or combination of the same capable of suitably determining trigger condition to execute a command. Control circuitry 220 and/or 218 may be based on any suitable processing circuitry such as processing circuitry 226 and/or 240, respectively. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors, for example, multiple of the same type of processors (e.g., two Intel Core i9 processors) or multiple different processors (e.g., an Intel Core i7 processor and an Intel Core i9 processor). In some embodiments, control circuitry 220 and/or control circuitry 218 is configured for receiving a composed message, receiving a selection of an actionable object associated with the message that is to be transmitted to a recipient device, deriving metadata associated with the actionable object, where the metadata includes a command that includes a trigger for the recipient device to execute the command, causing transmission of the message and the derived metadata to the recipient device, causing the recipient device to obtain contextual awareness data relevant to the trigger, and in response to determining, based on the obtained contextual awareness data, that the trigger has been satisfied, causing the second computing device to execute the command. The control circuitry 220 and/or control circuitry 218 is also configured for composing the message and associating it with an actionable object using a messaging application, where the actionable object is selected from a library of actionable objects presented on the messaging application user interface, the selection of the actionable object being made either by the recipient device or being suggested by the system based on the content and context of the message to the recipient for selection, and the insertion of the actionable object may be by the drag and drop, voice command, or a swiping action. The control circuitry 220 and/or control circuitry 218 is also configured for instructing the recipient device to make API calls to other applications, such as calendaring, OTT service, navigation, gaming applications, for executing the command using the other applications or the other applications providing data to the messaging application for executing the command. The control circuitry 220 and/or control circuitry 218 is also configured for transmitting the message in a group setting to a plurality of recipient devices, where a single actionable object with the same command/instruction may be transmitted to all recipient devices, a single actionable object with different command/instruction for each recipient device in the group may be transmitted, a single actionable object with the command/instruction that are dependent on execution of command/instruction of other recipient devices in the group may be transmitted, different actionable object with the different command/instruction for the same message may be transmitted to different recipient devices in the group. The control circuitry 220 and/or control circuitry 218 is also configured for updating or cancelling a command after the message has been transmitted. The control circuitry 220 and/or control circuitry 218 is also configured for monitoring recipient device and the recipient associated with the recipient device to obtain their contextual awareness data and compare the obtained data with a trigger for executing the command, and performing all functions related to all other processes and features described herein.

Computing device 218 receives a user input 204 at input circuitry 216. For example, computing device 218 may receive a composed message, or an indication of a message being composed. Computing device 218 may also receive a selection of an actionable object for the composed message, or the message being composed.

Transmission of user input 204 to computing device 218 may be accomplished using a wired connection, such as an audio cable, USB cable, ethernet cable or the like attached to a corresponding input port at a local device, or may be accomplished using a wireless connection, such as Bluetooth, Wi-Fi, WiMAX, GSM, UTMS, CDMA, TDMA, 3G, 4G, 4G LTE, 5G, 5G sidelink (5G NRV2X), 6G, or any other suitable wireless transmission protocol. Input circuitry 216 may comprise a physical input port such as a 3.5 mm audio jack, RCA audio jack, USB port, ethernet port, or any other suitable connection for receiving audio over a wired connection or may comprise a wireless receiver configured to receive data via Bluetooth, Wi-Fi, WiMAX, GSM, UTMS, CDMA, TDMA, 3G, 4G, 4G LTE, or other wireless transmission protocols.

Processing circuitry 240 may receive input 204 from input circuitry 216. Processing circuitry 240 may convert or translate the received user input 204 that may be in the form of voice input into a microphone. In some embodiments, input circuitry 216 performs the translation to digital signals. In some embodiments, processing circuitry 240 (or processing circuitry 226, as the case may be) carries out disclosed processes and methods. For example, processing circuitry 240 or processing circuitry 226 may perform processes as described in FIGS. 1, 4-5, 9-12, 14-15, 17, 19-20, 22-24, and 31, respectively.

FIG. 3 is a block diagram of a user device used for executing an action based on triggering of a contextual awareness condition specified by an instruction associated with a message, in accordance with some embodiments of the disclosure. In an embodiment, the equipment device 300, is the same equipment device 202 of FIG. 2. The equipment device 300 may receive content and data via input/output (I/O) path 302. The I/O path 302 may provide audio content (e.g., play audio files that are attached to the message, play audio or sound emojis, play sounds as instructed in the metadata, such as a notification sound). The control circuitry 304 may be used to send and receive commands, requests, and other suitable data using the I/O path 302. The I/O path 302 may connect the control circuitry 304 (and specifically the processing circuitry 306) to one or more communications paths or links (e.g., via a network interface), any one or more of which may be wired or wireless in nature. Messages and information described herein as being received by the equipment device 300 may be received via such wired or wireless communication paths. I/O functions may be provided by one or more of these communications paths or intermediary nodes but are shown as a single path in FIG. 3 to avoid overcomplicating the drawing.

The control circuitry 304 may be based on any suitable processing circuitry such as the processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 or i9 processor). In client-server-based embodiments, the control circuitry 304 may include communications circuitry suitable for receiving and transmitting receiving a composed message, receiving a selection of an actionable object associated with the message that is to be transmitted to a recipient device, deriving metadata associated with the actionable object, where the metadata includes a command that includes a trigger for the recipient device to execute the command, causing transmission of the message and the derived metadata to the recipient device, causing the recipient device to obtain contextual awareness data relevant to the trigger, and in response to determining, based on the obtained contextual awareness data, that the trigger has been satisfied, causing the second computing device to execute the command. The communications circuitry may also be suitable for composing the message and associating it with an actionable object using a messaging application, where the actionable object is selected from a library of actionable objects presented on the messaging application user interface, the selection of the actionable object being made either by the recipient device or being suggested by the system based on the content and context of the message to the recipient for selection. The communications circuitry may also be suitable for instructing the recipient device to make API calls to other applications, such as calendaring, OTT service, navigation, gaming applications, for executing the command using the other applications or the other applications providing data to the messaging application for executing the command. The communications circuitry may also be suitable for transmitting the message in a group setting to a plurality of recipient devices, where a single actionable object with the same command/instruction may be transmitted to all recipient devices, a single actionable object with different command/instruction for each recipient device in the group may be transmitted, a single actionable object with the command/instruction that are dependent on execution of command/instruction of other recipient devices in the group may be transmitted, different actionable object with the different command/instruction for the same message may be transmitted to different recipient devices in the group. The communications circuitry may also be suitable for updating or cancelling a command after the message has been transmitted. The communications circuitry may also be suitable for monitoring recipient device and the recipient associated with the recipient device to obtain their contextual awareness data and compare the obtained data with a trigger for executing the command, and performing all functions related to all other processes and features described herein.

The instructions for carrying out the above-mentioned functionality may be stored on one or more servers. Communications circuitry may include a cable modem, an integrated service digital network (ISDN) modem, a digital subscriber line (DSL) modem, a telephone modem, ethernet card, or a wireless modem for communications with other equipment, or any other suitable communications circuitry. Such communications may involve the internet or any other suitable communications networks or paths. In addition, communications circuitry may include circuitry that enables peer-to-peer communication of primary equipment devices, or communication of primary equipment devices in locations remote from each other (described in more detail below).

Memory may be an electronic storage device provided as the storage 308 that is part of the control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid-state devices, quantum-storage devices, gaming consoles, gaming media, or any other suitable fixed or removable storage devices, and/or any combination of the same. The storage 308 may be used to store various types of content, (e.g., actionable objects, command/instructions associated with the actionable object, messages composed using the message application, contact list of all the recipients, notification preferences of each recipient device, calendar data, delay data, modified or cancellation commands, information relating to device types and operating systems used by the sender and recipient device, and authorization information, and, AI and ML algorithms). Cloud-based storage, described in relation to FIG. 3, may be used to supplement the storage 308 or instead of the storage 308.

The control circuitry 304 may include audio generating circuitry and tuning circuitry, such as one or more analog tuners, audio generation circuitry, filters or any other suitable tuning or audio circuits or combinations of such circuits. The control circuitry 304 may also include scaler circuitry for upconverting and down converting content into the preferred output format of the electronic device 300. The control circuitry 304 may also include digital-to-analog converter circuitry and analog-to-digital converter circuitry for converting between digital and analog signals. The tuning and encoding circuitry may be used by the electronic device 300 to receive and to display, to play, or to record content. The circuitry described herein, including, for example, the tuning, audio generating, encoding, decoding, encrypting, decrypting, scaler, and analog/digital circuitry, may be implemented using software running on one or more general purpose or specialized processors. If the storage 308 is provided as a separate device from the electronic device 300, the tuning and encoding circuitry (including multiple tuners) may be associated with the storage 308.

The user may utter instructions to the control circuitry 304, which are received by the microphone 316. The microphone 316 may be any microphone (or microphones) capable of detecting human speech. The microphone 316 is connected to the processing circuitry 306 to transmit detected voice commands and other speech thereto for processing. In some embodiments, voice assistants (e.g., Siri, Alexa, Google Home and similar such voice assistants may be used for monitoring the recipient and transmitting contextual awareness data related to the recipient to the system) receive and process the voice commands and other speech.

The electronic device 300 may include an interface 310. The interface 310 may be any suitable user interface, such as a remote control, mouse, trackball, keypad, keyboard, touchscreen, touchpad, stylus input, joystick, or other user input interfaces. A display 312 may be provided as a stand-alone device or integrated with other elements of the electronic device 300. For example, the display 312 may be a touchscreen or touch-sensitive display. In such circumstances, the interface 310 may be integrated with or combined with the microphone 316. When the interface 310 is configured with a screen, such a screen may be one or more monitors, a television, a liquid crystal display (LCD) for a mobile device, active-matrix display, cathode-ray tube display, light-emitting diode display, organic light-emitting diode display, quantum-dot display, or any other suitable equipment for displaying visual images. In some embodiments, the interface 310 may be HDTV-capable. In some embodiments, the display 312 may be a 3D display. The speaker (or speakers) 314 may be provided as integrated with other elements of electronic device 300 or may be a stand-alone unit. In some embodiments, the display 312 may be outputted through speaker 314.

The equipment device 300 of FIG. 3 can be implemented in system 200 of FIG. 2 as primary equipment device 202, but any other type of user equipment suitable for allowing communications between two separate user devices for performing the functions related to exchange messages and actionable objects and implementing machine learning (ML) and artificial intelligence (AI) algorithms, and all the functionalities discussed associated with the figures mentioned in this application.

FIG. 4 is a flowchart of a process 400 for executing an action based on triggering of a contextual awareness condition specified by an instruction associated with a message, in accordance with some embodiments of the disclosure. The process 400 may be implemented, in whole or in part, by systems or devices such as those shown in FIGS. 2 and 3. One or more actions of the process 400 may be incorporated into or combined with one or more actions of any other process or embodiments described herein. The process 400 may be saved to a memory or storage (e.g., any one of those depicted in FIGS. 2 and 3) as one or more instructions or routines that may be executed by a corresponding device or system to implement the process 400.

In some embodiments, at block 405, the control circuitry 220 and/or 228 of a system, such as the system displayed in FIG. 2, may receive input of a message, such as an SMS, MMS, RCS, or an email message. The inputted message may also be an iMessage, Slack message, Microsoft Teams message, Google chat message, Discord message, email message, messages that uses OTT (over-the-top) messaging applications, such as WhatsApp, Telegram, Signal, social media chat messages, such as Facebook messenger, Instagram Direct, and Snapchat. The message may also be on any messaging platform or any operating system, such as Android or iOS operating systems.

The message inputted at 405 may be composed by a sender. For example, the sender may be using a WhatsApp messaging application to compose the message to be sent to a recipient. To do so, the sender may open the WhatsApp messaging application on their smartphone's user interface, tap on the new chat icon (or tap on a message to reply to the recipient), select the desired recipient from their contacts list or search for their name, and type the message in the message composing area using their keyboard. The sender may also voice text, swipe, or perform other gestures to compose the message. Although composing a message in WhatsApp is used as an example, the message may be composed in any type of messaging application.

At block 410, the input of an actionable object for the message is received by the control circuitry 220 and/or 228. In some embodiments, several methods may be used for inputting one or more actionable objects to messages. For example, in a first embodiment, users may manually select and insert objects from a library or menu of actionable objects displayed in a messaging user interface within the message composition area. In this first embodiment, the user may insert the actionable object into the message composing area by tapping on the actionable object or by dragging and dropping the actionable object from a menu into the message composition area or double-click on the actionable object to automatically insert it. The user may also insert the actionable object through other means, such as tapping, uttering a voice command, and gesturing. The user may be using any device, such as a smartphone, smartwatch, laptop, or computer tablet to perform this function.

In the second embodiment, the control circuitry may automatically select an actionable object from an actionable object library or database and automatically input the selected actionable object into the message without user intervention. The control circuitry may perform the selection based on the message content and context. In some embodiments, the control circuitry may analyze the message using artificial intelligence to identify relevant actionable objects. In other embodiments, the control circuitry may analyze the message and analyze user messaging and actionable object use history, such as by using a machine learning algorithm, to select the actionable object.

In the third embodiment, the control circuitry may select an actionable object from an actionable object library or database based on the message content and context, and then input the selected actionable object into the message only after user approval. In this third embodiment, the user may approve, reject, or provide further input into selection of the actionable object. For example, the user may further customize the selected actionable object by providing additional input or instructions, such as modify the command to add a certain instruction or modify the instruction.

In any of the embodiments above, e.g., the first, second, or third embodiment of inputting the actionable object into the message, the user or system may input one or more actionable objects. The user or system may also include nested actionable objects where the execution of a nested/child actionable object is dependent upon the execution of the parent actionable object. As such, if this then that (IFTTT) type rules may also be used. Such flexibility and use of nested actionable objects may enable users and the control circuitry to create complex and dynamic messages with a variety of contextual awareness conditions.

At block 415, in some embodiments, for the actionable object inputted, a command may be generated, or adopted if one already exists. In some embodiments, the actionable object may already be linked to a command, or a set of commands, which includes instructions that are to be executed by a recipient device.

If the command is already associated with the actionable object, the user or system adopting the actionable object may automatically adopt the command that is associated with the actionable object. In this embodiment, upon selecting an actionable object, the control circuitry may translate it into a corresponding command.

If the command does not already exist, then the control circuitry may generate a command, and associated instructions, based on the content and context of the message. For example, after determining the intent of the message, which may be conveying a message of good morning to someone, an actionable object may be selected and that command that includes instructions for delivering the message after the recipient wakes up from their sleep to wish them good morning may be selected.

In some embodiments, the user may be able to customize both the actionable object and its associated command, e.g., instructions associated with the command. For example, the user may instruct delivery of the message not only after the user wakes up but after the user opens their room curtains or pours a cup of coffee and is alert to engage with the message. Such contextual awareness data, such as opening of curtains or pouring of coffee may be obtained based on monitoring of the area, such as via camera, or based on input from IoT devices. Such contextual data may be obtained, in some embodiments, only after the recipient has authorized sharing of such data with their messaging application or device to perform the execution of the command.

In some embodiments, by associating a command with the selected actionable object, the control circuitry may enhance the message's execution by using contextual awareness data to perform an action associated with the command, such as when to deliver the message or notify the recipient, at an appropriate time when the recipient may be able to engage with the message.

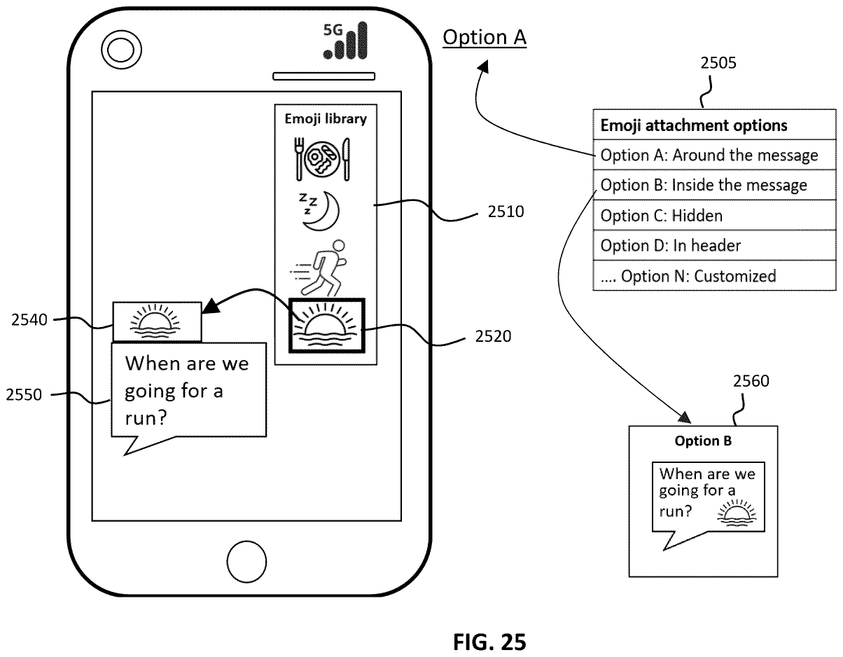

At block 420, the actionable object (with its command) may be attached to the message as a separate object. The actionable object may also be displayed on the sender's user interface associated with the sender's messaging application. In some embodiments, the display of the actionable object may be in line with other emojis or in a separate section of a sender's messaging user interface, which may be displayed within the message for the sender's convenience and understanding. An example of the display is depicted in FIG. 25. As depicted, the emoji may be displayed above or within the message in the user interface of the sender's messaging application. When the actionable object is inserted and associated with the message, the command/instruction associated with the actionable object may be attached to a specific part of the packet, such as a header, separate from the message, and the recipient device may be able to process the command/instruction separately from the message. Although some examples of where the actionable object may be displayed are provided, the embodiments include displaying the actionable object anywhere within the message. Such a display may provide visual feedback to the sender to confirm the intended action before sending the message with the actionable object.

In some embodiments, a message may be split and delivered based on different actionable objects associated with different parts of the message. For example, a message might say, “Come to the restaurant today and we can talk about our trip to Yosemite next Friday.” Accordingly, for example, two different actionable objects may be associated with this message. A first actionable object may be associated with the part about the restaurant, instructing the device to provide directions to the restaurant when a condition is triggered, and a second actionable object may be associated with a second part of the message about Yosemite, instructing the recipient device when triggered to schedule an event for next Friday on the recipient's calendar. Accordingly, different instructions for the different actionable objects may be sent to the recipient device and the different instructions may be executed by the recipient device based on different trigger conditions.

Attaching or associating the actionable object (with its command) to the message may also include translating the command into metadata that may be placed into various portions of a data packet, such as its header or payload, that accompany the message body. For example, for SMS messages, the command may be included in the User Data Header (UDH) or encoded in the User Data (UD) field and transmitted to the recipient device. Doing as such may ensure that the command data is part of the SMS payload but separate from the visible message content. If the user wishes to delete or modify the command in an SMS message, the system may simulate updating a previously sent message by sending a follow-up SMS with special metadata indicating the update. Likewise, depending on the platform used, such a SMS, MMS, RCS, or email message platform, appropriate actions may be executed to include the actionable object, its associated command, and/or metadata associated with the instructions of the command into a separate portion of a data packet that is to be transmitted to the recipient.

Also at block 420, an identifier may be attached to the message, such as included in the metadata of the message. The identifier may be used to inform the recipient device that an actionable object, command, or instructions are associated with the message. As such, by including the identifier, the recipient device may be placed on alert to lookout for the actionable object, command, or instructions and that it may need to perform additional processing in accordance with the actionable object, command, or instructions.

In some embodiments, at block 425, either the actionable object, command, metadata associated with instructions of the command, and the identifier (ID) that places the recipient device on alert to look out for the actionable object, command, or instructions, or a combination thereof, may be transmitted to the recipient device. In one embodiment, the actionable object associated with the message may be translated into a command and embedded in a data packet, such as to its header or in its payload as metadata for transmitting to the recipient device.

The process may include, for example, the sender selecting a send button on their messaging application, which may request sending of the message with the accompanying actionable object to the recipient. The sender's messaging application may receive the sender's send request, and in one embodiment transmit the message with the metadata to a messaging system, which in turn may then transmit the message and metadata to the recipient's messaging application. In another embodiment, the sender's messaging system, via the sender's device (also referred to as the first computing device), may transmit the message with the metadata directly to the recipient's messaging application on the recipient device (also referred to as second computing device).

The process of transmitting the message and the actionable object may also include assigning a unique identifier to each message when it is transmitted. This unique identifier may be included in the header or payload metadata and stored in both the sender's and recipient's messaging applications. In yet other embodiments, when using modern messaging platforms like iMessage or RCS, the unique identifier may be a part of the message payload and can be a UUID (Universally Unique Identifier) that may be used to ensure that each message can be distinctly referenced. Additional details relating to various transmission processes for various platforms and types of actions to be implemented by the recipient device are described in further detail in the discussion of FIGS. 1 and 4-31.

At block 430, the recipient's messaging application and/or the recipient device may receive the message and the metadata. The recipient's messaging application and/or the recipient device may then parse the message and decode the metadata to determine the instructions that are to be followed for taking an action on the recipient device as indicated in the metadata. In doing so, the recipient device may execute the instructions that are associated with the command and received as metadata without displaying it to the recipient, thereby maintaining a clean and clear message presentation while ensuring the contextual action is performed. In some embodiments, the recipient device may execute the instructions associated with the command in the backend, which are received as metadata, without displaying the instructions or any metadata on the recipient device. As such, a clean and clear message presentation may be maintained while ensuring the contextual action is performed. For example, if the metadata was included within the User Data Header (UDH) or encoded in the User Data (UD) field using a predefined format, then the recipient device may read the UDH or UD in the backend to execute as instructed in the instructions provided as metadata.

In some embodiments, at block 435, the control circuitry may cause the recipient device to obtain real-time contextual data. This may be to protect recipients'privacy and ensure timely delivery of the message based on the recipient's contextual data about their current status. In some embodiments, such contextual data may be obtained by the recipient device by connecting to other devices in the vicinity of the recipient. The recipient may have to authorize other devices to provide such data to the device used for reading the message received. For example, the recipient device may obtain such contextual data from its own camera or microphone, or by integrating with other devices like home assistants or smart cameras. When real-time contextual data aligns with the conditions, e.g., trigger conditions, specified in the metadata (e.g., instructions associated with the command), the recipient device may then execute specific actions as instructed by the metadata. For example, a message might be delayed until the recipient wakes up, is not busy, or has finished a meeting. By analyzing this contextual awareness data, the recipient device may follow the instructions in the metadata to deliver the message or take other actions.

At block 440, a determination may be made whether the contextual awareness data obtained by the recipient device triggers the execution of the specific action. If a determination is made that the contextual awareness data obtained by the recipient device does trigger the execution of the specific action, e.g., action indicated to be executed in the metadata, then the control circuitry at block 445 may execute the indicated specific action.

In some embodiments, depending on the nature of the action to be performed, the control circuitry may automatically, without user intervention, make an API call to another application and communicate with the other application to perform the action. For example, if the control circuitry determines that the metadata, upon meeting the contextual data trigger, requires the recipient to calendar a date or an appointment, then the control circuitry may automatically, without user intervention, perform an API call to a calendaring application used on the recipient device and calendar the date or appointment. In other embodiments, the control circuitry may seek user approval prior to calendaring the appointment or date. In another example, if the instructions in the metadata involve providing route directions such that the recipient can reach a destination, the control circuitry may make an API call to the recipient's navigation app (such as on the recipient's phone or automobile) to display a route map for the destination, if permitted by the user to do so.

In yet another example, if the instructions in the metadata involve playing a particular media asset, the control circuitry may make an API call to a database or service, such as an OTT service, and/or a media device, to access and play the media asset on the media device.

At block 460, another determination may be made by the control circuitry whether the recipient device has notification preferences. Some examples of notifications may include, turn notifications on or off, turn on airplane mode, turn off notifications if sleeping, busy, or in a meeting, set notification sounds or vibrations, e.g., on/off, level of sound or vibration, control notification banners, such as do not display name or content of message, or generate a custom notification.

If a determination is made at block 460 that the recipient device has notification preferences, then the control circuitry may follow the user's preferences at block 465. If a determination is made at block 460 that the recipient device does not have notification preferences, then the control circuitry may provide notifications once the specific action is executed (or about to be executed). In this instance, the control circuitry may use a default factory notification setting. In yet another embodiment, if a determination is made at block 460 that the recipient device does not have notification preferences, then the control circuitry may invoke an AI or ML engine to execute an AI or ML algorithm to provide and adopt notification settings and then use them automatically or seek user approval prior to adopting them.

Referring back to block 440, if a determination is made that the contextual awareness data obtained by the recipient device does not trigger the execution of the specific action, e.g., the recipient is still sleeping or is busy and as such the message is not be delivered to the recipient, then the control circuitry at block 450 may wait until the occurrence of the condition, e.g., a trigger condition, to take the action instructed in the metadata. In some embodiments, the control circuitry may periodically check for occurrence of the trigger condition and in other embodiments the control circuitry may utilize a counter 455 to check for the occurrence of the trigger condition until the counter limit, which may be predetermined, is reached.

At block 475, if the message is delivered to the recipient and the action as indicated in the metadata is performed, then the control circuitry may provide engagement metrics to the sender of the message. In some embodiments, these engagement metrics may be detailed engagement data of how the recipient engaged with the message. Such detail may go beyond basic read receipts and may offer deep insights into how the recipient interacted and engaged with the message. For example, such a metric may include time spent reading, scrolling, and content interactions by the recipient (such as copy/paste interactions with portion(s) of the message). They may also include tracking data such as whether the recipient forwarded, saved, or starred/liked the message. They may also include data such as how many times the recipient read the message. They may also include data such as whether the recipient manually took any actions based on the message (e.g., calendaring events or alarms or driving to the destination, such as a restaurant recommended in the message.)

In some embodiments, the engagement metrics may provide in-depth analysis, such as comparing current message engagement to past interactions. Such analysis may be useful to tailor their communication strategies and ensure that important messages are acknowledged.

In some embodiments, the engagement metrics may be used by the sender to send follow-up notifications if recipients only partially read or fail to interact with critical content. For example, if the recipient is to arrive at a destination and the recipient has not even started on the journey which may make them late to the destination, then a follow-up message may be sent.

In some embodiments, the recipients may customize in their preferences what can and cannot be shared in the engagement metrics with the sender. For example, the recipient may customize sharing parameters to prevent sharing of sensitive of private data or anything else they do not want to share with the sender.

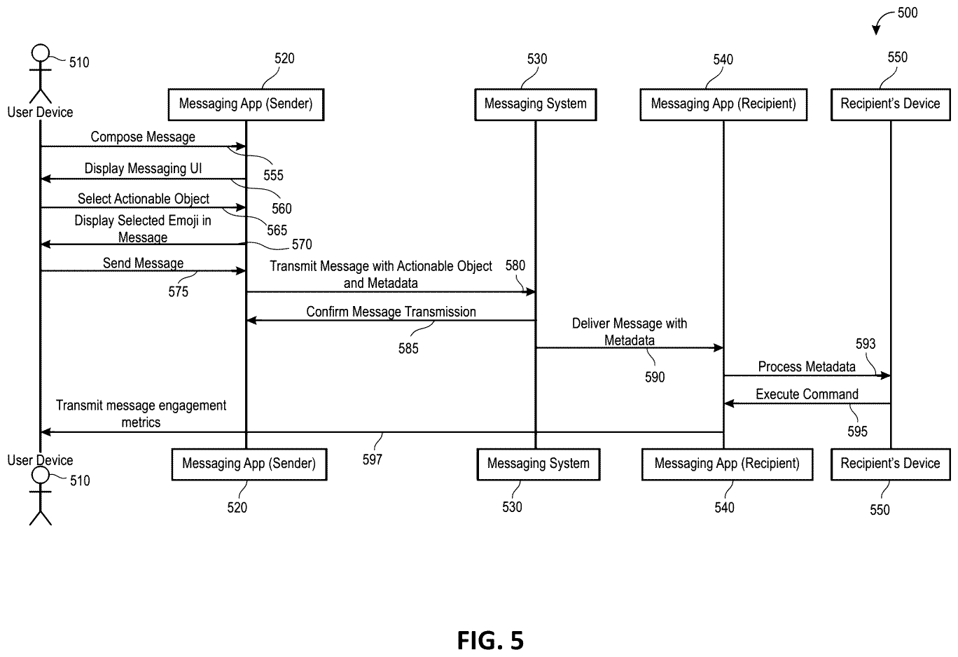

Although a few examples of engagement metrics and its sharing are described above, the embodiments are not so limited, and the recipient may generate any type of preferences and restrictions for gathering of engagement metrics and it's sharing with the sender. Some examples of engagement metrics and sharing are described further at least in FIGS. 5 and 10-12 below, such as at 597 in FIG. 5.

FIG. 5 is communication process 500 between systems and devices for executing an action based on triggering of a contextual awareness condition specified by an instruction associated with a message, in accordance with some embodiments of the disclosure. The process 500 may be implemented, in whole or in part, by systems or devices such as those shown in FIGS. 2 and 3. One or more actions of the process 500 may be incorporated into or combined with one or more actions of any other process or embodiments described herein. The process 500 may be saved to a memory or storage (e.g., any one of those depicted in FIGS. 2 and 3) as one or more instructions or routines that may be executed by a corresponding device or system to implement the process 500.

In some embodiments, process 500 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

More specifically, as depicted in FIG. 5, in some embodiments, a user 510 may compose a message, at 555, using a sender messaging application. As described earlier this messaging application may be any messaging application, such SMS, MMS, RCS, email messaging application, iMessage, Slack message, Microsoft Teams message, Google chat message, Discord message, messages that uses OTT (over-the-top) messaging applications, such as WhatsApp, Telegram, Signal, social media chat messages, such as Facebook messenger, Instagram Direct, email applications, and Snapchat. The messaging application may also be on any platform, such as Android or iOS platform.

The composed message at 555, such as in a WhatsApp messaging application, may be composed by the user by opening the WhatsApp messaging application on their smartphone's user interface, tapping on the new chat icon, selecting the desired recipient from their contacts list or search for their name, and typing a message in the message composing area using their keyboard or voice text the message. The user may also be replying to a message already received. Similarly, in other platforms, such as Slack, the user may compose the text message by navigating to the channel or direct message where they desire to send the message, click in the text box, and type the message. Although composing a message in WhatsApp and Slack are used as examples, the message may be compiled in any messaging application using a variety of message composing methods, including typing, gesturing, voice-to-text command, and swiping across a keyboard.

In some embodiments, the sender may also attach a variety of files, such as images, documents, audio or video files to the message. When using the smartphone, messaging applications may either be already installed or may be downloaded by the user, such as by using the Android Play store or iOS App Store.

Once the message is composed by the user 510, such as at 555, the messaging application 520 may display the message at 560 on the user interface of the user's device, such as the smartphone.

At 565, the user may select an actionable object, such as an emoji or any other actionable objects described above, from the messaging application. Upon selection of the actionable object, the system translates the actionable object, such as the emoji, into a corresponding command. For example, a sunrise emoji may be associated with a command for delivering the message at a particular time or when the recipient is waking up in the morning. These commands may be translated into metadata and embedded into the message, such as in the header or payload of a packet or in some other form separate from the message such that when processed by the recipient device, the text or the main body of the message and the metadata, e.g., the actionable object, command, or instructions, may also be processed separately. The commands or instructions in the command may also be transmitted as separate metadata that accompanies the message. The system may leverage existing messaging platforms such as SMS, iMessage, Gmail, and Rich Communication Services (RCS) to embed and process these commands. The actionable object and its metadata may be stored as a separate structure than the message itself. The actionable object and its metadata ensure that specific actions are executed by the recipient device upon receipt. The selected actionable object, e.g., emoji, may then be displayed at 570 on the user interface of the user's device, such as the smartphone. The display of the actionable object may be in line with other emojis or in a separate section of a sender's user interface, which may be displayed within the message for the sender's convenience and understanding. Some examples of the display are provided in FIG. 25 where the emoji is displayed above the message at 2540 or within the message at 2560 in the sender's messaging application's user interface. Although some examples of where the actionable object may be displayed are provided, the embodiments include displaying the actionable object anywhere within the message. Such a display may provide visual feedback to the sender to confirm the intended action before sending the message with the actionable object.

At 575, the user, e.g. the sender of the message, may select a send button to request sending of the message with the accompanying actionable object to the recipient. The messaging application may receive the user's send request and transmit the message with the actionable object, such as the emoji, and its metadata, at 580 to a messaging system 530. As described earlier, the message and the actionable object may be separate from each other thereby allowing, if desired, by any receiving entity to review and execute action based on the actionable object or review and discard the actionable object. Although transmitting of the actionable object is described in this and other figures, the embodiments also include transmitting the command associated with the actionable object or the instructions associated with the command as metadata instead of transmitting the actionable object.

Upon receipt, the messaging system 530 may confirm receipt, at 585, to the sender's messaging application. In some embodiments, if the receipt is not received within a predetermined time, then the sender's messaging application may retransmit the message with the actionable object and the instructions associated with the actionable object may be formatted in a different location of the data packet than the message and transmitted either together or separately from the message to the messaging system 530.

At 590, the messaging system 530 may deliver the message with the metadata associated with the command to the messaging application 540 of the recipient.

At 593, the recipient's messaging application 540 and/or the recipient device 550 may process the received metadata and take an action on the recipient device 550 as indicated in the metadata. In doing so, the recipient device may execute the command at 595 (e.g., execute the instructions provided in the metadata associated with the command) without displaying it to the recipient, maintaining a clean and clear message presentation while ensuring the contextual action is performed. In other words, the metadata may not be made visible to the recipient associated with the recipient device, however, it may be processed in the format received in the backend by the recipient device to execute the command. For example, if the command is received in the format where it was included within the User Data Header (UDH) or encoded in the User Data (UD) field using a predefined format, then the recipient device may read the UDH or UD in the backend to execute the command without displaying it to the recipient.

At 597, the recipient's messaging application may transmit metadata, which is then displayed to the sender of the message on their user interface. The metadata may include detailed information that goes beyond basic read confirmations and provides a comprehensive understanding of how the recipient engaged and interacted with the message. Such detailed information may include tracking metrics that inform the sender, for example, the amount of time spent by the recipient reading the message, scrolling behavior, and interactions with content. The tracking metrics may also include information relating to whether the recipient forwarded, saved/starred, the message. It may also include information relating to whether the recipient took any actions based on the content of the message. For example, if the message is an invitation or appointments tracking may include sharing information whether the user calendared the event or set an alarm to act upon the message. If the message involves meeting at a location, tracking may include information relating to whether the recipient is heading in that direction.

In yet other embodiments, in addition to tracking metrics, the information shared with the sender may be calculations and deeper analysis of the engagement metrics associated with the recipient that may present valuable insights into message engagement. For example, an analysis as to the amount of time spent reading or engaging with the current message compared to other messages sent by the sender may be provided. The analysis may also include insights into the number of times the recipient read the current message and the time spent each time reading it, especially if it was a lengthy or profound message. Having such a level of detail may empower the sender of the message to tailor their communication strategies and ensure that important messages are acknowledged and engaged with.

In some embodiments, based on the detailed engagement data collected, the system may prompt the sender to provide follow-up notifications. For example, based on the engagement metrics, if a determination is made that the recipient only partially read a message or failed to interact with critical content, the system may prompt the sender to send a reminder or follow-up message, e.g., a follow up to an earlier message for a meeting may be a subsequent message that says, “just following up to make sure we are meeting today.”

In some embodiments, to obtain such a granular level of engagement metrics, the recipients may have to agree and authorize sharing of such detail. As such, the recipient may be able to customize what data is shared with the sender, ensuring that their personal information remains protected. The recipient may also set up rules and parameters of what can and cannot be shared with the sender and the system may take that into consideration when sharing the recipient's metrics with the sender.

FIG. 6A is an example of an SMS with an update command, in accordance with some embodiments of the disclosure. In this embodiment, if the sender decides to update the command after the message has been sent, they may access the sent message, modify the command, and resend the updated metadata. For SMS messages, the command may be included in the User Data Header (UDH) or encoded in the User Data (UD) field and transmitted to the recipient device. As depicted in FIG. 6A, the update command may include a unique identifier 610 to associate it with the same message that was sent previously, followed by an indication that it is an update command, e.g., “<update: original_msg_id:new_cmd>.” The command may also include a first portion 615 which indicates that it is an update and a second portion 620 which indicates that it is a new command. Upon receiving the update command, the recipient device may replace the instructions included in the metadata from the previous message with the updated instructions. An example of the instructions and update instructions may be, for example, the previous instructions may have the recipient device provide the recipient with navigation directions to a first location, however, since the sender may have moved from the first location to a second location, the updated instruction may have the recipient device provide navigation directions to the second location. By allowing to update the command and its instructions using the update process, the message content and the handling of the message is kept relevant and appropriate.

FIG. 6B is an example of an SMS with a cancel command, in accordance with some embodiments of the disclosure. In this embodiment, if the sender decides to cancel the command after the message has been sent, they may access the sent message, modify the command to a cancellation, and send the cancellation metadata. For SMS messages, the cancellation command may be included in the UDH or encoded in the UD field and transmitted to the recipient device. As depicted in FIG. 6B, the cancellation command may include a unique identifier 650 to associate it with the same message that was sent previously, followed by an indication that it is a cancellation command, e.g., “<cancel: original_msg_id>.” The command may also include a portion 655 which indicates that it is a cancellation command. Upon receiving the update command, the recipient device may cancel the instructions previously received in the message. An example of the cancellation instructions may be to deliver a message now and no longer wait till the user wakes up in the morning, which were the instructions in the previous message. By allowing to cancel the previous command and its instructions using the cancellation process, the message content and the handling of the message is kept relevant and appropriate.

FIG. 7 is an example of an iMessage payload for an updated command, in accordance with some embodiments of the disclosure. In this embodiment, the sender may be using iMessage, which is a messaging platform that uses the iOS operating system, to send a text message, or another type of message, to the recipient. If the sender sends the message using iMessage and decides to update the command after the message has been sent, they may access the sent message, modify the command, and resend the updated metadata. As depicted in FIG. 7, the payload 700 associated with the iMessage may include an update message command 705, a delay notification command 710, and a contextual awareness condition 720 to delay the message notification until the recipient is awake. Upon receiving the update command, the recipient device may replace the instructions included in the metadata from the previous message with the updated instructions. By allowing to update the command and its instructions using the update process, the message content and the handling of the message is kept relevant and appropriate.

FIG. 8 is an example of an iMessage payload for a command cancellation, in accordance with some embodiments of the disclosure. In this embodiment, the sender may be using iMessage, which is a messaging platform that uses an iOS operating system, to send a text message, or another type of message, to the recipient. If the sender sends the message using iMessage and decides to cancel the command after the message has been sent, they may access the sent message, modify the command to a cancellation, and resend the metadata associated with the cancellation. As depicted in FIG. 8, the payload 800 associated with the iMessage for cancelling a command that was previously sent include an identification 810 that the message a cancellation command, the body 820 and action 830 associated with the message, such as to cancel the previous command. Upon receiving the cancel command, the recipient device may cancel previous sent instructions and not perform an action from the previous instructions.

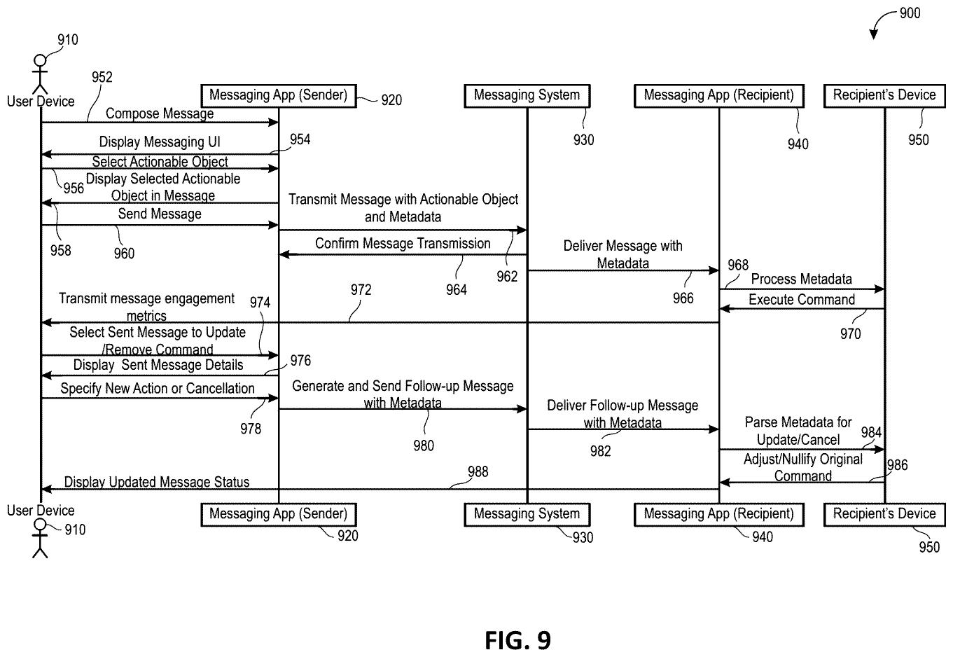

FIG. 9 is communication process 900 between systems and devices for executing an action based on triggering of a contextual awareness condition specified by an instruction associated with a message, in accordance with some embodiments of the disclosure. The process 900 may be implemented, in whole or in part, by systems or devices such as those shown in FIGS. 2 and 3. One or more actions of the process 900 may be incorporated into or combined with one or more actions of any other process or embodiments described herein. The process 900 may be saved to a memory or storage (e.g., any one of those depicted in FIGS. 2 and 3) as one or more instructions or routines that may be executed by a corresponding device or system to implement the process 900.

In some embodiments, process 900 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, email message, and RCS can be used to implement this system.

More specifically, as depicted in FIG. 9, in some embodiments, a message is composed using a messaging application at the sender's end, e.g., on a sender's device (also referred to as the first computing device). The messaging application can be any type of messaging application, such as iMessage, Slack, Microsoft Teams, Google chat message, email messaging application, Discord, WhatsApp, Telegram, Signal, and Snapchat. The messaging application may also be an email application. The messaging application may be on any operating system, such as Android or iOS operating system.

The process may include a user 910 composing a message using a messaging application, such as WhatsApp, and selecting an actionable object 954, such as an emoji, to associate with the composed message. The system may translate the actionable object into a corresponding command/instruction, and the command/instruction may be formatted such that it is included in a data packet separately from the message. The actionable object may be displayed at 956 on the sender's device (also referred to as the first computing device) to provide visual feedback prior to the sender selecting a send button at 960.

The messaging application may receive the sender's send request at 960 and transmit the message with the actionable object, such as the emoji, and its metadata, at 962 to a messaging system 930. As described earlier, the message and the actionable object may be separate from each other thereby allowing, if desired, by any receiving entity to review and take action based on the actionable object or review and discard the actionable object. In other words, the text, main body, content of the message, e.g., the text composed by the sender, and the metadata, e.g., the actionable object, command, or instructions, may also be processed separately. Although transmitting of the actionable object is described in this and other figures, the embodiments also include transmitting the command associated with the actionable object or the instructions associated with the command as metadata instead of transmitting the actionable object.

Upon receipt, the messaging system 930 may confirm receipt, at 964, to the sender's messaging application 920. In some embodiments, if the receipt is not received within a predetermined time, then the sender's messaging application may retransmit the message with the actionable object and the instructions associated with the actionable object may be formatted in a different location of the data packet than the message and transmitted either together or separately from the message to the messaging system 930.

At 966, the messaging system 930 may deliver the message with the metadata associated with the command to the messaging application 940 of the recipient.

At 968, the recipient's messaging application 940 and/or the recipient device 950 (also referred to as second computing device) may process the received metadata and take an action on the recipient device 950 as indicated in the metadata. In doing so, the recipient device may execute the command at 970 (e.g., execute the instructions provided in the metadata associated with the command) without displaying it to the recipient, maintaining a clean and clear message presentation while ensuring the contextual action is performed. In other words, the metadata may not be made visible to the recipient associated with the recipient device, however, it may be processed in the format received in the backend by the recipient device to execute the command. For example, if the command is received in the format where it was included within the UDH or encoded in the UD field using a predefined format, then the recipient device may read the UDH or UD in the backend to execute the command without displaying it to the recipient.

At 972, the recipient's messaging application 940 may transmit an engagement metric to the sender's device. This metric may include detailed information about the recipient's engagement with the message that goes beyond basic read confirmations, such as level and type of engagement, engagement time, etc. Based on these metrics, the sending device or the system may automatically send a follow-up message to the recipient's device.

At 974, the sender may either update or cancel the command after determining that the recipient has not yet engaged with the message and action has not been executed. The messaging application 920 may display details associated with the sent message at 976 and the user may specify a new action or cancellation at 978. Some examples of the commands for updating or cancellation are provided at FIGS. 6A-6B and 7-8.

At 980, the sender's messaging application 920 may generate and send a follow-up message with metadata to the messaging system 930. The follow-up message with metadata may include the update or cancel instructions, which may then be delivered at 982 from the messaging system 930 to the recipient's messaging application 940.

At 984 and 986, the recipient device and/or the recipient's messaging application may update or cancel based on the instructions provided and an updated message status may be reported to the user 910. In some embodiments, the updated message status may include engagement metrics associated with the recipient's engagement with the message, as described at 597 of FIG. 5.

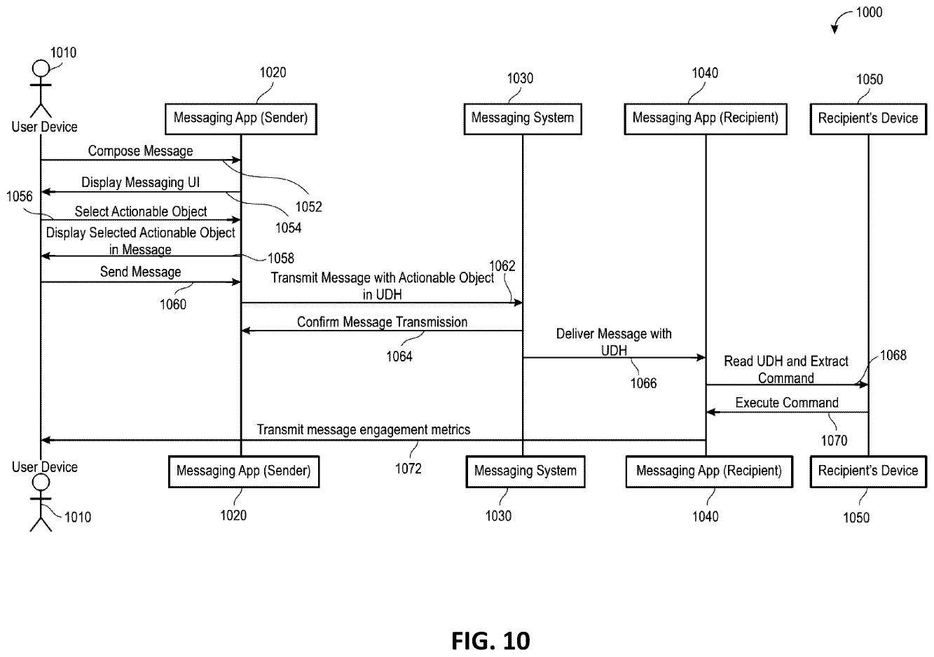

FIG. 10 is communication process 1000 between systems and devices when utilizing user data header (UDH) to include a command or metadata within the SMS message, in accordance with some embodiments of the disclosure. The process 1000 may be implemented, in whole or in part, by systems or devices such as those shown in FIGS. 2 and 3. One or more actions of the process 1000 may be incorporated into or combined with one or more actions of any other process or embodiments described herein. The process 1000 may be saved to a memory or storage (e.g., any one of those depicted in FIGS. 2 and 3) as one or more instructions or routines that may be executed by a corresponding device or system to implement the process 1000.

In this embodiment, the system utilizes the User Data Header (UDH) to include commands or metadata within the SMS message. When composing a message, the user may select an actionable object, which is then converted into a command stored in the UDH. This approach ensures that the command data is part of the SMS payload but separate from the visible message content. The recipient device may then read the UDH to execute the command (while the command is hidden and not displayed on the recipient device). The UDH read by the recipient device may include a custom Information Element Identifier (IEI), which may be followed by command data. The recipient device may trigger specific actions based on the received metadata in the command data when contextual awareness data meets the criteria for executing the command.

Referring to FIG. 10 the above-mentioned process 1000 includes a user 1010 composing a message 1052 in the messaging application 1020. At 1052, the messaging application may display a user interface to the user 1010. The user interface displayed at 1054 may include a library of actionable objects, such as emojis. The user may select from one of the emojis displayed at 1056. The user may also query for additional emojis. Once the user selects the emoji, which is one example of an actionable object, it may be displayed to the user at 1058 in the user's recipient device. The display may then show the selected emoji in the message, such as the emoji shown in the message at 2540 in FIG. 25.

At 1060, the user may select a send command, which may result in the messaging application 1020 transmitting the message with the selected emoji in UDH to a messaging system 1030. The messaging system 1030 may, upon receiving the transmitted message with the selected emoji, transmit a confirmation message to the messaging application 1020 to confirm its receipt.

The messaging system 1030 may then deliver the message with the UDH, at 1066, to a messaging application 1040 associated with the recipient. The recipient device 1050, at 1068, may read the UDH and extract the command from the UDH. The recipient device 1050 may then execute the command, at 1070 using its messaging application 1040 if the context of the recipient device meets the contextual conditions included in the UDH. For example, if the contextual conditions included in the UDH indicate delivery of the message when the recipient wakes up in the morning, the recipient may execute the command when it is determined that the user has woken up. Such contextual data may be obtained based on cameras and other devices that monitor the recipient's activity, such as a smart watch, sleep monitoring devices, or activity on the mobile phone. At 1072, the messaging application of the recipient device may display the message to the user 1010 without the UDH.

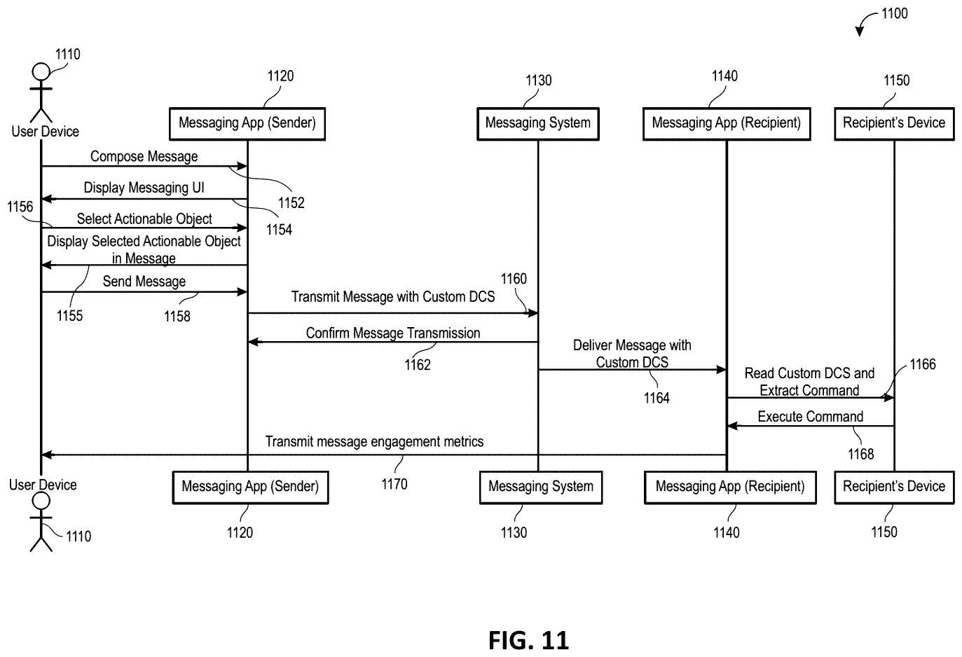

FIG. 11 is communication process 1100 between systems and devices when the system defines a custom data coding scheme (DCS) value that indicates the presence of command data within the message, in accordance with some embodiments of the disclosure. The process 1100 may be implemented, in whole or in part, by systems or devices such as those shown in FIGS. 2 and 3. One or more actions of the process 1100 may be incorporated into or combined with one or more actions of any other process or embodiments described herein. The process 1100 may be saved to a memory or storage (e.g., any one of those depicted in FIGS. 2 and 3) as one or more instructions or routines that may be executed by a corresponding device or system to implement the process 1100.

In some embodiments, process 1100 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, email messaging platforms, and RCS can be used to implement this system.

More specifically, as depicted in FIG. 11, in some embodiments, a message is composed at 1152 using a messaging application 1120 at the sender's end, e.g., on a sender's device. The messaging application 1120 can be any type of messaging application, such as iMessage, Slack, Microsoft Teams, Google chat message, Gmail, Discord, WhatsApp, Telegram, Signal, and Snapchat. It may also be an email application, such as Gmail or Outlook. The messaging application may be on any operating system, such as Android or iOS operating system.

The process may include a user 1110 composing a message using a messaging application 1120, and selecting an actionable object at 1156, such as an emoji, to associate with the composed message. To do so, the user 1110 may select from one of the actionable objects displayed on the user interface at 1154 of the messaging application 1120. When the user selects the actionable object, e.g., an emoji, such as by double clicking or selecting the actionable object from the user interface, the messaging application 1120 may be notified of the selection at 1156 and may display the selected actionable object in or alongside of the message at 1155. Some examples of the display of the actionable object (e.g., emoji) are provided in FIG. 25 where the emoji is displayed above the message at 2540 or within the message at 2560 in the sender's messaging application's user interface. The actionable object may be displayed at 1155 on the sender's device to provide visual feedback prior to the sender selecting a send button at 1158.

Once the actionable object is selected, the system may translate the actionable object into a corresponding command/instruction, which may be included in a data packet separately from the message. When the sender selects the actionable object, the system may assign a predefined Data Coding Scheme (DCS) value to the message, such as a DCS value to an SMS. This DCS value is used to indicate the presence of command/instructions within the message. As such, this DCS value may be used to alert the recipient device to interpret the message differently, recognizing that it contains metadata for triggering actions.

At 1158, the messaging application may receive the sender's send request to send/transmit the message with the actionable object, such as the emoji, and its metadata to a messaging system 1130. As described earlier, the message and the actionable object may be separate from each other thereby allowing, if desired, by any receiving entity to review and take action based on the actionable object or review and discard the actionable object. Although transmitting of the actionable object is described in this and other figures, the embodiments also include transmitting the command associated with the actionable object or the instructions associated with the command as metadata instead of transmitting the actionable object.

Upon receipt of the message with the custom DCS at 1160, the messaging system 1130 may confirm receipt, at 1162, to the sender's messaging application 1120. In some embodiments, if the receipt is not received within a predetermined time, then the sender's messaging application may retransmit the message with the actionable object and the instructions associated with the actionable object may be formatted in a different location of the data packet than the message and transmitted either together or separately from the message to the messaging system 1130.

At 1164, the messaging system 1130 may deliver the message with the metadata associated with the command and the DCS value to the messaging application 1140 of the recipient device 1150.

At 1166, the recipient's messaging application 1140 and/or the recipient device 1150 (also referred to as a second computing device) may receive the message with the DCS value. The recipient device may recognize that the DCS value is associated with an action that is to be performed by the recipient device for handling the message. As such, the recipient device may read the custom DCS to extract and execute the command.

In an example, the custom DCS value, which is a unique value for each message, may indicate that the message contains command data or instructions, enabling the recipient device to process and execute the corresponding actions seamlessly.

Once the command instructions have been determined and the action instructed to be executed is triggered, e.g., when the contextual awareness data of the recipient device meets the trigger conditions provided in the instructions, the recipient device may execute the command at 1168 (e.g., execute the instructions provided in the metadata associated with the command) without displaying it to the recipient, maintaining a clean and clear message presentation while ensuring the contextual action is performed. In other words, the metadata may not be made visible to the recipient associated with the recipient device, however, it may be processed in the format received in the backend by the recipient device to execute the command.

At 1170, the recipient's messaging application 1140 may transmit a message with one or more engagement metrics to the sender's device. These metrics may inform the sender about the recipient's interaction with the message which go beyond basic read confirmations, providing a comprehensive understanding of the recipient's engagement. In some embodiments, even if the recipient has read the message, the sender may still have the option to update or cancel the instruction/command before the recipient interacts on a more substantive basis. For example, if the recipient has browsed the message quickly, which may be determined based on the time spent reading the message, the system may determine that the recipient has not fully engaged with the message presenting an opportunity, if needed, to change or modify an action to be taken. In some embodiments, the sender may update or cancel the command if the recipient has not yet interacted with the message and the recipient device has not executed any action based on instructions provided in the message. Some examples of the commands for updating or cancellation are provided at FIGS. 6A-6B and 7-8.

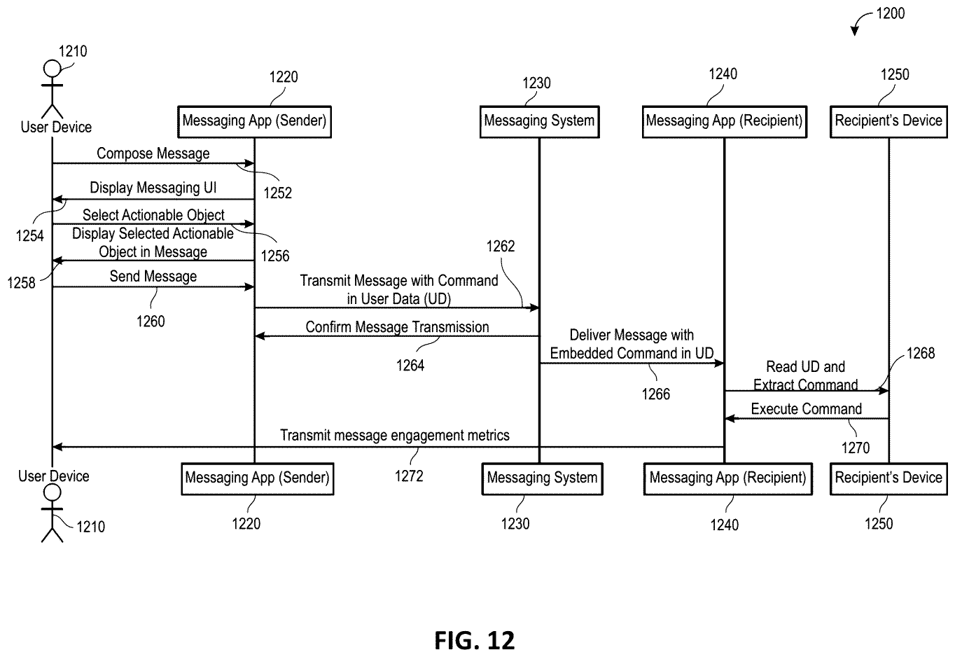

FIG. 12 is communication process 1200 between systems and devices when a system embeds a command directly within the user data (UD) of the SMS in a predefined format, in accordance with some embodiments of the disclosure. The process 1200 may be implemented, in whole or in part, by systems or devices such as those shown in FIGS. 2 and 3. One or more actions of the process 1200 may be incorporated into or combined with one or more actions of any other process or embodiments described herein. The process 1200 may be saved to a memory or storage (e.g., any one of those depicted in FIGS. 2 and 3) as one or more instructions or routines that may be executed by a corresponding device or system to implement the process 1200.

In some embodiments, process 1200 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, email messaging platforms, and RCS can be used to implement this system.

More specifically, as depicted in FIG. 12, in some embodiments, a message is composed at 1252 using a messaging application 1220 at the sender's end, e.g., on a sender's device. The messaging application 1220 can be any type of messaging application, such as iMessage, Slack, Microsoft Teams, Google chat message, Discord, WhatsApp, Telegram, Signal, and Snapchat. It may also be an email application, such as Gmail or Outlook. The messaging application may be on any operating system, such as Android or iOS operating system.

The process may include a user 1210 composing a message using a messaging application 1220, and selecting an actionable object at 1254, such as an emoji, to associate with the composed message. To do so, the user 1210 may select from one of the actionable objects displayed on the user interface at 1254 of the messaging application 1220. When the user selects the actionable object, e.g., an emoji, such as by double clicking or selecting the actionable object from the user interface, the messaging application 1220 may be notified of the selection at 1256 and may display the selected actionable object in or alongside of the message at 1158. Some examples of the display of the actionable object (e.g., emoji) are provided in FIG. 25 where the emoji is displayed above the message at 2540 or within the message at 2560 in the sender's messaging application's user interface. The actionable object may be displayed at 1258 on the sender's device to provide visual feedback prior to the sender selecting a send button.

Once the actionable object is selected, the system may translate the actionable object into a corresponding command, which may be included in a data packet separately from the message. In this embodiment, the system may embed the commands directly within the User Data (UD) of the message, such as an SMS, in a predefined format. This approach allows the recipient device to recognize and extract the command from the message content. When the user selects an actionable object, such as the emoji, the system appends the corresponding command in a special format within the UD.

At 1260, the messaging application may receive the sender's send request to send/transmit the message with the actionable object, such as the emoji, and its metadata in UD to a messaging system 1230. As described earlier, the message and the actionable object may be separate from each other thereby allowing, if desired, by any receiving entity to review and take action based on the actionable object or review and discard the actionable object. Although transmitting of the actionable object is described in this and other figures, the embodiments also include transmitting the command associated with the actionable object or the instructions associated with the command as metadata instead of transmitting the actionable object.

Upon receipt of the message with the command directly within the UD at 1262, the messaging system 1230 may confirm receipt, at 1164, to the sender's messaging application 1220. In some embodiments, if the receipt is not received within a predetermined time, then the sender's messaging application may retransmit the message with the actionable object and the instructions associated with the actionable object may be formatted in a different location of the data packet than the message and transmitted either together or separately from the message to the messaging system 1230.

At 1266, the messaging system 1230 may deliver the message with the command in UD to the messaging application 1240 of the recipient device 1250.

At 1268, the recipient's messaging application 1240 and/or the recipient device 1250 may receive the message with the command in UD. The recipient device reads the UD to identify and execute the command, ensuring the action is performed as intended while stripping out the command before displaying the message to the recipient.

In this example, the command is embedded within the UD, allowing the recipient device to execute the command based on the embedded metadata, thereby enhancing functionality without cluttering the message content.

Once the command instructions have been determined and the action instructed to be executed is triggered, e.g., when the contextual awareness data of the recipient device meets the trigger conditions provided in the instructions, the recipient device may execute the command at 1270 (e.g., execute the instructions provided in the metadata associated with the command) without displaying it to the recipient, maintaining a clean and clear message presentation while ensuring the contextual action is performed. In other words, the metadata may not be made visible to the recipient associated with the recipient device, however, it may be processed in the format received in the backend by the recipient device to execute the command.

At 1272, the recipient's messaging application 1240 may transmit an engagement metric to the sender's device. This metric may include detailed information about the recipient's engagement with the message that goes beyond basic read confirmations, such as level and type of engagement, engagement time, etc. Based on these metrics, the sending device or the system may automatically send a follow-up message to the recipient's device.

In some embodiments, the sender may either update or cancel the command after determining that the recipient has not yet engaged with the message and action has not been executed. Some examples of the commands for updating or cancellation are provided at FIGS. 6A-6B and 7-8.

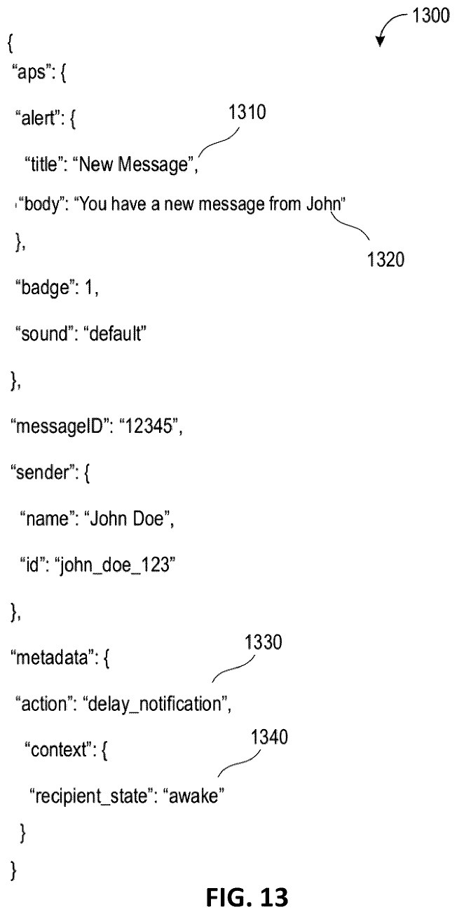

FIG. 13 is an example of a messaging payload for a delayed notification, in accordance with some embodiments of the disclosure. The payload may include, among other elements, a title section 1310, a body section 1320, which may notify the recipient that they received a message from John, an action section 1330, which may indicate that action to be executed, such as in this case to delay the notification, and a recipient state section 1340, which indicates, in this example, that the message is to delayed until the recipient's state is awake.

In the embodiment of FIG. 13, the system may leverage the flexibility of modern messaging platforms, such as iMessage for Apple devices and Rich Communication Services (RCS) for Android devices, to include commands and metadata within the message payload. When composing a message, such a message using the iMessage platform, the user may select an actionable object, such as an emoji, which the system translates into a command attached as custom data. This custom data may not be visible to the recipient but may allow the recipient device to execute the command upon receiving the message. For a delayed notification, which may be indicated in the payload at 1330, the system may ensure that the notification sound is delayed based on the recipient's awake or asleep state or other context or state (as indicated in the payload at 1340). The messaging payload may include fields such as “metadata” to store these commands, ensuring they are processed separately from the message content.

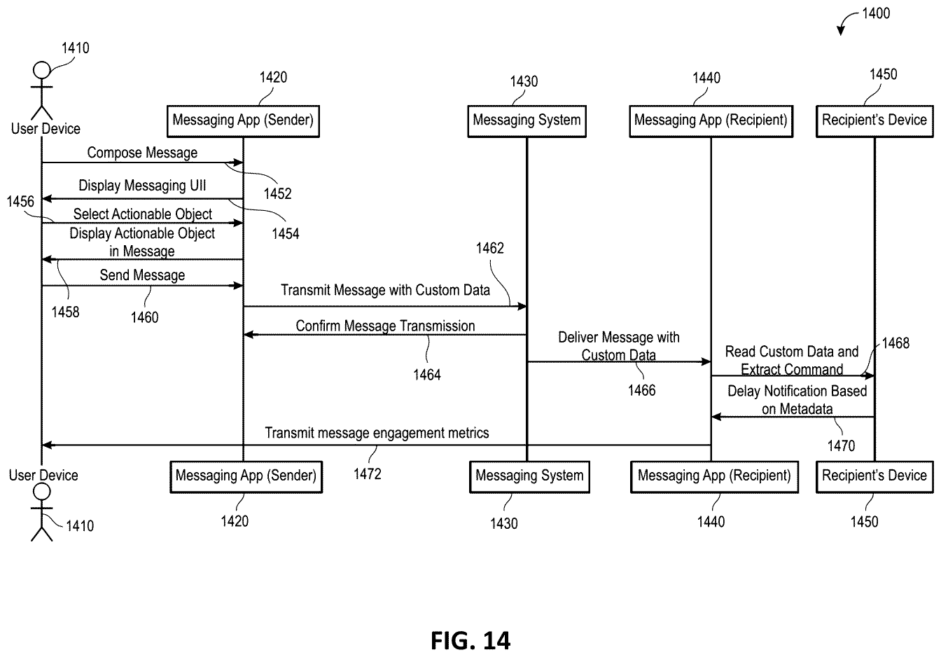

FIG. 14 is communication process 1400 between systems and devices for providing a delayed notification, in accordance with some embodiments of the disclosure. The process 1400 may be implemented, in whole or in part, by systems or devices such as those shown in FIGS. 2 and 3. One or more actions of the process 1400 may be incorporated into or combined with one or more actions of any other process or embodiments described herein. The process 1400 may be saved to a memory or storage (e.g., any one of those depicted in FIGS. 2 and 3) as one or more instructions or routines that may be executed by a corresponding device or system to implement the process 1400.

In some embodiments, process 1400 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

More specifically, as depicted in FIG. 14, in some embodiments, a message is composed at 1452 using a messaging application 1420 at the sender's end, e.g., on a sender's device. The messaging application 1420 can be any type of messaging application, such as iMessage, Slack, Microsoft Teams, Google chat, Discord, WhatsApp, Telegram, Signal, and Snapchat. It may also be an email application, such as Gmail or Outlook. The messaging application may be on any operating system, such as Android or iOS operating system.

The process may include a user 1410 composing a message using a messaging application 1420, and selecting an actionable object at 1454, such as an emoji, to associate with the composed message. To do so, the user 1410 may select from one of the actionable objects displayed on the user interface at 1454 of the messaging application 1420. When the user selects the actionable object, e.g., an emoji, such as by double clicking or selecting the actionable object from the user interface, the messaging application 1420 may be notified of the selection at 1456 and may display the selected actionable object in or alongside of the message at 1458. Some examples of the display of the actionable object (e.g., emoji) are provided in FIG. 25 where the emoji is displayed above the message at 2540 or within the message at 2560 in the sender's messaging application's user interface. The actionable object may be displayed at 1458 on the sender's device to provide visual feedback prior to the sender selecting a send button.

Once the actionable object is selected, the system may translate the actionable object into a corresponding command, which may be included as metadata in a data packet separately from the message.

In this embodiment, the “metadata” field may include the custom metadata, which may be the command or instruction for the recipient device to delay the notification sound based on the recipient's state (awake or asleep). In another embodiment, the command or instruction for the recipient device may be to wake-up the phone from sleep mode, display the message, display a part of the message, display an indication of the message, provide a haptic effect, ring a customized ringtone, auto-play a specific media asset, and/or initial a phone call to the sender if previously authorized by the recipient. The system may also allow the user to add any other customized instruction for the recipient device. In another embodiment, the metadata may be placed in any field of the data packet, such as header or payload.

At 1460, the messaging application may receive the sender's send request to send/transmit the message with the actionable object, such as the emoji, and its custom metadata to a messaging system 1430. As described earlier, the message and the actionable object may be separate from each other thereby allowing, if desired, by any receiving entity to review and take action based on the actionable object or review and discard the actionable object. Although transmitting of the actionable object is described in this and other figures, the embodiments also include transmitting the command associated with the actionable object or the instructions associated with the command as custom metadata instead of transmitting the actionable object.

Upon receipt of the message with the custom data at 1462, the messaging system 1430 may confirm receipt, at 1464, to the sender's messaging application 1420. In some embodiments, if the receipt is not received within a predetermined time, then the sender's messaging application may retransmit the message with the actionable object and the custom DCS either together or separately to the messaging system 1430.

At 1466, the messaging system 1430 may deliver the message with the custom metadata to the messaging application 1440 of the recipient device 1450. The recipient device may read and process this custom metadata at 1468 to determine the optimal time for delivering the notification or notification sound, ensuring it is received when the recipient is awake. As such, the recipient device may monitor the recipient's state and delay the notification, at 1470, based on the metadata until the contextual awareness data obtained based on the monitoring indicates that the recipient is now awake.

Once the command instructions have been determined and the action instructed to be executed is triggered, e.g., when the contextual awareness data of the recipient device meets the trigger conditions provided in the instructions, the recipient device may execute the command at 1470 (e.g., execute the instructions provided in the metadata associated with the command) without displaying it to the recipient, maintaining a clean and clear message presentation while ensuring the contextual action is performed. In other words, the metadata may not be made visible to the recipient associated with the recipient device, however, it may be processed in the format received in the backend by the recipient device to execute the command.

At 1472, the recipient's messaging application 1440 may transmit an engagement metric to the sender's device. This metric may include detailed information about the recipient's engagement with the message that goes beyond basic read confirmations, such as level and type of engagement, engagement time, etc. Based on these metrics, the sending device or the system may automatically send a follow-up message to the recipient's device. In some embodiments, the sender may either update or cancel the command after determining that the recipient has not yet engaged with the message and action has not been executed. Some examples of the commands for updating or cancellation are provided at FIGS. 6A-6B and 7-8.

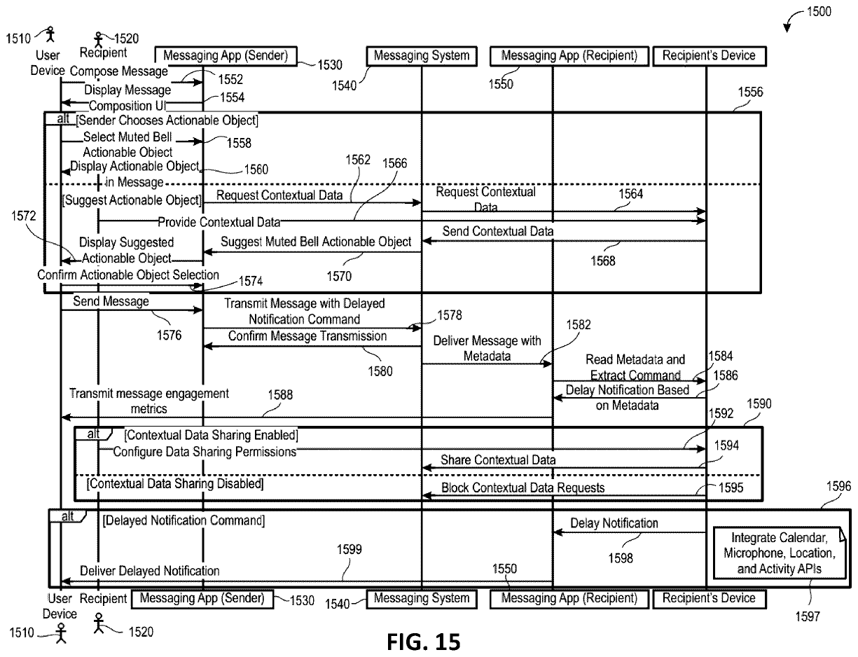

FIG. 15 is communication process 1500 between systems and devices using an API for executing a specific action associated with the actionable object, in accordance with some embodiments of the disclosure. The process 1500 may be implemented, in whole or in part, by systems or devices such as those shown in FIGS. 2 and 3. One or more actions of the process 1500 may be incorporated into or combined with one or more actions of any other process or embodiments described herein. The process 1500 may be saved to a memory or storage (e.g., any one of those depicted in FIGS. 2 and 3) as one or more instructions or routines that may be executed by a corresponding device or system to implement the process 1500.

In some embodiments, process 1500 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

More specifically, as depicted in FIG. 15, in some embodiments, a message is composed at 1552 using a messaging application 1530 at the sender's end, e.g., on a sender's device. The messaging application 1530 can be any type of messaging application, such as iMessage, Slack, Microsoft Teams, Google chat message, Discord, WhatsApp, Telegram, Signal, and Snapchat. messaging application 1530 may also be an email application, such as Gmail or Outlook The messaging application may be on any operating system, such as Android or iOS operating system.

The process may include a user 1510 composing a message using a messaging application 1530. When the user 1510 begins composing a message to a known contact who shares the same ecosystem, such as on an Apple device, the system, at 1562 and 1564, requests the contextual data from the recipient device 1551. The recipient device provides an interface where the recipient can persistently allow or revoke the sharing of contextual data with specific contacts. When granting permission, the recipient can choose to allow data sharing indefinitely or for a specified duration. This setting is stored on the recipient device and can be accessed and modified at any time. If the recipient decides to revoke permission, the system immediately ceases to share contextual data with the specified contact.

Permissions may be requested allowing the recipient to control access to specific types of data. For example, the system can request permissions for accessing calendar data, microphone data, and motion data separately. This granular permission model may provide the recipient with the flexibility to share only the data they are comfortable sharing. For instance, the recipient might choose to share calendar data but not microphone data, allowing the system to suggest the emoji based on their scheduled meetings but not based on ambient noise levels. When the recipient allows sharing contextual data, the system collects this data using various sensors and APIs. The receiver's device may detect that the recipient is in a meeting, a quiet environment, or during their scheduled quiet hours integrating data from various sensors and calendar entries to determine the most appropriate times for delayed notification delivery. This ensures that the message is delivered silently, without causing any disruption to the recipient with the corresponding notification occurring at an appropriate time.

Block 1556 provides a choice between two paths, each leading to the insertion of a distinct actionable object. The first path, depicted at steps 1558-1560, involves the sender selecting the actionable object. Alternatively, the second path, depicted at steps 1562-1574, allows the system to propose an actionable object based on the message content or contextual data derived from the recipient device. In this particular embodiment, the actionable object may be a muted bell, which can be selected by either the sender or the system and subsequently displayed on the sender's user interface.

Once the actionable object, e.g., muted bell, is selected, the system may translate the actionable object into a corresponding command, which may be included as metadata in a data packet separately from the message.

At 1576, the messaging application may receive the sender's send request to send/transmit the message with the actionable object, such as the muted bell and a delayed notification command 1578.

Through steps 1582-1586, the message with the metadata may be delivered to the messaging application of the recipient 1550, which may then transmit the metadata and the extracted command to the recipient device 1584 for delaying the notification based on the metadata, as depicted at 1586.

At 1590, permissions may be granted whether to share contextual data, as depicted at 1594, or block contextual data, as depicted at 1595. For cases where contextual data sharing is enabled, the system integrates various APIs to facilitate these processes. For example, as depicted at 1597, the calendar API may be used to fetch upcoming events from the recipient's calendar to check for scheduled meetings or quiet times. For instance, the API can access events with details such as start and end times, location, and event type, allowing the system to determine if the recipient is likely to be in a situation where a delayed notification delivery is appropriate. The Microphone API monitors ambient noise levels, capturing real-time data on the sound environment surrounding the recipient. If the noise level is below a certain threshold, indicating a quiet environment, the system can suggest the emoji to the sender. The Location API checks the recipient's current location using GPS and other location services, cross-referencing it with known quiet zones or places associated with meetings, such as offices or libraries. Additionally, an Activity Recognition API can use motion sensors to determine if the recipient is engaged in specific activities, like driving or exercising, which might warrant delayed notification message delivery. In addition to the APIs described above, APIs relating to communication applications, such as video conferencing, telephone, or other messaging application, gaming applications, and other applications, such as those that relate to productivity programs (e.g., Word, Excel, graphic design program, etc.), may also be used to determine whether the recipient is currently in a video conference meeting, on a call, or engaged in some other activity. By integrating these APIs, the system can make informed decisions about when to suggest or automatically apply the emoji, ensuring that messages are delivered in a non-disruptive manner. At 1596, the APIs may be activated, and the notification may be delayed to the recipient.

In such embodiments where the system integrates various APIs to facilitate these processes, an API call is made to the second/external application, such as calendaring, OTT application. In this embodiment, there may be two commands or two sets of instructions, the first command/set of instructions may be to the recipient device, such as to delay the message, and the second command/set of instructions may be to make the API call and how to use the external application. In yet other embodiments, a third command/set of instructions may include how to make the API call, what data to obtain from the external application, or instructions for the external application to perform a second action.

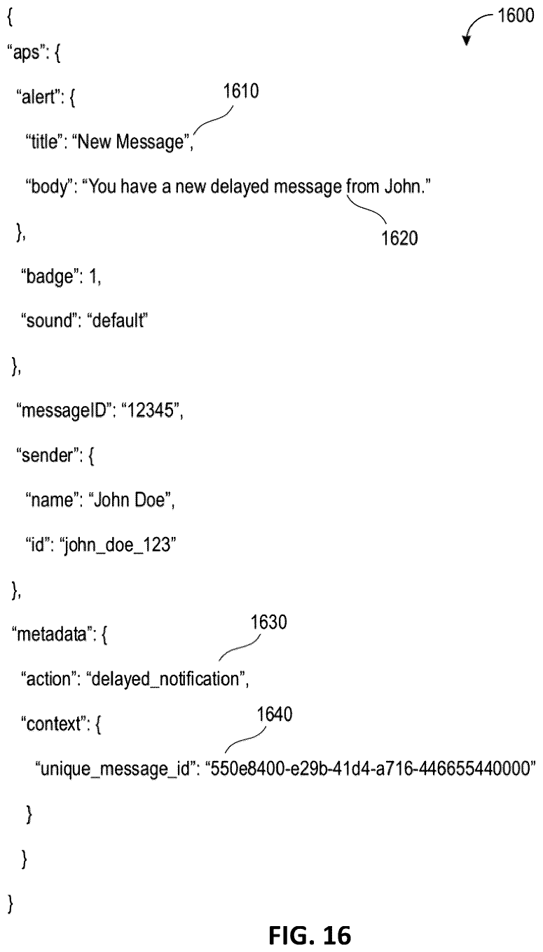

FIG. 16 is an example of structuring metadata in the payload for delayed notification in an iMessage, in accordance with some embodiments of the disclosure. As depicted, among other elements, the metadata may include a body 1620, which in this example indicates that the recipient has a new message from John. The metadata may also include an action 1630, which in this example is to delay the notification. The metadata may also include a unique ID 1640 which may allow the recipient device to locate the specific message associated with the delayed notification based on the unique ID.

In some embodiments, if a recipient receives a delayed notification, the recipient may select the notification, such as by tapping on the notification or double clicking it, which may directly open the specific message within their messaging app, even if newer messages have been received since then. Such navigation directly to the message from the notification may make accessing the message more efficient and easier rather than the recipient having to manually scroll through messages to find the relevant message.

In some embodiments, the messaging app may use a unique identifier for each message to locate and display it immediately. This unique identifier, often a UUID (Universally Unique Identifier), may be included in the message metadata and stored on both the sender's and recipient's devices.

In some embodiments, for modern messaging platforms like iMessage or RCS, the unique identifier may be part of the message payload, ensuring distinct identification. In SMS, the identifier may be embedded within the User Data Header (UDH) or User Data (UD) field, ensuring its transmission alongside the message body.

Upon receiving a delayed notification, the recipient device may display a notification banner or alert. In some embodiments, when the recipient selects the notification, the messaging app may capture the selection event, such as the tapping or double clicking event, and it may then extract the unique identifier from the notification's metadata.

When the recipient selects this notification, the messaging application may intercept the selection event and retrieve the unique identifier from the notification metadata. The application then searches its message database using this identifier to locate the specific message associated with the delayed notification. This process may involve querying the message store, which could be a local database or cloud-based storage, to find the message that matches the unique identifier.

Once the message is located, the messaging application may navigate directly to the message thread and highlight the specific message. This direct navigation skips intervening messages, and jumps directly to the relevant message, ensuring the recipient immediately sees the relevant message. For example, in iMessage, the system might use the unique identifier in the form of a UUID stored in the JSON metadata, which allows the application to perform a targeted search within the message history thereby allowing the recipient to jump to the message based on the message's identification in the targeted search.

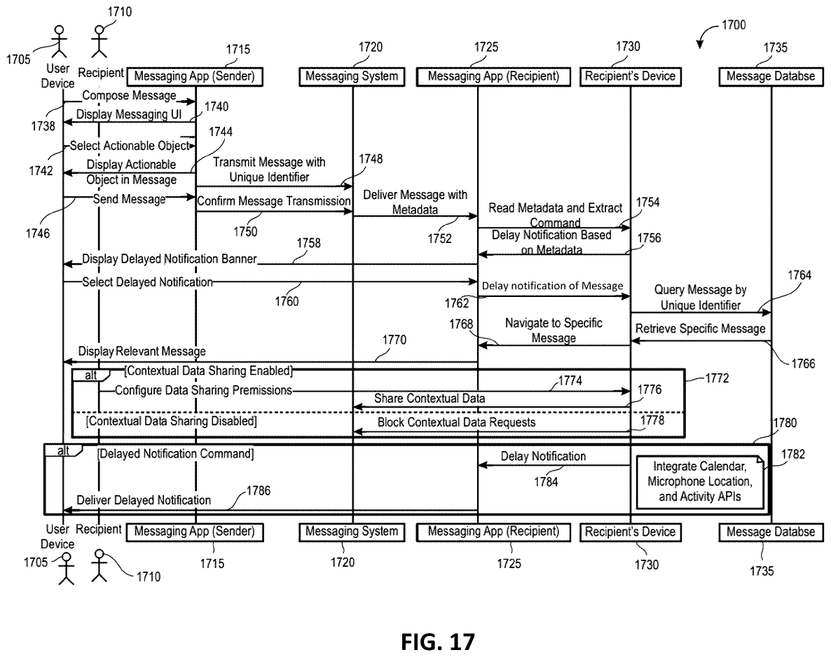

FIG. 17 is communication process 1700 between systems and devices when a unique message identifier is embedded within the UDH, in accordance with some embodiments of the disclosure. The process 1700 may be implemented, in whole or in part, by systems or devices such as those shown in FIGS. 2 and 3. One or more actions of the process 1700 may be incorporated into or combined with one or more actions of any other process or embodiments described herein. The process 1700 may be saved to a memory or storage (e.g., any one of those depicted in FIGS. 2 and 3) as one or more instructions or routines that may be executed by a corresponding device or system to implement the process 1700.

In some embodiments, process 1700 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

More specifically, as depicted in FIG. 17, in some embodiments, a message is composed at 1740 using a messaging application 1715 at the sender's end, e.g., on a sender's device, also referred to as the second computing device. The messaging application 1715 may be any type of messaging application, such as SMS, MMS, RCS, iMessage, Slack message, Microsoft Teams message, Google chat message, Discord message, OTT messaging applications (WhatsApp, Telegram, Signal), or social media chat messages (Facebook messenger, Instagram Direct, Snapchat). It may also be an email application, such as Gmail or Outlook. The platform may be Android or iOS. In response to the sender composing the message, the messaging application may display the composed message on the messaging user interface on the sender's device at 1738.

Once the message is composed and displayed, at 1742, the user device 1705 may select an actionable object, which, upon selection, may be associated with the composed message. In some embodiments, the user device 1705 may select the actionable object from one of the actionable objects displayed on the user interface of the messaging application 1715. In some embodiments, the messaging application, based on the content and context of the message or the recipient's contextual data may suggest the actionable object for selection.

When the actionable object is selected, such as by double clicking or selecting the actionable object from the user interface, the messaging application 1715 may display the selected actionable object in or alongside of the message at 1744. Some examples of the display of the actionable object (e.g., emoji) are provided in FIG. 25 where the emoji is displayed above the message at 2540 or within the message at 2560 in the sender's messaging application's user interface. The actionable object may be displayed at 1744 on the sender's device to provide visual feedback prior to the sender selecting a send button.

Once the actionable object is selected, the system may translate the actionable object into a corresponding command, which may be included as metadata in a data packet separately from the message.

In this embodiment, the “metadata” field may include the custom metadata, which may be the command or instruction for the recipient device to delay the notification sound based on the recipient's state (awake or asleep). In another embodiment, the command or instruction for the recipient device may be for the recipient device to wake-up the phone from sleep mode, display the message, display a part of the message, display an indication of the message, provide a haptic effect, ring a customized ringtone, auto-play a specific media asset, and/or initial a phone call to the sender if previously authorized by the recipient. The system may also allow the user to add any other customized instruction for the recipient device. In another embodiment, the metadata may be placed in any field of the data packet, such as header or payload.

At 1746, the sending user's device may request to transmit the message to the recipient device 1730. The messaging application may receive the sender device's send request to send/transmit the message with the actionable object and insert a unique identifier. This unique identifier may be embedded in the User Data Header (UDH) or User Data (UD) field. Such embedding may allow the recipient device to extract the unique identifier and perform the necessary lookup. In some embodiments, the message may be augmented with contextual text to inform the receiving user of the reason for the delay. For example, a message could be augmented with “sent last night at 11:30 pm and delivered silently because you had ‘do not disturb’ or sleep focus turned on.”

The sender's messaging application 1715 may then transmit the message with the unique identifier at 1748 to a messaging system 1720. Although a messaging system 1720 is used as an example, the messaging application 1715 may also transmit the message with the unique identifier at 1748 to a central server, such as the server described in FIG. 2.

As described earlier, the instructions associated with the actionable object may be processed separately from the message. For example, the instructions may be included in the packet header, which may be processed separately from the main body which may include the message. The receiving device may separately analyze the instructions, which may direct the recipient device to execute an action when the current state of the recipient device meets a contextual awareness condition described in the instructions. Although transmitting of the actionable object is described in this and other figures, the embodiments also include transmitting the command associated with the actionable object or the instructions associated with the command as custom metadata instead of transmitting the actionable object.

Upon receipt of the message with the unique identifier at 1748, the messaging system 1720 may confirm receipt, at 1750, to the sender's messaging application 1715. In some embodiments, if the receipt is not received within a predetermined time, then the sender's messaging application may retransmit the message with the actionable object and the unique identifier together or separately to the messaging system 1720.

At 1752, the messaging system 1720 may deliver the message with the metadata to the messaging application 1725 of the recipient device 1730. The metadata may include the actionable object, its associated command, and/or the instructions associated with the command. The metadata may also include multiple layers of commands and instructions. The metadata may also include the unique identifier. The recipient device 1730 may read and extract the command from the metadata at 1754 and at 1756 delay notification of the message based on the metadata. For example, the metadata may indicate to the recipient device not to notify the recipient until the recipient was woken up from overnight sleep and as such the at 1756 the message notification may be delayed until a determination is made that the recipient has woken up.

At 1758, a delayed notification banner may be transmitted to the sender's device and displayed and the sender's device may respond by selecting delayed notification.

At 1762, the recipient's messaging application 1725, may delay notification of the message to the recipient. The recipient device 1730, at 1764, may query a message database 1735 by the unique identifier indicated in the metadata provided. Based on the unique identifier embedded in UD or UDH presented, the message database 1735 may respond to the recipient device with the specific message associated with the unique identifier. As described earlier, the recipient device may be able to perform the necessary lookup for the specific message that has been delayed, rather than looking for the message, by using the unique identifier embedded in UD or UHD. This unique identifier may be augmented with contextual text to inform the receiving device of the reason for the delay, such as delayed until you were not busy, or delayed until you woke up.

At 1770, the recipient's messaging application 1240 may transmit an engagement metric to the sender's device. This metric may include detailed information relating to the recipient's engagement with the message, such as the type and degree of engagement well beyond basic read confirmations. Steps 1774-1778 may determine what metrics can be shared with the sending device based on data sharing permissions granted by the recipient device. Based on these metrics, in one embodiment, the sending device or the system may automatically send a follow-up message to the recipient's device. In another embodiment, if the message has not yet been engaged with, the sending device may choose to replace the actionable object by sending a subsequent message with a new actionable object and instructing the recipient device to replace the previously sent message and actionable object.

In some embodiments, the delay command instructions may be processed in the backend without displaying it to the recipient, maintaining a clean and clear message presentation while ensuring the contextual action is performed. In other words, the metadata may not be made visible to the recipient associated with the recipient device, however, the metadata may be processed in the format received in the backend by the recipient device to execute the command.

In some embodiments, the sender may either update or cancel the command after determining that the command has not yet been executed. For example, prior to the delay command being executed. Some examples of the commands for updating or cancellation are provided at FIGS. 6A-6B and 7-8.

In some embodiments, as indicated by block 1780, steps 1782-1786 may be executed to use calendar data, or make an API call for delaying the notification. For example, the system may analyze calendar appointments and determine when the recipient's schedule is available, and delay the notification accordingly until the recipient is available.

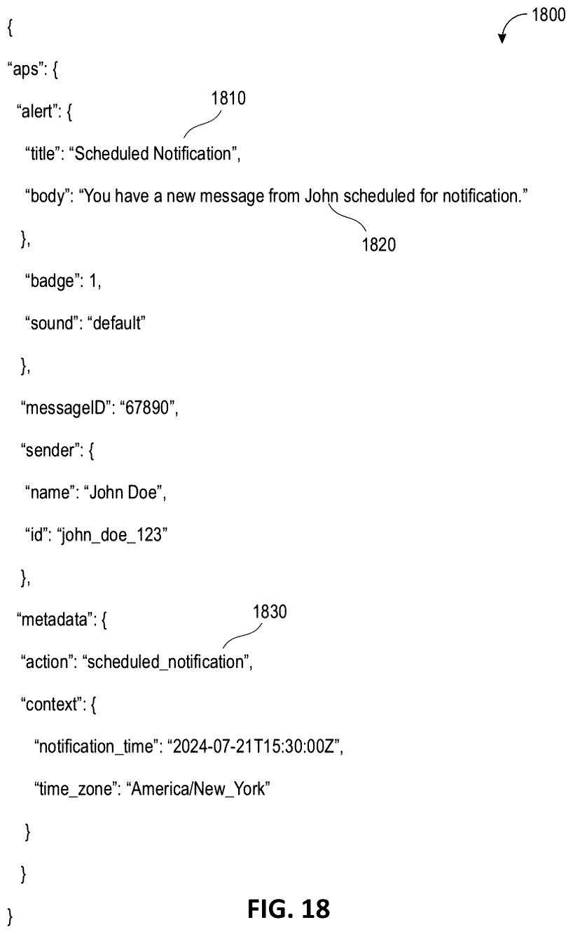

FIG. 18 is an example of structuring metadata for scheduled notification in an iMessage, in accordance with some embodiments of the disclosure. In this embodiment, notifications may be scheduled using calendar, clock, and other scheduling tools. In some embodiments, when a sender wants to send a message but desires to delay its delivery, the system may suggest an actionable object, such as a calendar with a clock, for attaching to the message. This actionable object, e.g., calendar with a clock, may allow the sender to schedule the notification for a future time such as by selecting a time and date using the clock and the calendar. The system then dynamically adjusts the delivery time based on the recipient's calendar, any detected delays, and other relevant factors like the recipient being stuck in traffic or having to attend to an unexpected appointment.

To schedule a delayed notification, when the sender selects the associated actionable object while composing the message, the system may associate such selection as an instruction to schedule the notification for future delivery. If the recipient has granted permission to share contextual data, either partially or all of the contextual data, the system may use a Calendar API to access their calendar and identify potential scheduling conflicts or ideal times for notification delivery. For example, if the recipient's calendar shows that the recipient is busy in a meeting from 10-11 AM, then, based on the recipient's calendar, the delivery may be scheduled at 11:01 AM or some other time after the meeting has ended. As such, by analyzing the recipient's scheduled events, such as meetings or appointments, the system determines time slots when the recipient is likely to be available and not preoccupied.

In addition to calendar data, the system may use real-time contextual information to refine the notification schedule. For example, if the recipient is traveling, the system may integrate data from traffic APIs like Waze or GPS to assess current road conditions. By analyzing the recipient's route, such as route to the recipient's home or work, the system may determine if they might encounter delays. If heavy traffic or delays are anticipated, the system may adjust the notification time to a less disruptive period. For example, if the recipient is to get home by 11 AM, but is delayed in traffic by 20 minutes, then the notification may be delayed at least until 11:20 AM.

Similarly, the system may monitor for unexpected appointments or schedule changes by continuously syncing with the recipient's calendar and other relevant data sources. For example, if a meeting is rescheduled to a later time or a doctor's appointment runs late, the system may adjust the notification accordingly and delay it until the user is available or able to engage with the message.

In some embodiments, the recipient may not allow sharing contextual data, either partially or in totality. In other embodiments, the recipient may set parameters on what can be shared. If the recipient does not allow sharing contextual data, the system may provide the sender with an interface to specify an arbitrary notification time. This interface allows the sender to select a specific date and time for the notification to be delivered, without relying on contextual data from the recipient. The sender may manually input the desired notification time using a date and time selection tool displayed on their user interface, ensuring that they have full control over the scheduling.

Once the command is received by the recipient, the optimal or specified notification time may be determined, the system may then schedule the notification for future delivery. For modern messaging platforms like iMessage or RCS, this may involve attaching metadata to the message indicating the scheduled notification time. The metadata might include fields such as “scheduled_notification” and the specific time for the notification, formatted according to the recipient's local time zone. FIG. 18 provides an example of such attached metadata which includes a title 1810, scheduled notification, a body 1820, and an action 1830, which is to schedule the notification. The metadata may also include message ID and other portions as depicted in the figure.

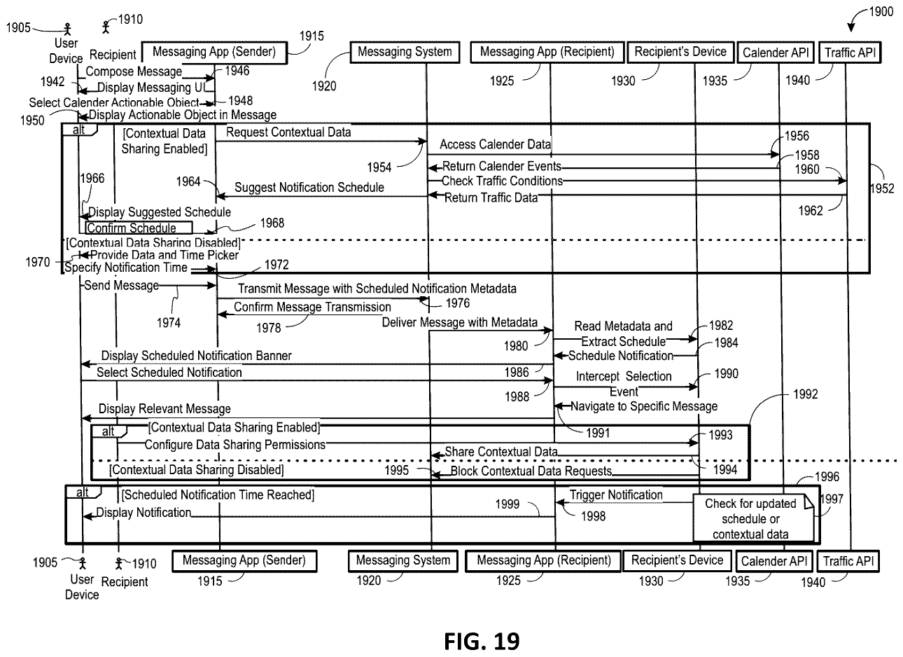

FIG. 19 is communication process 1900 between systems and devices for executing a scheduled notification, in accordance with some embodiments of the disclosure. The process 1900 may be implemented, in whole or in part, by systems or devices such as those shown in FIGS. 2 and 3. One or more actions of the process 1900 may be incorporated into or combined with one or more actions of any other process or embodiments described herein. The process 1900 may be saved to a memory or storage (e.g., any one of those depicted in FIGS. 2 and 3) as one or more instructions or routines that may be executed by a corresponding device or system to implement the process 1900.

In some embodiments, process 1900 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

In some embodiments, the scheduling described in FIG. 19 may be for an SMS message. In such embodiments, SMS scheduling may be implemented by including a predefined format in either the UDH or UD field. By using such format may allow the system to specify the desired or scheduled delivery time.

The recipient device may receive the scheduling metadata in UHD or UD and interpret the metadata and delay the message until the scheduled time and then deliver the notification on the user device of the recipient. When the recipient device delays the notification based on the delay metadata, it may display the notification as if it were just received, e.g., in real-time and not inform the recipient that it was delayed. The messaging app may also prioritize the notification (after the message is delivered after the delay), ensuring it stands out even if other messages have arrived in the meantime.

This process involves setting an internal timer based on the scheduled notification metadata, which triggers the notification at the appropriate time. In some embodiments, even if the user has already read the message, the system may notify the user again at the scheduled time, e.g., the delayed time, since the sender would have a reason to schedule the notification for a particular time.

The system continuously monitors for any changes in the recipient's schedule or contextual factors up until the scheduled notification time. If significant changes are detected, such as the addition of a new meeting or an unexpected delay, the system can dynamically reschedule the notification to a more suitable time. This adaptability ensures that the notification is delivered when the recipient is most likely to be receptive and available. By leveraging calendar data, real-time contextual information, and dynamic scheduling adjustments, this embodiment ensures that notifications are delivered at the most appropriate times, enhancing the likelihood of prompt and attentive responses from recipients. By enabling senders to set any desired delivery time, e.g., delay for the desired period or delay based on the recipient's busy schedule, even without specific context, the sender may be empowered to control notification timing and ensure their message is delivered as intended and at the most optimal time.

The process for performing the above mentioned embodiment is described in more detail in FIG. 19. As depicted in FIG. 19, in some embodiments, a message is composed at 1946 using a messaging application 1915 at the sender's end, e.g., on a sender's device, also referred to as the second computing device. The messaging application 1915 may be any type of messaging application, such as SMS, MMS, RCS, iMessage, Slack message, Microsoft Teams message, Google chat message, Discord message, OTT messaging applications (WhatsApp, Telegram, Signal), or social media chat messages (Facebook messenger, Instagram Direct, Snapchat). The platform may be Android or iOS. In response to the sender composing the message, the messaging application may display the composed message on the messaging user interface on the sender's device at 1942.

Once the message is composed and displayed, the sender's user device 1905 may select an actionable object at 1942 to associate with the message. In this example the actionable object selected and associated with the message may be a calendar and a clock emoji. In some embodiments, the sender's user device 1905 may select the actionable object from one of the actionable objects displayed on the user interface of the messaging application 1915. In some embodiments, the messaging application, based on the content and context of the message or the recipient's contextual data may suggest the actionable object for selection.

When the actionable object is selected, such as by double clicking or selecting the actionable object from the user interface, the messaging application 1915 may display the selected actionable object, e.g., the calendar actionable object, in or alongside of the message at 1948. Some examples of the display of the actionable object (e.g., emoji) are provided in FIG. 25 where the emoji is displayed above the message at 2540 or within the message at 2560 in the sender's messaging application's user interface. The actionable object may be displayed at 1948 on the sender's device 1905 to provide visual feedback prior to the sender selecting a send button.

Once the actionable object is selected, the system may translate the actionable object into a corresponding command, which may be included as metadata in a data packet separately from the message, such as header or payload. In another embodiment, metadata and message may be placed and sent together, however, instructions may be provided to process the metadata separately from the main body of the message.

When the actionable object is selected, which in this embodiment is a calendar actionable object for scheduling the notification to the recipient, contextual data is obtained at 1952 through steps 1956-1962. Such steps include accessing the calendar at 1956, such as by making an API call to the calendar application, the calendar application in response and via the API, returning calendar events at 1958, obtaining traffic conditions at 1960, such as via making an API call to the traffic API 1940, the traffic application, in response and via the API, returning traffic data at 1952. All such data from calendaring, traffic, and any other applications that relate to scheduling, may be obtained to determine a suggested schedule and a specific notification time when the message delivery and/or notification to the recipient may be optimal. In other words, the calendaring and traffic data may be used in combination with the recipient's contextual data to determine the optimal notification time for the message. For example, it may be used to determine whether the recipient is busy or whether they are driving and delayed in getting home. Two alternative paths may be selected based on whether such contextual data is available. In one embodiment, at step 1968, the selection and confirmation of a scheduled time may be based on the recipient contextual data and in another embodiment, at step 1972, when contextual data sharing at the recipient is disabled, the sender may provide the selection of date and time. At 1974, the sending user's device may request to transmit the message to the recipient device 1930 and the system based on the suggested notification schedule may determine the time to transmit or time to notify the recipient. The system using such data may then transmit the message with scheduled notification metadata, e.g., based on data gathered via APIs, at 1976. As described earlier, the message and the actionable object may be separate from each other thereby allowing, if desired, by any receiving entity to review and take action based on the actionable object or review and discard the actionable object. As such, the recipient device may be able to process the instructions associated with the actionable object separately from the message composed by the sending device. Although transmitting of the actionable object is described in this and other figures, the embodiments also include transmitting the command associated with the actionable object or the instructions associated with the command as custom metadata instead of transmitting the actionable object.

Upon receipt of the message with the unique identifier at 1976, the messaging system 1920 may confirm receipt, at 1978, to the sender's messaging application 1915. In some embodiments, if the receipt is not received within a predetermined time, then the sender's messaging application may retransmit the message with the actionable object and the unique identifier together or separately to the messaging system 1920.

At 1980, the messaging system 1920 may deliver the message with the metadata to the messaging application 1925 of the recipient device 1930. The metadata may include the actionable object, its associated command, and/or the instructions associated with the command. The metadata may also include multiple layers of commands and instructions. The metadata may also include notification instructions that were suggested to be included in the command based on calendar, traffic, and other scheduling data obtained through APIs at 1952.

At 1982, the recipient device 1930 may read the metadata and extract the schedule. At 1984, the recipient device 1930 may then schedule notification and inform the messaging application 1925 associated with the recipient device 1930.

The messaging application 1925 associated with the recipient device 1930, in response to receiving the scheduling notification, may transmit a banner that may be displayed on the sender's user device 1905 at 1986. The sender's user device 1905 may then schedule notification at 1995 upon receiving the banner. Upon receiving the scheduled notification at 1995 from the sender device, the messaging application 1925 associated with the recipient device 1930 may intercept selection event at 1990 and navigate to the specific message at 1991. To summarize, the metadata is extracted, and notification is scheduled based on input from the sender device and then rather than searching for the message to display at the delayed time, the messaging application is able to navigate directly to the message that was on hold/delayed using a unique identifier.

At 1992, contextual data may be shared with the sender device. This data may relate to the message engagement metrics described in FIG. 5. Sharing or blocking permissions and authorizations may be obtained prior to sharing of the engagement metrics with the sender device.

In some embodiments, the sender may either update or cancel the command after determining that the command has not yet been executed. For example, prior to the delay command being executed. Some examples of the commands for updating or cancellation are provided at FIGS. 6A-6B and 7-8.

In yet other embodiments, the schedule or contextual data may be updated. As such, the system at 1996, through steps 1997-1999 may check for updates and accordingly update the message notification or delay of the message as appropriate.

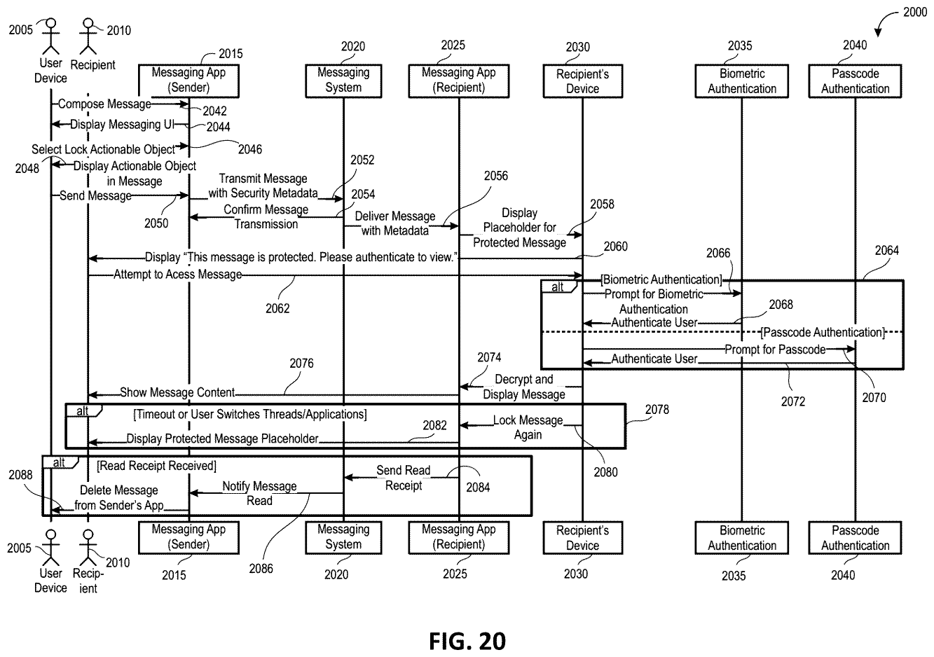

FIG. 20 is communication process 2000 between systems and devices when biometric authentication is used, in accordance with some embodiments of the disclosure. The process 2000 may be implemented, in whole or in part, by systems or devices such as those shown in FIGS. 2 and 3. One or more actions of the process 2000 may be incorporated into or combined with one or more actions of any other process or embodiments described herein. The process 2000 may be saved to a memory or storage (e.g., any one of those depicted in FIGS. 2 and 3) as one or more instructions or routines that may be executed by a corresponding device or system to implement the process 2000.

In some embodiments, process 2000 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

In some embodiments, FIG. 20 relates to handling messages with sensitive information. In some embodiments, when a message contains sensitive information or attachments, an actionable object, such as a lock emoji, may be suggested by the system.

The message is then encrypted, requiring biometric authentication or a passcode for access. This ensures that only the intended recipient can view the message in a private setting. Ins some embodiments, the system may use AI to assess message sensitivity. For example, by comparing content with public data or analyzing keywords like ‘confidential’ or ‘privileged,’ the system can determine if the message or its attachments are private. In other embodiments, leveraging AI, the system may evaluate the context and content to gauge whether the message should be shared publicly. For example, personal family matters or sensitive company project details might be automatically marked as private and sensitive.

In some embodiments, when the sender selects the actionable object associated with sensitivity, privacy, and/or confidentiality, such as a lock emoji, while composing a message, the system may determine such an actionable object as an instruction to secure the message with biometric authentication or a passcode. The system may then attach metadata to the message indicating that biometric authentication or a passcode is required for access. As such, when such metadata is attached, the recipient, to open the message, may need to unlock their device using their primary authentication method, authenticate themselves using their registered biometric data, such as their fingerprint that can be analyzed using a biometric sensor on their phone to verify a match. Only when the biometric information is verified, the system may then decrypt the message and display it for the recipient to read. In the embodiments where recipient biometrics data is required as a password to access the sensitive message, such biometric data may not be shared with the sender to protect the recipient's privacy. As such, biometric verification may occur solely on the recipient device, and their biometric data may remain private. The sender may only be notified that the recipient is successfully verified.

In some embodiments, the message may be additionally encrypted by the receiver's device. In some embodiments, the message may be deleted from the sender's messaging application once a read receipt is received from the recipient device.

Upon receiving the message, the recipient device may display a placeholder indicating that the message is protected and requires biometric authentication or a passcode to access. The placeholder might display a lock icon or a message such as “This message is protected. Please authenticate to view.” When the recipient attempts to access the message, the device prompts for biometric authentication or a passcode. This may involve scanning a fingerprint, using facial recognition, or entering a secure passcode. Once authenticated, the device decrypts and displays the message content. After a timeout or when the user switches message threads or applications, the message may be put back into a “locked” state requiring re-authentication for subsequent reads.

The process for performing the above mentioned embodiment is described in more detail in FIG. 20. As depicted in FIG. 20, in some embodiments, a message is composed at 2042 using a messaging application 2015 at the sender's end, e.g., on a sender's device, also referred to as the second computing device. The messaging application 2015 may be any type of messaging application, such as SMS, MMS, RCS, iMessage, Slack message, Microsoft Teams message, Google chat message, Discord message, OTT messaging applications (WhatsApp, Telegram, Signal), or social media chat messages (Facebook messenger, Instagram Direct, Snapchat). The platform may be Android or iOS. In response to the sender composing the message, the messaging application may display the composed message on the messaging user interface on the sender's device at 2005.

Once the message is composed and displayed, the sender's user device 2005 may select an actionable object at 2046, which in this example is a lock emoji indicating that the message is sensitive, confidential, private, and/or privileged. As described earlier, in some embodiments, the system, such as by leveraging AI, may analyze the content and context of the message and based on the analysis determine that the message is sensitive, confidential, private and/or privileged. Accordingly, the system may automatically suggest to the sender device to include an actionable object that indicates that the message is sensitive, confidential, private and/or privileged.

When the actionable object is selected, such as by double clicking or selecting the actionable object from the user interface, the messaging application 2020 may display the selected actionable object, e.g., the lock actionable object, in or alongside of the message at 2005. Some examples of the display of the actionable object (e.g., emoji) are provided in FIG. 25 where the emoji is displayed above the message at 2540 or within the message at 2560 in the sender's messaging application's user interface. The actionable object may be displayed at 2048 on the sender's device 2005 to provide visual feedback prior to the sender selecting a send button.

Once the actionable object is selected, the system may translate the actionable object into a corresponding command, which may be included as metadata in a data packet separately from the message, such as header or payload. In another embodiment, metadata and message may be placed and sent together, however, instructions may be provided to process the metadata separately from the main body of the message.

When the actionable object is selected, which in this embodiment is a lock actionable object for indicating to the recipient device that the message contains sensitive, confidential, private, and/or privileged information, the recipient device 2030, at 2064, may require the recipient associated with the recipient device to authenticate themselves using biometric data, such as a fingerprint. Steps 2068-2072 may be executed to verify and authenticate the recipient using biometric data.

At blocks 2074, the message may be decrypted and displayed. Once displayed it may be locked again at 2078 after it has been viewed. A read receipt may be sent to the sender device 2984 and 2088 once the recipient has read the message.

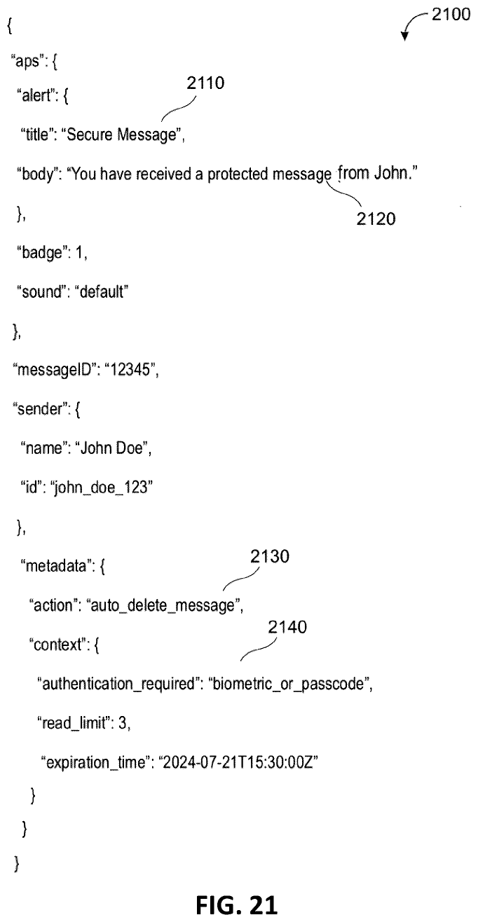

FIG. 21 is an example of structuring metadata for automatically deleting message in iMessage, in accordance with some embodiments of the disclosure. In some embodiments, metadata in FIG. 21 may relate to sending instructions on how to delete a message with sensitive, confidential, private, privileged, once it has been read. As depicted, among other elements, the metadata may include a title 2120, which indicates that it is a secure message, a body 2120, which in this example includes text that informs the recipient that they have received a protected message, a command 2130 to auto delete the message after it has been read, and another command 2140 that indicates to the recipient device to authenticate the recipient using biometrics or passcode prior to displaying the sensitive message.

In some embodiments, an actionable object for example, a lock and flame may be suggested when the message contains sensitive, confidential, private, or privileged information or attachments. Adding such an actionable object may automatically mark the message for deletion after it's been read, such as once, twice, or a few times, or after a certain amount of time, as predetermined. Doing so may ensure that sensitive data is permanently removed after it has been read so it doesn't fall in the wrong hands.

In this embodiment, when the sender selects the action emoji while composing a message, the system interprets this selection as an instruction to secure the message with biometric authentication or a passcode and to set it for automatic deletion after a specified number of reads or a time period. The system may attach metadata to the message indicating that biometric authentication or a passcode is required for access and specifying the conditions for automatic deletion.

Upon receiving the message, the recipient device may display a placeholder indicating that the message is protected, temporary, and requires biometric authentication or a passcode to access. The placeholder might display a lock and flame icon or a message such as “This message is temporary and protected. Please authenticate to view.”

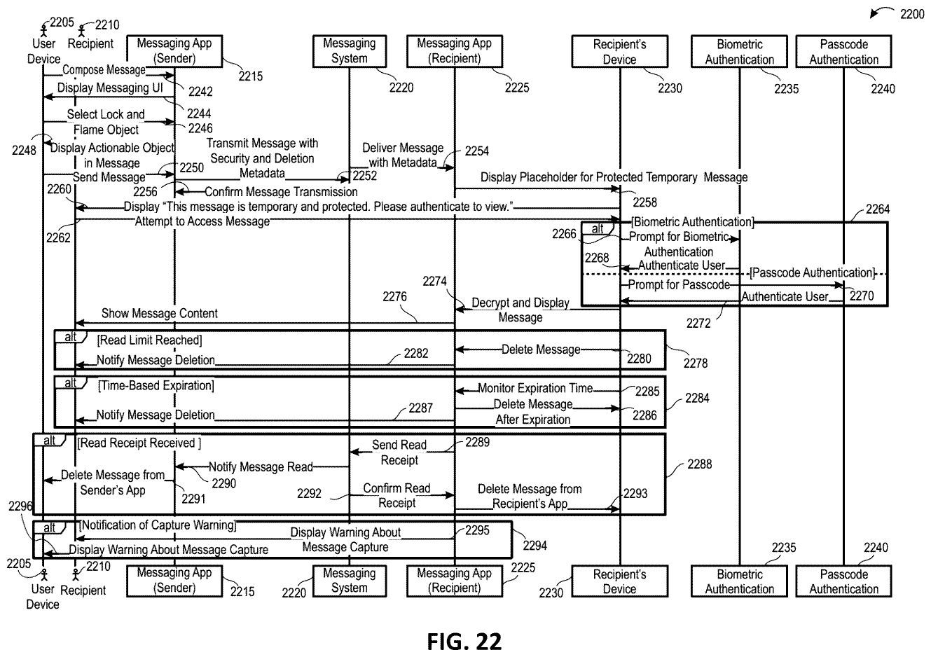

FIG. 22 is communication process 2200 between systems and devices when biometric authentication is used and a message is automatically deleted based on various deletion factors, in accordance with some embodiments of the disclosure. The process 2200 may be implemented, in whole or in part, by systems or devices such as those shown in FIGS. 2 and 3. One or more actions of the process 2200 may be incorporated into or combined with one or more actions of any other process or embodiments described herein. The process 2200 may be saved to a memory or storage (e.g., any one of those depicted in FIGS. 2 and 3) as one or more instructions or routines that may be executed by a corresponding device or system to implement the process 2200.

In some embodiments, process 2200 may be used to enhance message notifications by allowing senders of the message to add actionable objects that are embedded with contextual commands to their messages using, such as emojis or icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

As described above, for SMS messages, the automatic deletion command may be incorporated within the UDH or UD field in a predefined format to ensure the security and deletion information is transmitted alongside the message. The recipient device may receive such security and deletion information and then processes and implement it as indicated in the metadata.

In some embodiments, to access the message, the recipient device may require biometric authentication or a passcode. This may be based on instructions provided in the metadata to the recipient device to require such biometric verification. Such biometric verification may be of many types. For example, this may include scanning a fingerprint, using facial recognition, entering a secure passcode, or even utilizing voice or iris recognition. In some embodiments, the sender may also specify the desired biometric data and the required time for submitting the data, such as within 5 minutes of receiving the biometric verification request. In some embodiments, another authority, such as a government entity or a third party may verify the biometric data to prevent unauthorized access and ensure the information is only viewed by the intended recipient.

Once authenticated, the device may decrypt and display the message content. The system may then enforce the automatic deletion policy based on the parameters set by the sender. In some embodiments, if the message has a specified number of allowed reads, such as 3, 5, or 10, then the system may monitor, such as by using a counter, how many times it has been accessed and read and then no longer display it after the number of reads have been reached. For example, after the message is read the specified number of times, the system automatically deletes the message from the recipient device. This is achieved by securely erasing the message content and any associated metadata from the device's storage.

Additionally, if a time-based expiration is set, the system monitors the elapsed time since the message was first accessed. When the specified expiration time is reached, the system permanently deletes the message, regardless of the number of times it has been read. The message content and metadata are securely erased from the device's storage to ensure that no traces of the message remain.

In some embodiments, the message may be deleted from both the sender's and receiver's device once a read receipt has been sent from the receiver to the sender. Additionally, a notification may be sent to each participant indicating that the message has been deleted.

In some embodiments, in addition to read limits, other security features, such as capture prevention of the message may be implemented. In this embodiment, the recipient may not be able to save or take a screenshot of the message. In this embodiment, both the sending and receiving device may display a notification indicating that it is not possible to capture the content of the message using methods outside of the messaging application, such as performing a screenshot.

The process for performing the above mentioned embodiment is described in more detail in FIG. 22. As depicted in FIG. 22, in some embodiments, a message is composed at 2242 using a messaging application 2215 at the sender's end, e.g., on a sender's device, also referred to as the second computing device.

Once the message is composed and displayed, the sender's user device 2205 may select an actionable object at 2246, which in this example is a lock and a flame, to associate with the composed message. In some embodiments, the sender's user device 2205 may select the actionable object from one of the actionable objects displayed on the user interface of the messaging application 2215. In some embodiments, the messaging application, based on the content and context of the message or the recipient's contextual data may suggest the actionable object for selection.

When the actionable object is selected, such as by double clicking or selecting the actionable object from the user interface, the messaging application 2215 may display the selected actionable object, e.g., the lock and flame, in or alongside of the message at 2248. Some examples of the display of the actionable object (e.g., emoji) are provided in FIG. 25 where the emoji is displayed above the message at 2540 or within the message at 2560 in the sender's messaging application's user interface. The actionable object may be displayed at 2248 on the sender's device 2205 to provide visual feedback prior to the sender selecting a send button.

The process then includes block 2254, 2278, 2284, 2288, and 2294 which includes a plurality of sub-steps. Through these steps biometric authentication, read limit management, time-expiry management, message capture prevention, and notification, as depicted may be handled.

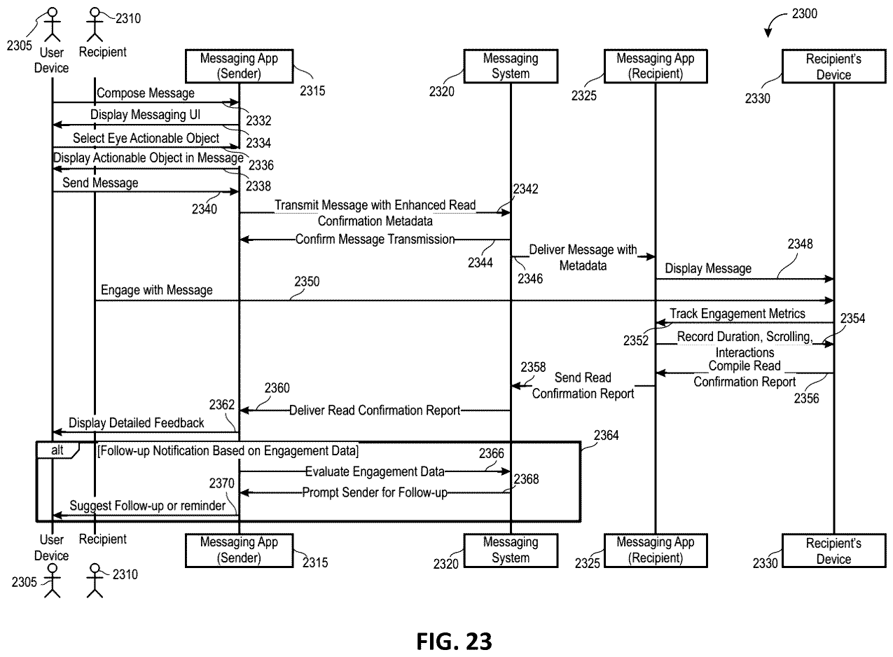

FIG. 23 is communication process 2300 between systems and devices for tracking an engagement metric related to engagement with the message, in accordance with some embodiments of the disclosure. The process 2300 may be implemented, in whole or in part, by systems or devices such as those shown in FIGS. 2 and 3. One or more actions of the process 2300 may be incorporated into or combined with one or more actions of any other process or embodiments described herein. The process 2300 may be saved to a memory or storage (e.g., any one of those depicted in FIGS. 2 and 3) as one or more instructions or routines that may be executed by a corresponding device or system to implement the process 2300.

In some embodiments, process 2300 may be used to enhance message notifications by allowing senders of the message to add actionable objects that are embedded with contextual commands to their messages using, such as emojis and icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system. Existing email application, such as Gmail or Outlook, may also be used to implement this system.

More specifically, process 2300, as depicted, involves indicating by the sender or the system to the recipient device that detailed engagement metrics are to be transmitted back to the sender that describe the level of engagement with the message by the recipient. Accordingly, in an embodiment, an actionable object showing, for example, an eye is suggested when the sender needs confirmation that the message has been read. The system provides detailed feedback on the recipient's engagement with the message, tracking metrics such as the time taken to read the message and how thoroughly the message was reviewed. Follow-up notifications are adjusted based on this engagement data. This functionality goes beyond existing “send read receipts” and can be applied to an individual message rather than all messages. In some embodiments, an actionable object, such as an eye, may be inserted into the message. The eye actionable object, such as an eye emoji, may be selected based on the sender's desire for confirmation that the message has been engaged with by the recipient. The system, based on the inclusion of the eye actionable object, may provide detailed feedback on the recipient's engagement with the message, such as tracking metrics that may be much more than a simple read receipt. For example, such metrics may include time spent reading, scrolling, and content interactions by the recipient. They may also include tracking data such as whether the recipient forward, saved, or starred the message. They may also include data such as how many times the recipient read the message. They may also include data such as whether the recipient manually took any actions based on the message (e.g., calendaring events or alarms or driving to the destination, such as a restaurant recommended in the message. In some embodiments, the engagement metrics may provide in-depth analysis, such as comparing current message engagement to past interactions. Such analysis may be useful to tailor their communication strategies and ensure that important messages are acknowledged.

Follow-up notifications may then be adjusted based on the engagement metrics received by the sender relating to the recipient's engagement with the message.

When the sender selects the actionable object, such as the eye actionable object, while composing a message, the system interprets this selection as a request for detailed read confirmation. The system attaches metadata to the message indicating that enhanced read confirmation is required. This metadata specifies the types of engagement metrics to be tracked, such as the duration the message was open and interactions with the message content such as how long the message is open, whether the recipient scrolls through the message, and if any links or attachments within the message are accessed. Once the recipient finishes engaging with the message, the device compiles this data and sends it back to the sender's device as part of a read confirmation report.

Upon receiving the read confirmation data, the sender's device processes the information and provides detailed feedback to the sender. This feedback includes metrics such as the time taken to read the message, the extent of scrolling, and any interactions with the content. The sender can view this information in their messaging application to understand how the recipient engaged with the message.

Based on the engagement data, the system can also adjust follow-up notifications. For example, if the data indicates that the recipient did not fully read the message or did not interact with critical content, the system can prompt the sender to send a follow-up message or reminder. This ensures that important information is acknowledged and acted upon.

The process for performing the above mentioned embodiment is described in more detail in FIG. 23. As depicted in FIG. 23, in some embodiments, a message is composed at 2332 using a messaging application 2315 at the sender's end, e.g., on a sender's device, also referred to as the second computing device.

Once the message is composed and displayed, the sender's user device 2305 may select an actionable object at 2336, which in this example is an eye emoji, to associate with the composed message. The eye actionable object may include instructions for the recipient device to collect and transmit message engagement metrics to the sender device. In some embodiments, the sender's user device 2305 may select the actionable object from one of the actionable objects displayed on the user interface of the messaging application 2315. In some embodiments, the messaging application, based on the content and context of the message or the recipient's contextual data may suggest the actionable object for selection.

When the actionable object is selected, such as by double clicking or selecting the actionable object from the user interface, the messaging application 2315 may display the selected actionable object, e.g., the eye, in or alongside of the message at 2338. Some examples of the display of the actionable object (e.g., emoji) are provided in FIG. 25 where the emoji is displayed above the message at 2540 or within the message at 2560 in the sender's messaging application's user interface. The actionable object may be displayed at 2248 on the sender's device 2205 to provide visual feedback prior to the sender selecting a send button.

Steps 2342-2348 are similar to other steps in the above mentioned figures. The process of tracking the engagement metrics is described through steps 2352-2362 where the engagement metrics are tracked, compiled, and displayed at the sender's device. Follow-ups from the sender device based on the engagement metrics are described in sub steps 2366-2370 or block 2364.

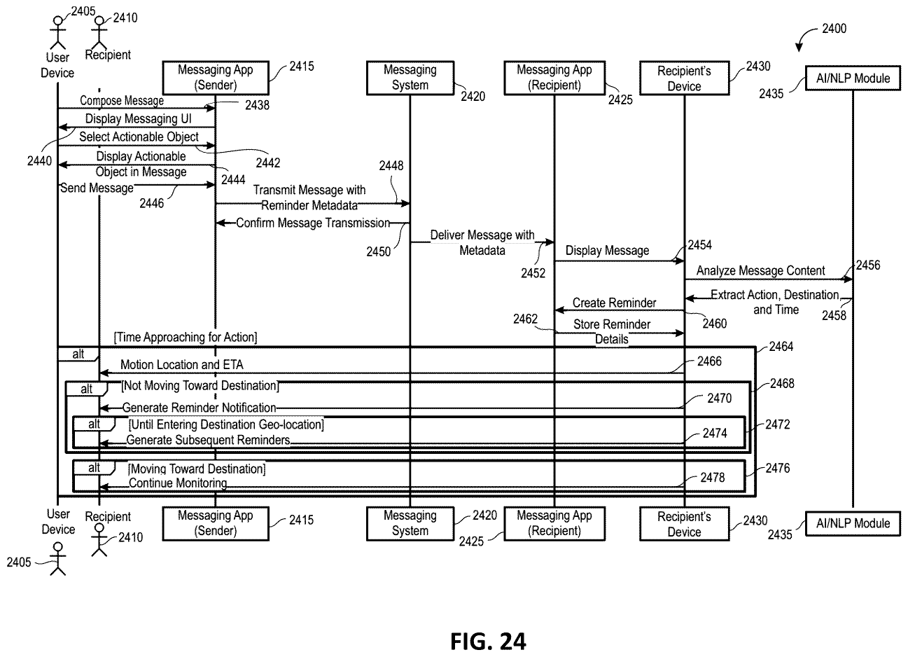

FIG. 24 is communication process 2400 between systems and devices for using a calendaring and reminding function for the recipient of the message, in accordance with some embodiments of the disclosure. The process 2400 may be implemented, in whole or in part, by systems or devices such as those shown in FIGS. 2 and 3. One or more actions of the process 2400 may be incorporated into or combined with one or more actions of any other process or embodiments described herein. The process 2400 may be saved to a memory or storage (e.g., any one of those depicted in FIGS. 2 and 3) as one or more instructions or routines that may be executed by a corresponding device or system to implement the process 2400.

In some embodiments, process 2400 may be used to enhance message notifications by allowing senders of the message to add actionable objects that are embedded with contextual commands to their messages using, such as emojis and icons. These commands are sent as metadata alongside but separate from the message to enable specific actions to be executed on the recipient device when it is contextually appropriate, e.g., when the contextual data obtained from the recipient device is within the parameters of the context described in the command or meets a contextual trigger condition as indicated in the command. Existing messaging platforms like SMS, iMessage, and RCS can be used to implement this system.

More specifically, process 2400, as depicted, involves determining if the message is a reminder for the recipient, and if so, parsing the message into action, location, and time to set appropriate reminders such that the recipient is guided to what action is to be executed by the recipient via reminders. In some embodiments, an actionable object that depicts a calendar with a check mark may be recommended by the system when the sender wants to schedule reminder notifications for the recipient. In this embodiment, the system may leverage AI, natural language processing, and semantic analysis to analyze the content and context of the composed message. If the system determined, based on the leveraging, that the sender intends to set up reminder notifications or appointments based on the identified action, location, and time, then such an actionable object may be recommended to add to the message. For example, if the sender messages “Don't forget to pick up the kids from school at 2:00 PM” and selects the reminder actionable object, the recipient device may analyze the message to understand that there is an action (pick up), a destination (school), and a time (2:00 PM).

When the sender selects the actionable object while composing the message, the system may determine this selection as an instruction to create a reminder for the recipient. The system may then attach metadata to the message indicating that reminder notifications are required. This metadata includes the extracted details of the action, destination, and time may be transmitted to the recipient device.

Upon receiving the message, the recipient device may process the metadata and use AI and NLP techniques to parse the message content. The system may then identify key elements such as the action to be performed, the destination, and the time. The system may then correlate the destination to known locations in the recipient's contacts or frequently visited places. For instance, “school” could be matched to a known contact address stored as “School” in the recipient's contacts, such as the son's elementary school.

As the time for the action approaches, the recipient device may monitor its location and compare it to the identified destination. The system may then take into account the estimated time of arrival (ETA) based on the recipient's mode of transportation, whether driving or walking. If the recipient device is not moving towards the destination as the time approaches, the system may generate subsequent message notifications to act as reminders. In another embodiment, when the system detects that the recipient device is not moving towards the destination, it may query the recipient's other devices to determine whether any of those devices are moving towards the destination. For example, the recipient may use both their smartphone and smartwatch to send and receive messages. If the recipient's smartphone is not moving towards the destination, the system may query the recipient's smartwatch to determine whether it is moving towards the destination. The recipient may also have registered all the devices that used for messaging and the system may access the registered list of recipient devices and query all of them simultaneously. The system may then send follow-up messages on the recipient's primary device, which may be the smartphone, if it determines that none of the recipient devices are moving towards the destination.

These reminders may continue to alert the recipient until the device enters the geo-location of the destination. For instance, if the recipient has not started moving towards “123 School St, Hometown” by 1:45 PM for a 2:00 PM pickup, the device might generate a notification at 1:30 PM, another at 1:45 PM, and further reminders if needed. Such reminders may ensure that the recipient is continuously reminded of the scheduled action.

The process for performing the above mentioned embodiment is described in more detail in FIG. 24. As depicted in FIG. 24, in some embodiments, a message is composed at 2432 using a messaging application 2415 at the sender's end, e.g., on a sender's device, also referred to as the second computing device.

Once the message is composed and displayed, the sender's user device 2405 may select an actionable object at 2442, which in this example is a calendar emoji with a check mark, to associate with the composed message. The calendar with a check mark actionable object may include instructions for the recipient device to remind the recipient of the task they are to perform at a certain time. In some embodiments, the sender's user device 2405 may select the actionable object from one of the actionable objects displayed on the user interface of the messaging application 2415. In some embodiments, the messaging application, based on the content and context of the message or the recipient's contextual data may suggest the actionable object for selection.

When the actionable object is selected, such as by double clicking or selecting the actionable object from the user interface, the messaging application 2415 may display the selected actionable object, e.g., the calendar with a check mark, in or alongside of the message at 2440. Some examples of the display of the actionable object (e.g., emoji) are provided in FIG. 25 where the emoji is displayed above the message at 2540 or within the message at 2560 in the sender's messaging application's user interface. The actionable object may be displayed at 2248 on the sender's device 2205 to provide visual feedback prior to the sender selecting a send button.

Steps 2348-2456 are similar to other steps in the above mentioned figures. The process of extracting action, destination, and time and setting reminders, as described above are described at 2458-2478. Such reminders may continue until the recipient completes the task or provides some input to the sender indicating that the task has been completed.

FIG. 25 is a user interface for generating a message and associating an actionable object, such as an emoji, with the message, in accordance with some embodiments of the disclosure. In some embodiments, the actionable object may be included with the composed message as indicated at 2505.

In one embodiment, e.g. Option A, the actionable object 2520 may be selected from library 2510 and appended above the message 2550 at location 2540. For example, the user may drag and drop, select, swipe, or utter a voice command to insert the actionable object from the library of actionable objects. In related embodiments, the actionable object 2520 may be located anywhere surrounding or in the vicinity of the message in the message composing area.

In another embodiment, e.g. Option B, the actionable object 2520 may be selected from library 2510 and included inside the message, such as at 2560. In yet another embodiment, e.g. Option C, the actionable object 2520 may be hidden and displayed only when the user selects a display option. The display of the actionable object may also be customized such that it may be displayed at any location in the user interface.

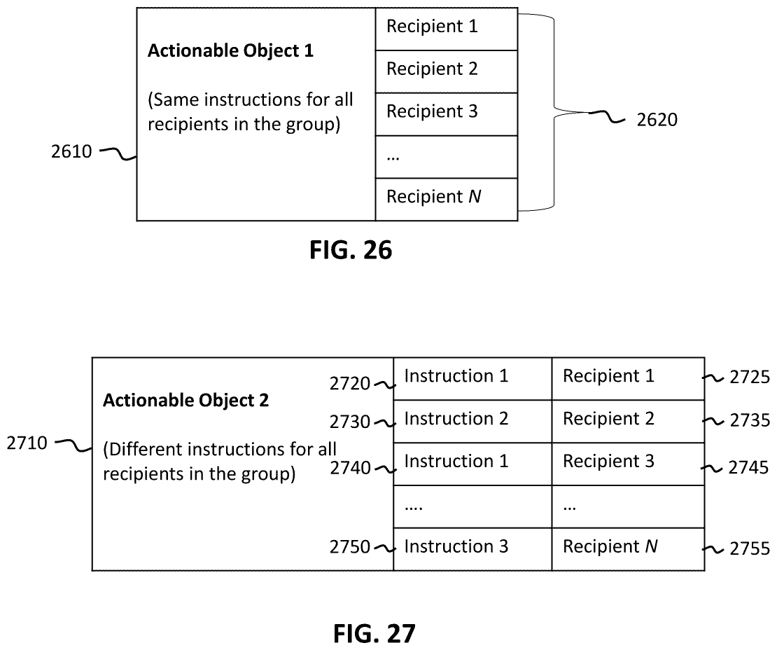

FIG. 26 is an example of using the same actionable object for all recipients in a group, in accordance with some embodiments of the disclosure. In some embodiments, a message may be a group message that is sent from the sender to a group of recipients. The group may be set up using the messaging application, such as WhatsApp, Slack, Teams, Google Meet, or an SMS group.

In this embodiment, the sender may select an actionable object 2610, such as actionable object 1 which has the same instructions for all the recipients 2620, e.g., recipient 1-N, in the group. In this embodiment, the actionable object may include the same instructions to all recipients on how to handle the message based on their contextual data. For example, if the message instructions are to deliver the message when the recipient wakes up, since each recipient may wake up from overnight sleep at different times, the action to deliver the message after waking up may vary by recipient based on their contextual data.

FIG. 27 is an example of using different instructions for each recipient in a group setting, in accordance with some embodiments of the disclosure. In some embodiments, a message may be a group message that is sent from the sender to a group of recipients. The group may be set up using the messaging application, such as WhatsApp, Slack, Teams, Google Meet, or an SMS group.

In this embodiment, the sender may select an actionable object 2710, such as actionable object 2. The instructions associated with the actionable object 2710 may be customized such that a unique or different instruction can be sent to different recipients in the group. For example, the same actionable object 2710 may include instruction 2720, which is instruction 1, to be applied to recipient 1. Likewise, the same actionable object 2710 may include instruction 2730, which is instruction 2, to be applied to recipient 2. The instruction may also be repeated for some recipients, such as for recipient 3, who may also be provided instruction 1. The same actionable object 2710 may further include instruction 2750, which is instruction 3 to be applied to recipient N. As such, within the same actionable object, different instructions may be included for different recipients. In some embodiments, the same instructions are executed for all recipients. In other embodiments, the instructions may specify which instructions should be implemented for each separate recipient device. For example, instruction 1 may be intended to be executed by recipient device 1, and instruction 2 may be intended to be executed by recipient device 2. In another embodiment, only the instruction relevant to the recipient device may be sent to the recipient device.

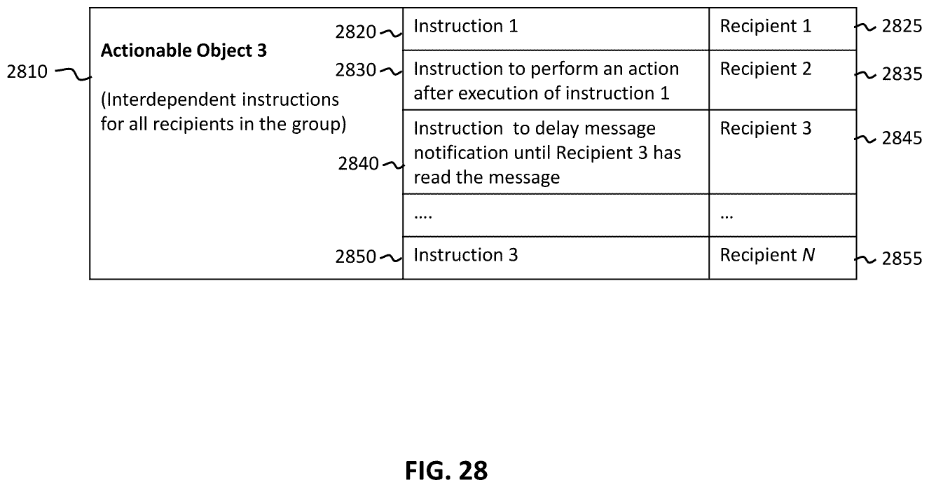

FIG. 28 is an example of including an instruction that is interdependent on an action executed for other recipients in a group setting, in accordance with some embodiments of the disclosure. In some embodiments, a message may be a group message that is sent from the sender to a group of recipients. The group may be set up using the messaging application, such as WhatsApp, Slack, Teams, Google Meet, or an SMS group.

In this embodiment, the sender may select an actionable object 2810, which includes instructions that are interdependent based on actions executed for other recipients in a group setting. Such conditional instructions may be used to determine the sequence or execution of actions for each recipient. For example, instruction 2820 may be transmitted as metadata along with the message 2825 to recipient 1. The metadata, as described earlier, may be kept separate from the message. Likewise, instruction 2830 may be transmitted as metadata along with the message 2835 to recipient 2, instruction 2840 may be transmitted as metadata along with the message 2845 to recipient 3, and instruction 3 2850 may be transmitted as metadata along with the message 8255 to recipient N.

As depicted, in instruction 2830, which is for recipient 2835, may be dependent on the actions executed for recipient 2825, e.g., to perform an action after execution of instruction 2820. Likewise, instruction 2840, which is for recipient 2845, may be dependent on the actions executed for recipient 2835, e.g., to delay message notification until Recipient 3 has read the message. Other examples of dependencies may include being permitted to send the message to a second recipient only after the first recipient has read the message or only after the first recipient wakes up. As such, the execution of an action for the second recipient in the group may be dependent upon the execution of action for the first recipient. Accordingly, one or more conditions, including nested conditions, and “if this then that” type of instructions may tie execution of actions between recipients of the group.

In some embodiments, all the instructions may be sent to all the recipients, however, within the instructions, additional instructions may indicate which instructions be implemented by which recipient device. In another embodiment, only the instruction relevant to the recipient device may be sent to the recipient device.

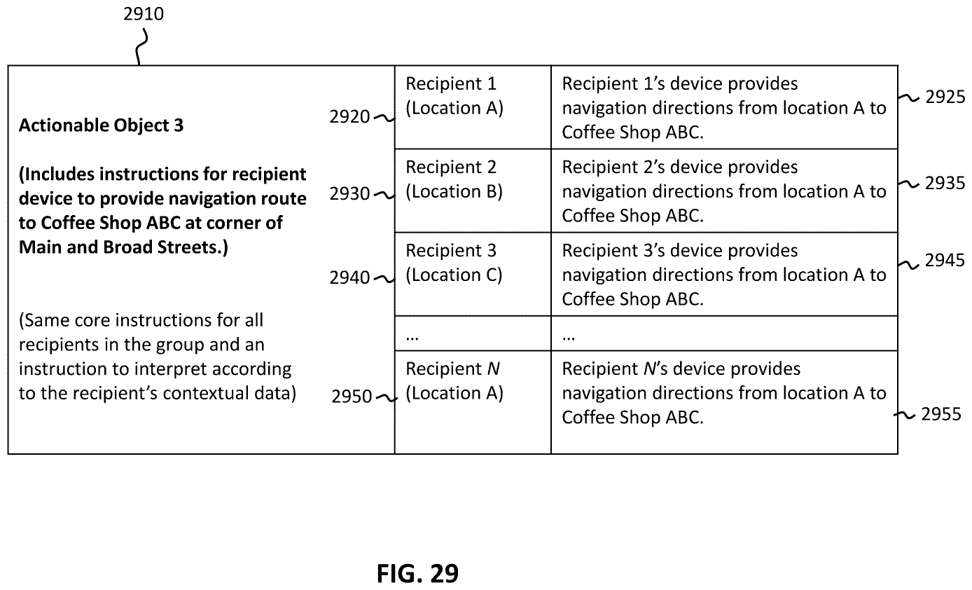

FIG. 29 is an example of using actionable objects with an instruction that may be interpreted by each recipient device based on the recipient device's contextual data, in accordance with some embodiments of the disclosure. In some embodiments, a message may be a group message that is sent from the sender to a group of recipients. The group may be set up using the messaging application, such as WhatsApp, Slack, Teams, Google Meet, or an SMS group.

In this embodiment, the sender may select an actionable object 2910, such as actionable object 3. Although the actionable object 2910 and the associated instructions may be the same for each recipient 2935-2955 of the group, additional instructions to each separate recipient device may be to interpret and apply the provided instructions according to their contextual circumstances. For example, while the general instructions for all recipients may be for the recipient device to provide navigation instructions to a specific destination, such as coffee shop ABC located at the corner of Main and Broad streets, the routing to that location could differ based on each recipient location and their starting points. For example, recipient 1, referenced at 2920, may be currently at location A when they receive the message, recipient 2, referenced at 2930, may be currently at location B when they receive the message, recipient 3, referenced at 2940, may be currently at location C when they receive the message, and recipient N may be with recipient 1 at the same location A as recipient 1. As such, the separate recipient devices may interpret the actionable object according to their location and generate appropriate directions. In this embodiment, although the core instructions to all the recipients in the group may be identical, e.g., to provide navigational directions to the same destination, the specific implementation might vary across recipients due to their unique contextual data.

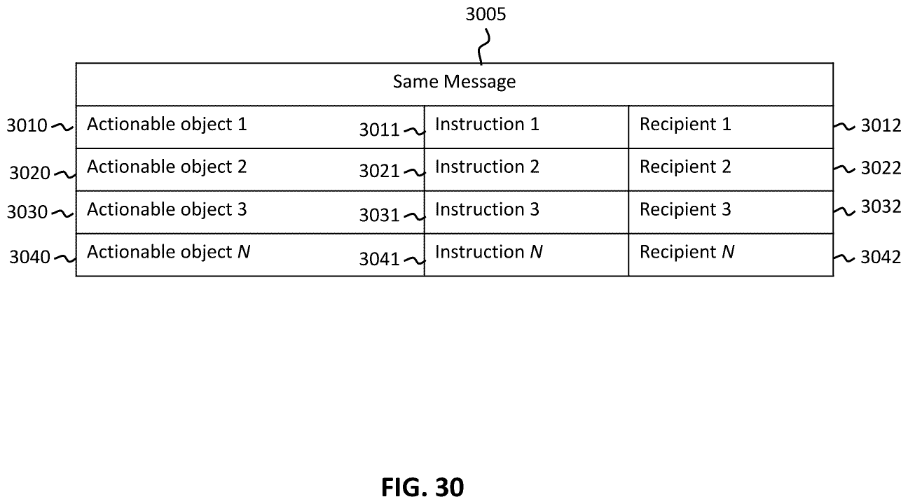

FIG. 30 is an example of using distinct actionable objects, each with distinct instructions, for each recipient in the group that is to receive the same message, in accordance with some embodiments of the disclosure. In some embodiments, a message may be a group message that is sent from the sender to a group of recipients. The group may be set up using the messaging application, such as WhatsApp, Slack, Teams, Google Meet, or an SMS group.

In this embodiment, the sender may select different actionable objects 1-N, such as actionable objects, 3010, 3020, 3030, 3040, for the same message 3005, that is to be sent to a plurality of recipients (1-N). Each such actionable object may be associated with a different instruction(s) for the recipient device to handle the same message. For example, actionable object 3010 may include an instruction 3011 that is provided as metadata to recipient 3012. Likewise, actionable object 3020 may include an instruction 3021 that is provided as metadata to recipient 3022, actionable object 3030 may include an instruction 3031 that is provided as metadata to recipient 3032, and actionable object 3040 may include an instruction 3041 that is provided as metadata to recipient 3042. Accordingly, the sender may include separate actionable objects within the same message, specifying which actionable object applies to which recipient. These actionable objects could be distinct or related, with their implementation varying based on different commands and associated instructions associated with each actionable object for each recipient for whom it is directed.

In some embodiments, all the instructions may be sent to all the recipients, however, within the instructions, additional instructions may indicate which instructions be implemented by which recipient device. In another embodiment, only the instruction relevant to the recipient device may be sent to the recipient device.

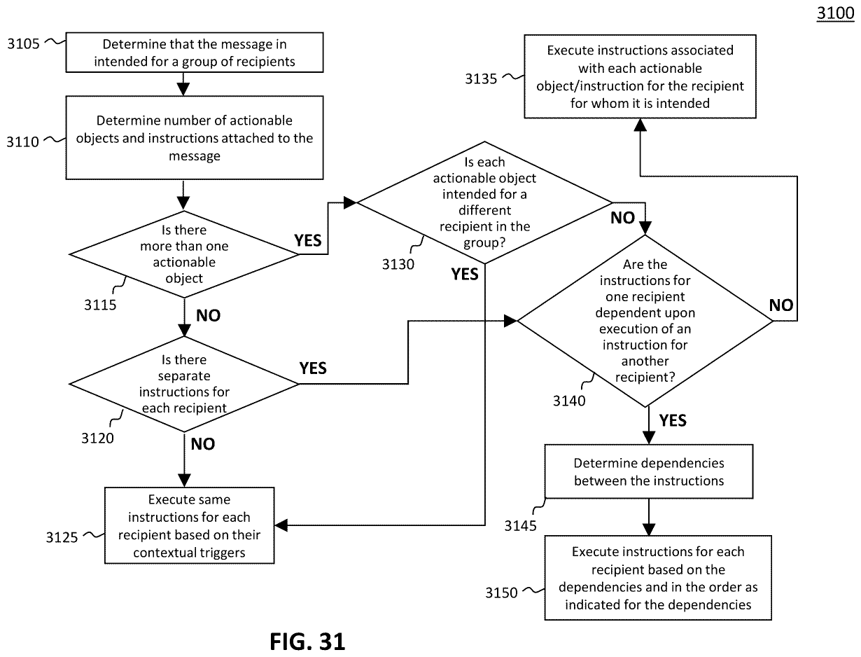

FIG. 31 is a flowchart of a process 3100 for composing a message and an actionable object for plurality of recipients in a group setting. The process 3100 may be implemented, in whole or in part, by systems or devices such as those shown in FIGS. 2 and 3. One or more actions of the process 3100 may be incorporated into or combined with one or more actions of any other process or embodiments described herein. The process 3100 may be saved to a memory or storage (e.g., any one of those depicted in FIGS. 2 and 3) as one or more instructions or routines that may be executed by a corresponding device or system to implement the process 3100.

In some embodiments, the message sent by the sender may be intended for multiple recipients within a group. This group could be established using platforms like WhatsApp, Slack, Google Meet, or any other messaging application. FIG. 31 illustrates various scenarios where the sender can transmit a message along with an actionable object to a group of recipients. For instance, in one embodiment, the sender might attach a single actionable object to the message, accompanied by a single instruction that applies to all recipients within the group. In another embodiment, the sender may attach a single actionable object but provide different instructions for each individual recipient within the group. In yet another embodiment, the sender may attach an actionable object with instructions that are interdependent between recipients. In such embodiments where the instructions are interdependent, the execution of instructions for one recipient might be contingent upon the completion of instructions by another recipient. For example, the notification for a second recipient might only be sent after the first recipient has read the message and executed the action. In yet another embodiment, the sender may attach multiple actionable objects to a single message, each intended for a specific recipient within the group. Although a few embodiments are described, the embodiments are not so limited and any other variations of actionable objects or a single object with varying instructions for different recipients are contemplated.

Referring to FIG. 31, at 3105, a determination may be made that the message is intended for a group of recipients. At block 3110, a determination may be made as to the number of actionable objects and instructions attached to the message. This can be further illustrated in the blocks below. At block 3115, a determination may be made if there are more than one actionable object associated with the message. If a determination is made at block 3115 that there is more than one actionable object, then the process may move to block 3130 where a determination may be made if the multiple actionable objects associated with the message are intended for different recipients in the group period. Example, the sender may attach a first actionable object that is intended for the first recipient and a second actionable object that is intended for the second recipient.

If a determination is made at block 3130 that each actionable object is intended for different recipient in the group, and a determination is made at block 3140 that the instructions are not dependent on execution of instructions for another recipient, then, at block 3135, the system may execute instructions associated with each actionable object for the recipient for whom it is intended. The execution of the instructions may occur once the recipient actions, which are determined based on monitoring the recipient as described earlier, trigger the execution. Such triggers and actions may be described in the command or metadata transmitted along with the message. In some embodiments, prior to the process moving from block 3130 to block 3135, a determination may be made whether the instructions for one recipient are dependent upon execution of an instruction for another recipient, as depicted at block 3140. If a determination is made that the instructions are interdependent based on the recipient's actions, then blocks 3145 and 3150 may be executed. At block 3145 the dependencies between the instructions may be determined. This may include determining which instruction is to be executed first and which subsequent instruction follows after the execution of the first instruction. At block 3150, after the dependencies between the instructions are determined, the system may execute the instructions for each recipient based on the determined dependencies and in order as indicated for the dependencies.

If a determination is made at block 3130 that all actionable objects in a group message are intended for all recipients, the process moves to block 3125, where each actionable object's instructions are executed based on their contextual triggers. On the other hand, if each actionable has separate instructions to be executed for separate recipients, such as the first actionable object is to be executed for a first recipient and a second actionable object is to be executed for the second recipient, then the system may execute them accordingly as instructed when their triggers are met. Referring back to block 3115, if a determination is made that there is only one actionable object associated with the message to be transmitted to the group of recipients, then another determination may be made at block 3120 which includes determining whether there are separate instructions within the single actionable object for different recipients. If there are separate instructions for separate recipients, then the process may continue to block 3140 as described above. If a determination is made that there is only a single instruction for all the recipients in the group, then at block 3125 the instructions may be executed when each recipient's trigger is activated.

The embodiments described herein also include a method or system that may be configured to receive, at a receiving device, a message with an actionable object associated with the message. The actionable object may be associated with an instruction to execute the message upon occurrence of a contextual awareness condition. In response to receiving the instruction, the receiving or recipient device may process the instruction associated with the actionable object separately from rendering or playing the message. The receiving or recipient device may also obtain contextual awareness data associated with the receiving device. In some embodiments, the contextual awareness data may be obtained by accessing an application of the receiving device. If a determination is made that the contextual awareness data satisfies the contextual awareness condition, then the receiving device may execute the message based on the instruction included in the actionable object. In some embodiments, the instruction may relate to delaying notification of the message until the contextual awareness condition is satisfied, e.g., to delay notification of the message if a determination is made that the contextual awareness data does not satisfy the contextual awareness condition.

In some embodiments, a change in the contextual awareness condition to a second contextual awareness condition may be detected. Upon the detection, a determination may be made whether the second contextual awareness condition triggers delivery of the notification of the message. In response to determining that the second contextual awareness condition triggers the delivery of the notification of the message, the receiving device may display a notification of receipt of the message on the receiving device's user interface.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
generating a data packet containing a message and an actionable object associated with the message, wherein the actionable object specifies an instruction for a recipient device to execute an action when a state of the recipient device meets a contextual awareness condition of the instruction, and the instruction is distinct from the message in the data packet;
transmitting the data packet with the instruction from a sending device to a recipient device, wherein the instruction causes the recipient device to obtain its current state; and
wherein, in response to determining that the obtained current state of the recipient device meets the contextual awareness condition described in the instruction, the recipient device executes the action.

2. The method of claim 1, further comprising:
analyzing content of the message being composed using a messaging application;
determining, based on the analyzing of the content, the contextual awareness condition for the message composed using the messaging application, wherein the determined contextual awareness condition is related to the content of the message; and
causing display, on the sending device, of the actionable object associated with the determined contextual awareness condition.

3. The method of claim 1, further comprising:
receiving an indication of the message being composed using a messaging user interface of a messaging application;
displaying a plurality of actionable objects on the messaging user interface of the messaging application;
receiving a selection of a first actionable object, from the plurality of actionable objects, displayed on the messaging user interface; and
associating the first actionable object with the message that is to be transmitted to the recipient device, wherein associating includes an instruction associated with the first actionable object in a field of a data packet distinct from a field used for a body of the message.

4. The method of claim 1, wherein transmitting the data packet comprises transmitting the message as a distinct object from the instruction.

5. The method of claim 1, further comprising, including a unique identifier with the transmitted data packet, wherein the unique identifier indicates presence of the instruction.

6. The method of claim 1, further comprising, updating the instruction transmitted in the data packet to the recipient device in response to determining that the message has not been accessed by a user of the recipient device, or that the recipient device has not executed the action.

7. The method of claim 6, wherein updating the instruction transmitted in the data packet to the recipient device further comprises:
generating a second message; and
associating the generated second message with a second actionable object, wherein the second actionable object includes a modified instruction for a) replacing a previously transmitted message and actionable object with the second message and the second actionable object, and b) executing the second message upon occurrence of a second contextual awareness condition.

8. The method of claim 1, further comprising:
receiving a message engagement metric from the recipient device, wherein the message engagement metric relates to engagement of a recipient of the recipient device with the message transmitted in the data packer; and
transmitting a follow-up message in a second data packet in response to determining, based on the received engagement metric, engagement below a threshold.

9. The method of claim 1, wherein the action relates to delaying notification of the message to the recipient device until the occurrence of the contextual awareness condition.

10. The method of claim 1, wherein the actionable object is an emoji, icon, or text included in a body of the message.

11. A system comprising:
communications circuitry configured to access a sending device; and
control circuitry configured to:
generate a data packet containing a message and an actionable object associated with the message, wherein the actionable object specifies an instruction for a recipient device to execute an action when a state of the recipient device meets a contextual awareness condition of the instruction, and the instruction is distinct from the message in the data packet;
transmit the data packet with the instruction from the sending device to a recipient device, wherein the instruction causes the recipient device to obtain its current state; and
wherein, in response to determining that the obtained current state of the recipient device meets the contextual awareness condition described in the instruction, the recipient device executes the action.

12. The system of claim 11, further comprising, the control circuitry configured to:
analyze content of the message being composed using a messaging application;
determine, based on the analyzing of the content, the contextual awareness condition for the message composed using the messaging application, wherein the determined contextual awareness condition is related to the content of the message; and
cause display, on the sending device, of the actionable object associated with the determined contextual awareness condition.

13. The system of claim 11, further comprising, the control circuitry configured to:
receive an indication of the message being composed using a messaging user interface of a messaging application;
display a plurality of actionable objects on the messaging user interface of the messaging application;
receive a selection of a first actionable object, from the plurality of actionable objects, displayed on the messaging user interface; and
associate the first actionable object with the message that is to be transmitted to the recipient device, wherein associating includes an instruction associated with the first actionable object in a field of a data packet distinct from a field used for a body of the message.

14. The system of claim 11, wherein transmitting the data packet comprises the control circuitry configured to transmit the message as a distinct object from the instruction.

15. The system of claim 11, further comprising, the control circuitry configured to include a unique identifier with the transmitted data packet, wherein the unique identifier indicates presence of the instruction.

16. The system of claim 11, further comprising, the control circuitry configured to update the instruction transmitted in the data packet to the recipient device in response to determining that the message has not been accessed by a user of the recipient device, or that the recipient device has not executed the action.

17. The system of claim 16, wherein updating the instruction transmitted in the data packet to the recipient device further comprises, the control circuitry configured to:
generate a second message; and
associate the generated second message with a second actionable object, wherein the second actionable object includes a modified instruction for a) replacing a previously transmitted message and actionable object with the second message and the second actionable object, and b) executing the second message upon occurrence of a second contextual awareness condition.

18. The system of claim 11, further comprising, the control circuitry configured to:
receive a message engagement metric from the recipient device, wherein the message engagement metric relates to engagement of a recipient of the recipient device with the message transmitted in the data packer; and
transmit a follow-up message in a second data packet in response to determining, based on the received engagement metric, engagement below a threshold.

19. The system of claim 11, wherein the action relates to delaying notification of the message to the recipient device until the occurrence of the contextual awareness condition.

20. The system of claim 11, wherein the actionable object is an emoji, icon, or text included in a body of the message.
